(19) United States
(12) Patent Application Publication
(10) Pub. No.: US 2021/0256406 A1
(43) Pub. Date: Aug. 19, 2021

(54) System and Method Associated with Generating an Interactive Visualization of Structural Causal Models Used in Analytics of Data Associated with Static or Temporal Phenomena

(71) Applicant: The Research Foundation for the State University of New York, Albany, NY (US)

(72) Inventors: Klaus MUELLER, New York, NY (US); Jun WANG, Lynbrook, NY (US)

(21) Appl. No.: 16/973,319

(22) PCT Filed: Jul. 8, 2019
(86) PCT No.: PCT/US2019/040803

§ 371 Date: Dec. 8, 2020

Related U.S. Application Data
(60) Provisional application No. 62/694,481, filed on Jul. 6, 2018.

(51) Int. Cl. G06N 5/04; G06K 9/62; G06F 16/28; G06N 7/00

(52) U.S. Cl. CPC G06N 5/046; G06N 7/005; G06F 16/287; G06K 9/6226

(57) ABSTRACT

A system and method associated with generating an interactive visualization of causal models used in analytics of data is disclosed. The system performs various operations that include receiving time series data in the analytics of time-based phenomena associated with a data set. The system generates a visual representation to specify an effect associated with a causal relation. A causal hypothesis is determined using at least one of an effect variable and a cause variable associated with the visual representation. Causal events are identified in a new visual representation with a time shift being set. A statistical significance is determined using at least one time window within the new visual representation. An updated visual representation is generated including one or more updated causal models.

A corresponding method and computer-readable medium are also disclosed.

### CROSS-REFERENCE TO RELATED APPLICATION(S)

The present application is the U.S. National Phase of International Patent Application No. PCT/US2019/040803, filed on Jul. 8, 2019, which in turn claims priority to U.S. Provisional Application No. 62/694,481, filed on Jul. 6, 2018, the entire contents of which are each incorporated by reference herein, in their entirety for all purposes.

### STATEMENT OF GOVERNMENT RIGHTS

This invention was made with government support under grant numbers U.S. Pat. Nos. 1,117,132 and 1,527,200 awarded by the National Science Foundation. The government has certain rights in the invention.

### FIELD OF THE DISCLOSURE

The present disclosure relates to a system and method associated with expedient determination of causal models in observing time or static based phenomena. Even more particularly, the present invention relates to a novel system and method that implements a novel visual analytics framework for expedient visualization, modeling, and inference of causal model structures and causal sequences. The present system and method further implements novel methodologies for creation of interactive visualizations that facilitate and engages an expert in the analysis of a particularized data set including heterogeneous data, with the capability to pool derived models and identify valuable causal relations and patterns.

### BACKGROUND

In the field of data analytics, in particular applications associated with theories of causation modeling and discovery on multivariate datasets have been widely studied for implementation. In particular, visual causality analysis has also become a popular topic in the field of visual analytics (VA) in recent years.

Current developmental work on using visual analytics to determine causality relations among variables has mostly been based on the concept of counterfactuals. The existence of counterfactuals is generally considered necessary for proper causal analysis. As such, with respect to visual causal analysis, the analysis has proven to be more ad-hoc and does not generally rest in the theory of causal analysis. Consequently, visual causal analysis generally does not enforce the existence of counterfactuals. In addition, knowing when a change in a causal relation will occur can be crucial for decision-making as it affects how and when actions should be taken in causal network analysis. Hence, taking into account the effect of time can serve as a useful indicator for causal dependencies in visual causal analysis.

There is currently a need for an analytics system and method associated with static phenomena that can process the colossal data sets and derive with greater precision and analytics, the exact causal model that governs the relations between variables in multidimensional datasets, which is difficult to accomplish in practice. This is generally found to be burdensome and difficult to accomplish with greater precision, because causal inference algorithms in and of themselves, typically cannot encode an adequate amount of domain knowledge to break all ties. While visual analytic approaches are considered a feasible alternative to fully automated methods, their application in real-world scenarios can be tedious.

The determination of causal relations that exist among variables in multivariate datasets is a goal in data analytics. Causation is related to correlation but correlation does not necessarily imply causation. While a number of causal discovery algorithms have been devised that eliminate spurious correlations from a network, there is no certainty that all of the inferred causations are indeed true. Hence, including domain expertise in the causal reasoning loop can be beneficial in identifying erroneous causal relationships suggested by a discovery algorithm.

Hence, it is desirable to implement a visual analytics system and method that provides a novel visual causal reasoning framework that enables users to apply their expertise, verify and edit causal model structure(s) and/or link(s), and/or collaborate with a causal discovery algorithm(s) to identify a valid causal network.

It is further desirable to implement a novel analytics system and method that includes an interface permitting interactive exchange via for example, an interactive 2D graph representation augmented by information on salient statistical parameters. Such information would assist users to gain an understanding of the landscape of causal structures, particularly when the number of variables is large. The system and method also can handle both numerical and categorical variables within at least one unified model and yet render plausible and improved results over prior analytics systems.

Hence, it is desirable to implement a visual analytics system and method that can deal with the implications of Simpson's Paradox in order to imply the existence of multiple causal models differing in both structure and parameter depending on how the data is subdivided.

It is further desirable to implement a visual analytics system and method that uses a comprehensive interface that engages experts in identifying these subdivisions while allowing them to establish the corresponding causal models via a rich set of interactive capabilities. In certain aspects or embodiments, other features of the visual analytics system interface include: (1) a new causal network visualization that emphasizes the flow of causal dependencies, (2) a model scoring mechanism with visual hints for interactive model refinement; and (3) flexible approaches for handling heterogeneous data.

In certain aspects or embodiments, it is further desirable to implement a dedicated visual analytics system and method that guides analysts in the task of investigating events in time series to discover causal relations associated with windows of time delay. In order to render the search efficient, disclosed is a novel algorithm that can automatically identify potential causes of specified effects and the values or value ranges of these causes in which the effect occurs.

In certain aspects or embodiments, the disclosed analytics system further leverages logic-based causality in certain embodiments and/or probability-based causality in certain aspects or embodiments using novel algorithms to help analysts test the significance of each potential cause and measure their influences toward the effect.

It is further desirable to implement an interactive interface in such a visual analytics system that features a conditional distribution view and a time sequence view for interactive causal proposition and hypothesis generation, as well as a novel box plot for visualizing significance and influences of causal relations over the time window.

It is further desirable to implement a novel area chart that allows users to assess the strength each cause has on a chosen effect over time, and use it to observe the effect levels over different time windows based on the entire ensemble of causes by implementation of the novel box plot.

It is further desirable to implement an analytics system and method that generates analytical results for different effects that can be intuitively visualized in certain embodiments in a causal flow diagram or other forms of representation.

### SUMMARY OF THE INVENTION

In accordance with an embodiment or aspect, the present technology is directed to a system and method associated with generating an interactive visualization of causal models used in analytics of data. The system and method comprises a memory configured to store instructions; and a visual analytics processing device coupled to the memory. The processing device executes a data visualization application with the instructions stored in memory, wherein the data visualization application is configured to perform various operations.

In accordance with an embodiment or aspect, disclosed is a system and method that includes the processing device perform the various operations that include receiving time series data in the analytics of time-based phenomena associated with a data set. The system and method further includes generating a visual representation to specify an effect associated with a causal relation. The system and method further includes determining a causal hypothesis using at least one of an effect variable and a cause variable associated with the visual representation. The system and method yet further includes identifying causal events in a new visual representation with a time shift being set. The system and method yet further includes determining a statistical significance using at least one time window within the new visual representation. The system and method yet further includes generating an updated visual representation including one or more updated causal models.

The system and method in accordance with certain other embodiments or aspects, further includes operations, which are provided herein below respectively. In yet a further disclosed embodiment, the system and method further includes that the visual representation comprises a conditional distribution visualization. In yet a further disclosed embodiment, the system and method further includes that the updated visual representation further comprises a causal flow visualization. In yet a further disclosed embodiment, the system and method further includes determining the causal hypothesis by analysis of time-lagged phenomena associated with the data set. In yet a further disclosed embodiment, the system and method further includes that the conditional distribution visualization further comprises a histogram associated with the effect variable. In yet a further disclosed embodiment, the system and method further includes the conditional distribution visualization further comprises a histogram associated with the cause variable. In yet a further disclosed embodiment, the system and method further includes that a value constraint may be set for the cause variable. In yet a further disclosed embodiment, the system and method further includes the updated visual representation further comprises a time-lagged conditional distribution visualization. In yet a further disclosed embodiment, the system and method further includes the conditional distribution visualization visualizes computed strengths of one or more cause(s) for the effect associated with a causal relation. In yet a further disclosed embodiment, the system and method further includes that the computed strengths of the one or more cause(s) for the effect is based on a probability analysis associated with the effect.

In accordance with yet another disclosed embodiment, a computer readable medium is disclosed storing instructions that, when executed by a visual analytics processing device, performs various operations. The various disclosed operations include receiving time series data in the analytics of time-based phenomena associated with a data set. Further disclosed operations include generating a visual representation to specify an effect associated with a causal relation. Yet a further disclosed operation includes determining a causal hypothesis using at least one of an effect variable and a cause variable associated with the visual representation. Yet a further disclosed operation includes identifying causal events in a new visual representation with a time shift being set. Yet a further disclosed operation includes determining a statistical significance using at least one time window within the new visual representation. Yet a further disclosed operation includes generating an updated visual representation including one or more updated causal models.

In certain aspects or embodiments, the computer readable medium further includes that the visual representation comprises a conditional distribution visualization. In certain aspects or embodiments, further disclosed is that the updated visual representation further comprises a causal flow visualization. Yet a further disclosed operation includes determining the causal hypothesis by analysis of time-lagged phenomena associated with the data set. Yet a further disclosed embodiment is that the conditional distribution visualization further comprises a histogram associated with the effect variable. Yet a further disclosed embodiment is that the conditional distribution visualization further comprises a histogram associated with the cause variable. Yet a further disclosed operation includes that a value constraint may be set for the cause variable. Yet a further disclosed embodiment includes that the updated visual representation further comprises a time-lagged conditional distribution visualization. Yet a further disclosed operation includes that the conditional distribution visualization visualizes computed strengths of one or more cause(s) for the effect associated with a causal relation. Yet a further disclosed operation includes that the computed strengths of the one or more cause(s) for the effect is based on a probability analysis associated with the effect.

These and other purposes, goals and advantages of the present application will become apparent from the following detailed description read in connection with the accompanying drawings.

### BRIEF DESCRIPTION OF THE DRAWINGS

The patent or application file contains at least one drawing executed in color. Copies of this patent or patent application publication with color drawing(s) will be provided by the U.S. Patent and Trademark Office upon request and payment of the necessary fee.

Some embodiments or aspects are illustrated by way of example and not limitation in the figures of the accompanying drawings in which:

FIG. 1 (provided herein as components shown in FIGS. 1A-1F), provides an overview of an exemplary interface associated with causal network visualization including a control panel for reading data and setting inference parameters shown in FIG. 1A; interactive path diagrams shown in FIG. 1B; a parallel coordinates view that explore data partitions shown in FIG. 1C; statistics coefficients tables of regressions associated with the causal model in FIG. 1D; data subdivision control in FIG. 1E; and a model heatmap wherein learned models are examined by selection of colored tiles in FIG. 1F, all in accordance with embodiments of the disclosed system and method.

FIG. 2 provides a flowchart illustration that provides an overview of an exemplary process associated with visual causality analytics, in accordance with an embodiment of the disclosed system and method.

FIG. 2A provides an illustration of a workflow implementing the process of causal model editing, in accordance with an embodiment of the disclosed system and method.

FIG. 2B provides an illustration of a workflow implementing the process of causal model subdivision and pooling, in accordance with an embodiment of the disclosed system and method.

FIG. 3 illustrates an exemplary implementation that provides visualization of the causal network derived from the AutoMPG dataset, in accordance with an embodiment of the disclosed system and method (provided further as separate visualizations as illustrated in FIGS. 3A-3D).

FIG. 3A illustrates an exemplary path diagram visualization of the network, in accordance with an embodiment of the disclosed system and method.

FIG. 3B illustrates an exemplary path diagram after setting an edge coefficient threshold value of 0.3, in accordance with an embodiment of the disclosed system and method.

FIG. 3C illustrates an exemplary visualization of the network as a force-directed graph, in accordance with an embodiment of the disclosed system and method.

FIG. 3D illustrates an exemplary orthogonal graph visualization of the network, in particular shown as an orthogonal circuit schematic layout form, in accordance with an embodiment of the disclosed system and method.

FIG. 4 illustrates an exemplary path diagram with model scores visualizing a network associated with a particular dataset, in accordance with an embodiment of the disclosed system and method.

FIG. 5 provides an overview of experimental evaluation results of the impact of GM with/without UB in the causal inference of heterogeneous data, comparing to the strategy of simply binning. Charts in each row are from experiments running on the same simulated dataset. Charts in each column visualize the same metric.

FIGS. 5A, 5E, and 5I are the SHDs of rebuilt causal networks by binning numeric variables with different levels. FIGS. 5B, 5F and 5J are the Structure Hamming Distances (SHDs) from GM and GM+UB with different numbers of categorical variables included in the dataset. FIGS. 5C, 5G and 5K show the average TPR. FIGS. 5D, 5H and 5L show the average TDR of the reconstructed networks with the three strategies under different numbers of categorical variables. Each of FIGS. 5A-5L provide respective illustrations of experimental results, each in accordance with an embodiment of the disclosed system and method.

FIGS. 6A-6D illustrate an exemplary causality analysis using a sales campaign dataset containing three sales groups. In particular, FIG. 6A illustrates the parallel coordinates view of an exemplary data analytics interface displaying the three clusters of the dataset as shown, in accordance with an embodiment of the disclosed system and method. FIGS. 6B-6D, illustrate the path diagrams of causal networks are generated from the corresponding sales groups, as shown, in accordance with an embodiment of the disclosed system and method.

FIG. 7 illustrates a screenshot diagnostic of causal models learned from example Ocean Chlorophyll dataset by conditioning on each geolocation, in accordance with an embodiment of the disclosed system and method.

FIG. 7A illustrates a heatmap of all models clustering into three clusters. FIGS. 7B-7D illustrate the representative models for the three clusters corresponding to the numbered tiles in FIG. 7A. FIG. 7E illustrates the t-SNE layout of these models' adjacency matrices in which it is observed that there are indeed three clusters. FIGS. 7F-7H are pooled causal relations from the three clusters accordingly, with a credibility coefficient threshold of 0.5. Each of FIGS. 7A-7H provide respective illustrations in accordance with an embodiment of the disclosed system and method.

FIG. 8 provides an example visual analytics interface for analysis of the Presidential Election dataset with the causal network interface framework. FIG. 8A provides an example user interface for selection of variable types and data preparation method. FIG. 8B illustrates an example representation providing parallel coordinates visualizing the dataset. FIG. 8C provides a derived causal network representation which uncovers many interesting facts behind the election results. Each of FIGS. 8A-8C provide respective illustrations in accordance with an embodiment of the disclosed system and method.

FIG. 9 provides illustrations of exemplary causal models inferred from the ACT dataset. FIGS. 9A, 9B and 9C illustrate causal networks that explain why students changed to other majors when entering college. FIG. 9D provides an illustration of the model pooled from the first group of 18 models learned from data subdivisions. FIGS. 9E, 9F and 9G provides illustrations of causal networks explaining why students changed major in the first two years in college. FIG. 9H provides illustration of the model pooled from the second group of 18 models. Each of FIGS. 9A-9H provide respective illustrations in accordance with an embodiment of the disclosed system and method.

FIG. 10 illustrates a short sequence of continuous variables used in inferring a potential cause, in accordance with an embodiment of the disclosed system and method.

FIG. 11 illustrates exemplary situations where an event can be erroneously considered as causing the event e. In FIG. 11A c and e are actually independent but are commonly caused by another event x (the confounder) with c being caused earlier than e. In FIG. 11B c causes e indirectly via x (chaining). Each of FIGS. 11A-11B provide respective illustrations in accordance with an embodiment of the disclosed system and method.

FIG. 12 illustrates a screenshot of an exemplary visual analytics interface for analyzing the Air Quality dataset. In FIG. 12A, the interface consists of the conditional distribution view for generating temporal events and causal hypothesis. In FIG. 12B, illustrated is the causal inference panel comprising several components for analyzing temporal causal relations. In FIG. 12C illustrated is the time sequence view for examining synchronized time series. FIG. 12D provides an illustration of the causal flow chart displaying an overview of established causal relations. Each of FIGS. 12A-12D provide respective illustrations each in accordance with an embodiment of the disclosed system and method.

FIG. 13 provides an illustration of an analytical pipeline associated with an exemplary visual analytics system.

FIG. 13A provides a flowchart illustration of an exemplary process used in time series based analytics in order to identify causal relations in generating a causal flow representation, in accordance with an embodiment of the disclosed system and method.

FIG. 13B provides a flowchart illustration of an exemplary process used in time series based analytics in order to identify causal relations and estimate potential causes iteratively, in accordance with an embodiment of the disclosed system and method.

FIG. 13C provides a flowchart illustration of an exemplary process used in time series based analytics in order to identify and test statistical significance of respective causal relations, in accordance with an embodiment of the disclosed system and method.

FIG. 14 illustrates the conditional distribution view displaying the distribution (top blue bars) and the conditional distribution (top green bars) of the variable Glucose, in accordance with an embodiment of the disclosed system and method

FIG. 15 provides an illustration including a visual encoding of events in the causal inference panel. FIG. 15A illustrates a box in the box chart representing a significant cause exerted on a continuous variable. FIG. 15B illustrates a significant cause exerted on a discrete variable. FIG. 15C illustrates an insignificant cause. FIG. 15D illustrates a positive effect (Increase type) with elevated expected value. FIG. 15E illustrates a negative effect (Decrease type). Each of FIGS. 15A-15E provide respective illustrations each in accordance with an embodiment of the disclosed system and method.

FIG. 16 provides an illustration of an analytics visualization including an interactive interface using the medical dataset, in accordance with an embodiment of the disclosed system and method.

FIG. 17 provides an illustration of an exemplary analytics visualization including a time sequence view visualizing the illustrative medical dataset under 4 units time offset, in accordance with an embodiment of the disclosed system and method.

FIG. 18 illustrates a screenshot of an exemplary visual analytics interface for analyzing the Air Quality dataset. In FIG. 18A, the interface shown in various graphical formats, indicates the causes increasing the PMUSPost estimated automatically with a time delay set to 6 hours, in accordance with an embodiment of the disclosed system and method. In FIG. 18B, illustrated is an analytics representation associated with the time sequence view reveals that, while wind from the northeast reduces air pollution, wind from the northwest does not. FIG. 18C provides an illustration of the influence of northwest wind. FIG. 18D provides an illustration of the influence of the southwest wind. Each of FIGS. 18A-18D provide respective illustrations of a visual analytics interface, each in accordance with an embodiment of the disclosed system and method.

FIG. 19 illustrates an exemplary visual analytics interface for analyzing the DJIA 30 dataset. In FIG. 19A, the interface consists of various graphical formats, providing predictors of the share price of IBM falling into $150 to $160 with 1 day lagging. FIG. 19B illustrates factors related to the decreasing of IBM's share price. Each of FIGS. 19A-19B provide respective illustrations of a visual analytics interface, each in accordance with an embodiment of the disclosed system and method.

FIG. 20 illustrates a system block diagram in accordance with an embodiment of the visual analytics system, in the form of an example computing system that performs methods according to one or more embodiments.

FIG. 21 illustrates a system block diagram including constituent components of an example electronics device associated with a visual analytics and causal model editor, in accordance with an embodiment of the visual analytics system.

FIG. 22 illustrates a system block diagram including constituent components of an example device, in accordance with an embodiment of the visual analytics system, including an example computing system.

FIG. 23 illustrates a system block diagram including constituent components of an example computing device, in accordance with an embodiment of the disclosed visual analytics system and method, including an example computing system.

FIG. 24 illustrates a system block diagram of an example computing operating environment, where various embodiments may be implemented.

It should be appreciated that elements in the figures are illustrated for simplicity and clarity. Common but well-understood elements, which may be useful or necessary in a commercially feasible embodiment, are not necessarily shown in order to facilitate a less hindered view of the illustrated embodiments.

### DETAILED DESCRIPTION

In the following description, for the purposes of explanation, numerous specific details are set forth in order to provide a thorough understanding of example embodiments or aspects. It will be evident, however, to one skilled in the art, that an example embodiment may be practiced without all of the disclosed specific details.

The present disclosure relates to a system and method associated with expedient determination of causal models in observing time or static based phenomena. Even more particularly, the present invention relates to a novel system and method that implements a novel visual analytics framework for expedient visualization, modeling, and inference of causal model structures and causal sequences. The present system and method further implements novel methodologies for creation of interactive visualizations that facilitate and engages an expert in studying a particularized data set including heterogeneous data, with the capability to pool derived models and identify valuable causal relations and patterns.

Determining the causal explanations of an observed phenomenon is one of the ultimate goals for data analysts, yet it is considered one of the most difficult tasks in technology. The advantage of knowing causality, rather than just correlation, is that the former provides much clearer guidance in predicting the effects of actions. In order to tackle this challenge, modern statistical theories on causality have been well established following the illuminating work of Pearl, Causality: Models, Reasoning, and Inference, Cambridge University Press, 2000. for example, and P. Spirtes, C. N. Glymour, R. Scheines, D. Heckerman, C. Meek, G. Cooper, and T. Richardson. Causation, Prediction, and Search. MIT Press, 2000

These theories define a causal relation as a counterfactual and offer automated algorithms for inferring a graph structure explaining the causal dependencies behind the observed system. Generalized visual analytics frameworks leveraging such theories have also been presented recently by inventors J. Wang and K. Mueller, providing interactive utilities to have users involved to apply their domain expertise in the causal reasoning.

While knowing that a causal relation exists is enlightening, knowing when the change will occur can also be crucial, as it instructs how and when actions should be taken. For example, knowing the timing of biological processes will allow us to intervene properly to prevent disease; knowing the causes that drive the price of a stock in the stock market will enable profitable trading; knowing that second-hand smoking causes lung cancer in 10 years may motivate people to kick the habit and lead to legislation that prohibits public smoking. On the other hand, people would be far less worried if the time delay was for example, 90 years. This fine but powerful nuance of time is at the very root of causality.

Although theoretical tools analyzing the time factor in causality, for example, Granger causality, Dynamic Bayesian networks, and logic-based causality, are widely adopted in scientific research, there are few known interactive visual analytics tools that support domain users in these analytical tasks. Human analysts must resort to simple text based editors to identify important phenomena and set up parameter for hypotheses evaluations. This might be feasible when testing a small number of relations under very specific settings. However, exploratory causal discovery can require many interactions between the user and the algorithm until a comprehensive model explaining the observations is and/or can even be achieved. These types of complex analytical processes can be very difficult to manage without visual support.

In particular, the urge to find the causal explanations behind one or more observed phenomena is an inherent trait of human nature, and the massive growth of data can help satisfy this innate curiosity. While correlation has been widely used as evidence of causation, relations derived in this way can be ambiguous and often even spurious. Many of such examples can be found for example, at T. Vigen, “Spurious Correlations” at http://www.tylervigen.com/spurious-correlations, which provides information regarding spurious-correlations.

Hence, there is a need for a dedicated causality framework capable of measuring the dependency between two variables in the context of another set of controlled variables. While a number of algorithms have been devised for identifying causal relation in multivariate data, these algorithms typically cannot encode existing domain knowledge, or even common sense, to guide their analyses. This, in turn, leads them to hold strong assumptions on data distributions, which can rarely be satisfied in practice. A remedy to overcome this significant shortcoming is to insert an expert, whether human or automated, into the causal inference loop as a synergist partner. This realization has led to efforts that use a visual analytics approach to causal inference, called visual causality analysis. It allows experts endowed with domain knowledge and intuition to refute or propose causal links.

Hence, visual analytics interfaces were proposed in earlier works, for example, the Visual Causality Analyst: J. Wang and K. Mueller, “The Visual Causality Analyst: An Interactive Interface for Causal Reasoning,” IEEE Trans. Vis. Comput. Graph., vol. 22, no. 1, pp. 230-239, 2016. Such system utilizes a 2D graph visualization of causal networks and a set of interactive tools that users can employ to examine the derived relations. While effective, these proposed system interfaces are nevertheless relatively simple and can only provide very basic functions of operating on a single model. Real world scenarios, however, incur many practical difficulties that such a simple tool generally cannot handle.

The greatest practical challenge is posed by Simpson's Paradox (E. H. Simpson, “The Interpretation of Interaction in Contingency Tables,” Source J. R. Stat. Soc. Ser. B, vol. 13, no. 2, pp. 238-241, 1951) which provides that a relation held in the general population may be altered in data sub-groups given proper partitions. A widely-used example for this phenomenon is the 1973 discovery of an apparent gender bias favoring male applicants in the graduate school admissions at UC Berkeley. However, in fact, the gender bias was reversed when each department was considered separately, in particular 6/85 departments appeared to favor females while only 4/85 appeared to favor males. This discrepancy was not deliberating but explainable by unrelated admission facts. When applying causality analysis, Simpson's paradox implies that possibly multiple causal models underlie a dataset, each for a certain sub-range of the data across the factors.

Hence, in accordance with an embodiment, the disclosed visual analytics system and method associated with static phenomena, assists analysts to recognize where such decompositions may be applied appropriately and hence permits such analysts and related systems to subdivide the data along certain dimensions or into clusters. In addition, the disclosed visual analytics system and method associated with static phenomena, provides the ability and platform that permits analysts to compare between and extract credible relations from the derived multiple causal models via a pooling process that can occur either at the causal link level or at the model level.

Yet, a further challenge is that real-world problems often have a mix of numerical and categorical (ordinal, nominal) data that prior art systems are unable to tackle effectively nor efficiently. This mix of data stands at odds with current causality algorithms which can generally handle either numerical or categorical variable, but not both. In order to render and make the data homogeneous, prior methods will bin all numeric variables into categorical ones. This, however, incurs undesirable discretization artifacts.

Other approaches tackle the issue associated with making the data homogeneous by transforming the categorical variables into numerical ones using a global re-spacing and re-ordering scheme. However, a known shortcoming of this scheme was that the distribution of the levels remains to be sparse, which in effect, adds complexity to the causal inferencing.

Accordingly, disclosed is a novel level-enrichment approach that overcomes the shortcomings in the art. In particular, the disclosed visual analytics system and method associated with static phenomena, implements a devised set of generalized inference algorithms with flexible options for handling heterogeneous data.

In certain aspects or embodiments, causal models are often drawn in form of general directed networks and graphs in which flows of causal dependencies are difficult to recognize. This also impedes the practical use of causality analysis as an analytics platform for general use. Accordingly, in accordance with an embodiment, disclosed is a novel system and method associated with more appropriate visualization of causal networks in the form of path diagrams laid out using spanning trees. In particular, such path diagrams provide causal flows with an effective narrative structure.

In accordance with an embodiment, disclosed is a visual analytics system and method associated with a novel visualization of causal networks that better exposes the flow of causal sequences. Yet further disclosed is a novel scoring function with corresponding visual hints that are used to compare alternative causal models. Yet further disclosed is a novel visual analytics system and method for improved processing and handling of heterogeneous data in causal inference with its experimental evaluation. Yet further disclosed is a novel visual analytics system and method associated with interactive functions and/or capabilities that allow users to explore data sub-divisions from which different models can be inferred. Yet further disclosed is a novel visual analytics system and method associated with novel mechanisms for diagnosing (or pooling) all derived models to recognize valuable causal relations and patterns.

In accordance with an embodiment, further disclosed is a novel visual analytics system and method associated with time-bearing phenomena that addresses the above-described deficiencies in the art. In particular, in certain aspects or embodiments, disclosed is a dedicated visual analytics system and method that guides analysts in the task of investigating temporal phenomena and their causal relations associated with windows of time delay. In certain aspects or embodiments, the disclosed system and method leverages a probabilistic causality theory-based implementation where the probability of a phenomenon or an event in time is defined as the time points at which a variable's value falls into a specified range. An event c is considered a potential cause of another event e, if c happens always before e, within a fixed time window and if it elevates the probability of e occurring. Then, the significance score of a potential cause is computed by testing it against each of the other causes, whereas causes with larger scores are considered better explanations of the effect.

Accordingly, a causality based method for analyzing time series which can identify dependencies with time delays is disclosed in accordance with an embodiment. A visual analytics framework that allows users to both generate and test temporal causal hypotheses, is further disclosed in accordance with yet another embodiment. A novel algorithm that supports the automated search of potential causes given the observed data is further disclosed in accordance with yet another embodiment. Further described hereinbelow, are some usage scenarios that demonstrate the capabilities of the causality framework of the disclosed system and method in example implementations of an embodiment of the visual analytics system and method.

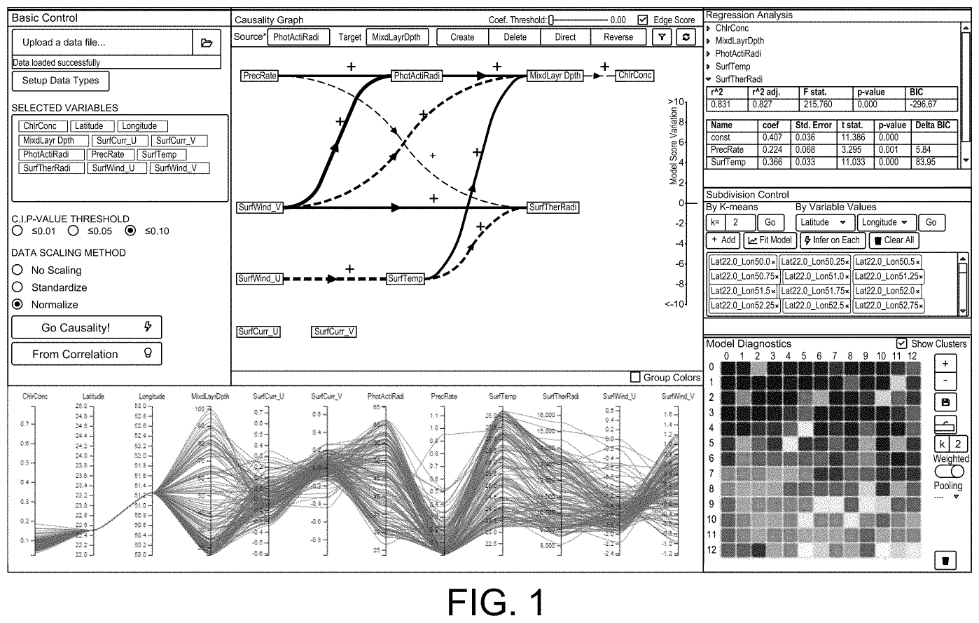

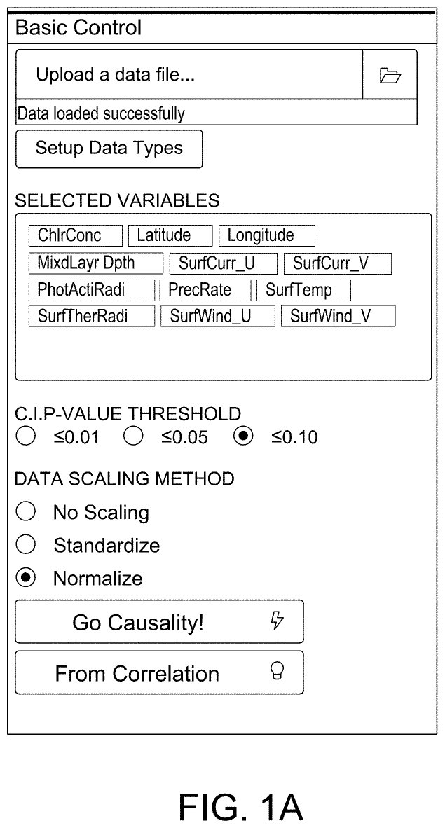

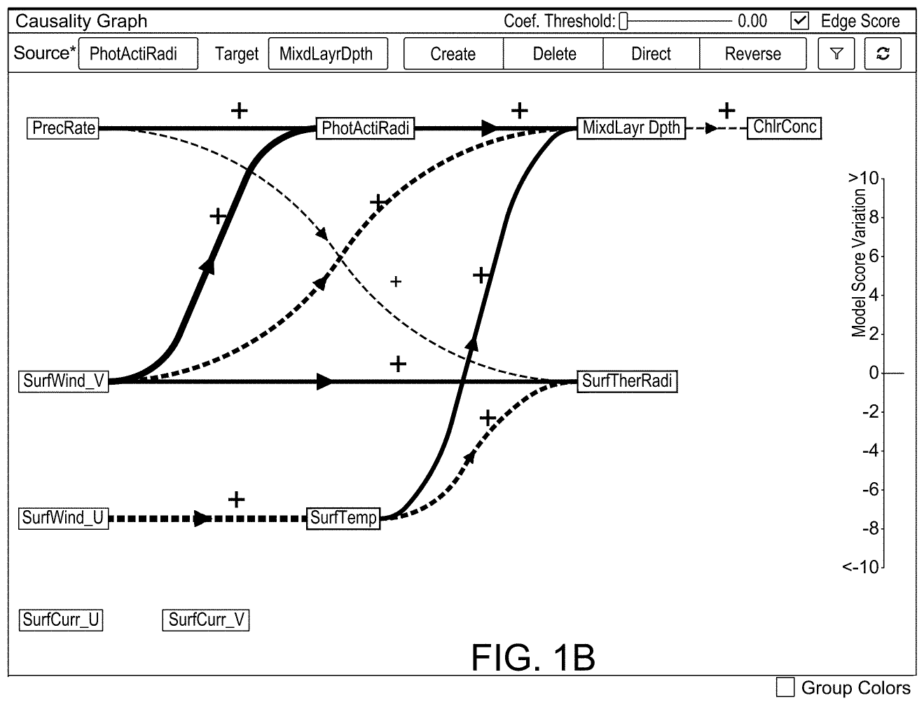

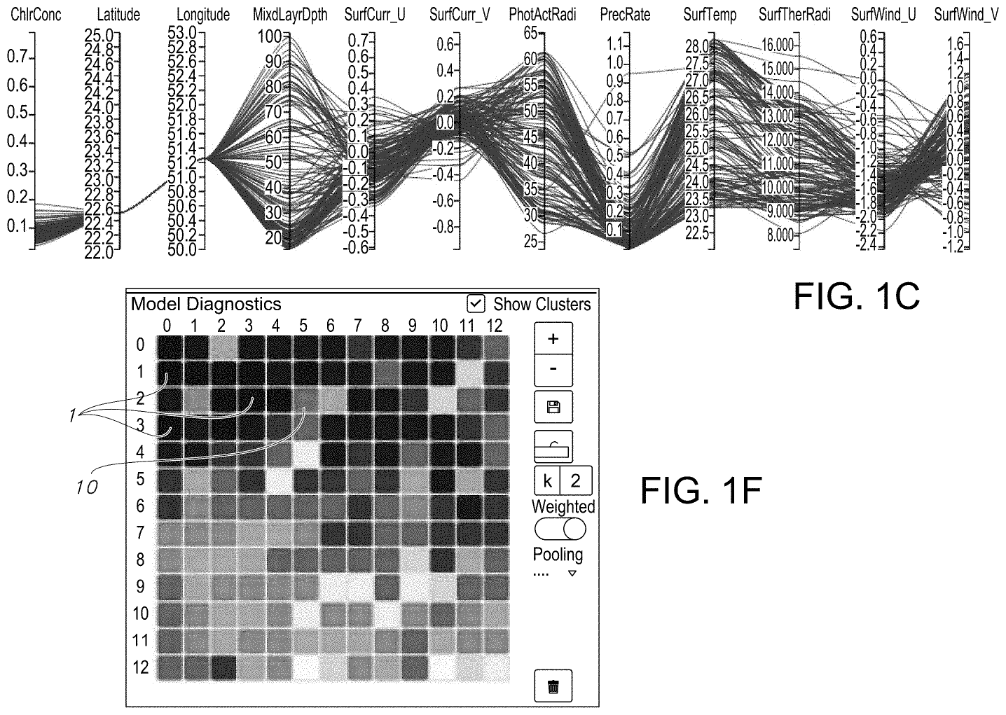

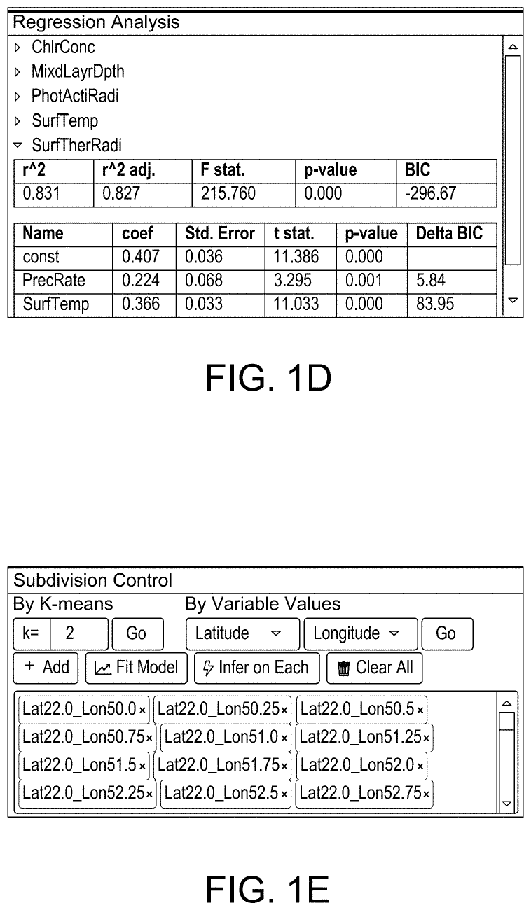

FIG. 1 provides an overview of an exemplary interface associated with causal network visualization including interactive path diagrams, a parallel coordinates view that explore data partitions, statistics coefficients tables of regressions associated with the causal model, data subdivision controls and a model heatmap where learned models are examined by selection of colored tiles, in accordance with an embodiment of the disclosed system and method.

In particular, FIG. 1 illustrates an embodiment of the disclosed novel causal structure interface. In general, FIG. 1 shows a novel visualization of causal networks that exposes the flow of causal sequences more effectively and efficiently in the form of a novel visual interface associated with visual causality analytics. A scoring function along with corresponding visual hints can be used to compare alternative causal models. In addition, an improved method for handling heterogeneous data in causal inference (for example, along with experimental evaluation implementations) is disclosed. In addition, interactive capabilities that allow users to explore data sub-divisions from which different models can be inferred is disclosed with mechanisms for diagnosing (or pooling) all derived models to recognize valuable causal relations and patterns.

In particular, shown in FIG. 1A, is an exemplary control panel for reading in data and setting inference parameters. FIG. 1B illustrates interactive path diagrams for causal network visualization. FIG. 1C illustrates parallel coordinates view for exploring data partitions. FIG. 1D illustrates statistic coefficients tables of regressions associated with the causal model. FIG. 1E illustrates data subdivision control, in which a subdivision can be saved as a clickable tag. FIG. 1F illustrates model diagnostic controls and an exemplary model heatmap, wherein users can examine learned models by clicking and/or selecting each tile colored by model scores.

More specifically, the parallel coordinates view shown in FIG. 1C serves as the component for data visualization. Users have the option to start from either a causality model or a correlation graph shown in FIG. 1A. The path diagram view shown in FIG. 1B and the regression analysis view shown in FIG. 1D allow the visual analysis of both causation and correlation. The analytics on local causation models are achieved through the data subdivision view shown in FIG. 1E and the model heatmap shown in FIG. 1F, with which user can visually examine each model derived from a data subdivision as well as the pooled models, while obtaining full support for decision making and hypothesis evaluation.

The disclosed visual analytics system and method supports visual investigation of multiple causal models underlying a dataset. Hence, causal inference on data subdivisions can be accomplished.

By way of background, according to Simpson's Paradox, a relation found in the overall data may not hold in certain data subdivisions, and conflicting relations buried in some specific data ranges may cancel each other so that none can be observed in the general population. Such effect has often been observed in correlation analysis. For example, by bracketing the price of a product to lower ranges one may see positive correlations with sales, while negative correlations are reflected with a higher price range. In addition, causal relations with opposite directions may also exist as feedback loops. For instance, the price of a product will affect sales when sales are low, but a large number of sales can also reduce the cost and hence, lower the price.

As a result, multiple causal models differing in both structure and regression parameters can arise from such data partitions. Ignoring such facts and always learning the model using the whole dataset will potentially lead to faulty relations returned by inference algorithms. Without data partitioning, the regression model constructed will probably contain considerable large residuals. In addition, the Bayesian Information Criterion (BIC) of a model is computed from such residuals (referring hereinbelow to Equation (2), hence refining these miscalculated causal models based on their score change can also be difficult in these circumstances).

In order to eliminate or at least reduce such disturbances and reveal the different causal models hidden in the data, an interactive parallel coordinates interface (as shown in FIG. 1C) is employed by an embodiment of the Visual Analytics system and method. Via the parallel coordinates, users can directly observe potentially attractive data subdivisions and partition the data by adjusting the brushed value range of variables. Conversely, data partitions can also be detected by the system based on unique values of some variables or as data clusters recognized by clustering algorithms, using the interactive capabilities shown for example, in FIG. 1E.

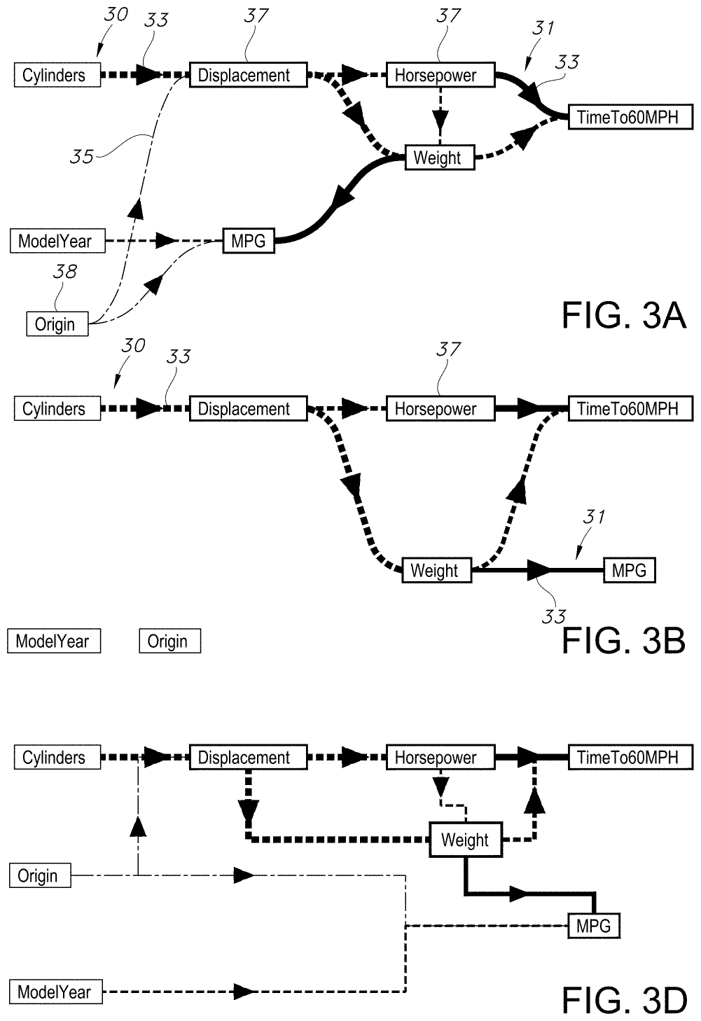

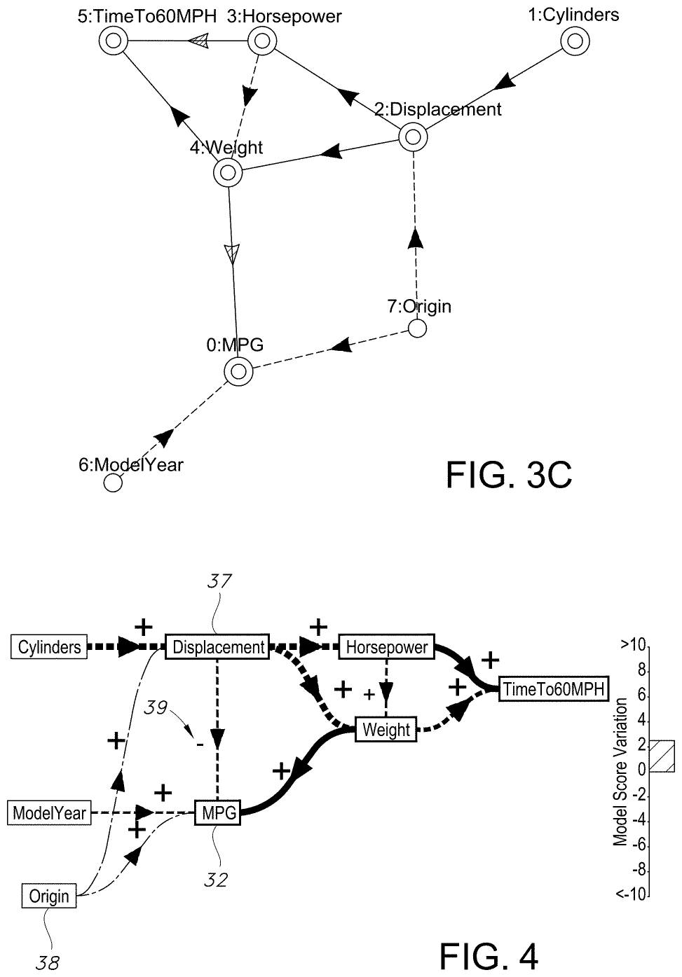

These interactive capabilities shown in FIG. 1E also allow users to manage the recognized partitions. Users can save a partition as a tag, recall it in the parallel coordinates by clicking the tag, or fit it to a causal structure by hitting the “Fit Model” button. Most importantly, one can learn a causal model from each such data subdivision and refine it with the visual approaches, as described further hereinbelow in connection with FIGS. 3-4.

Three data clusters have been recognized by k-means clustering (T. Kanungo, D. M. Mount, N. S. Netanyahu, C. D. Piatko, R. Silverman, and A. Y. Wu, “An efficient k-means clustering algorithm: analysis and implementation,” IEEE Trans. Pattern Anal. Mach. Intell., vol. 24, no. 7, pp. 881-892, 2002) and are colored blue, yellow and red, respectively (with interactive capabilities shown in FIG. 1E)

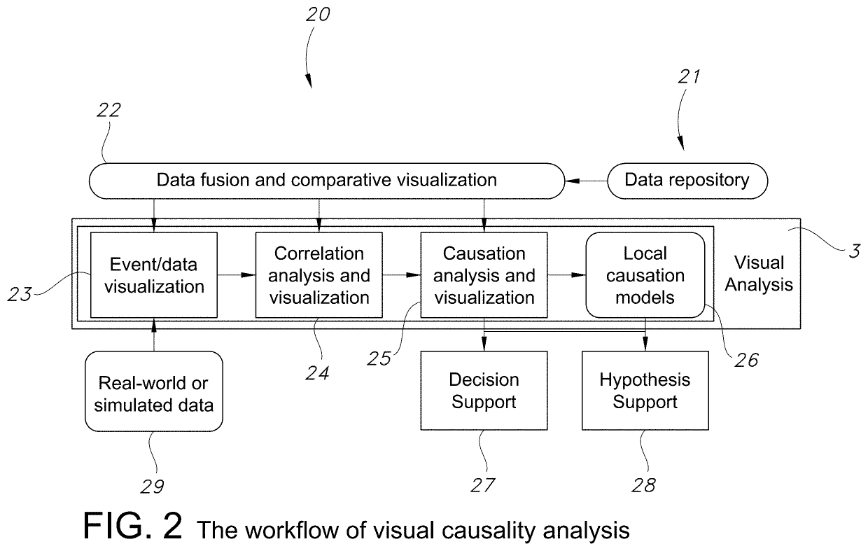

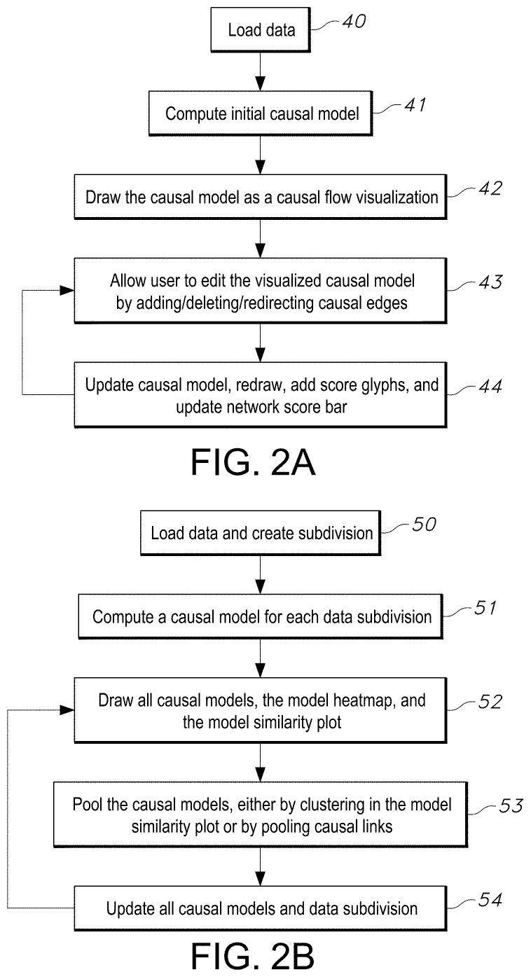

FIG. 1F illustrates the heatmap of the exemplary models, where a darker tile 1 denotes a model with a lower model score (thus better goodness) following the criterion described further hereinbelow in connection with FIGS. 1 and 2 and Equations (1)-(2). FIG. 1B illustrates the causal model denoted by for example, the highlighted tile 10 (that is colored in orange) in FIG. 1F.

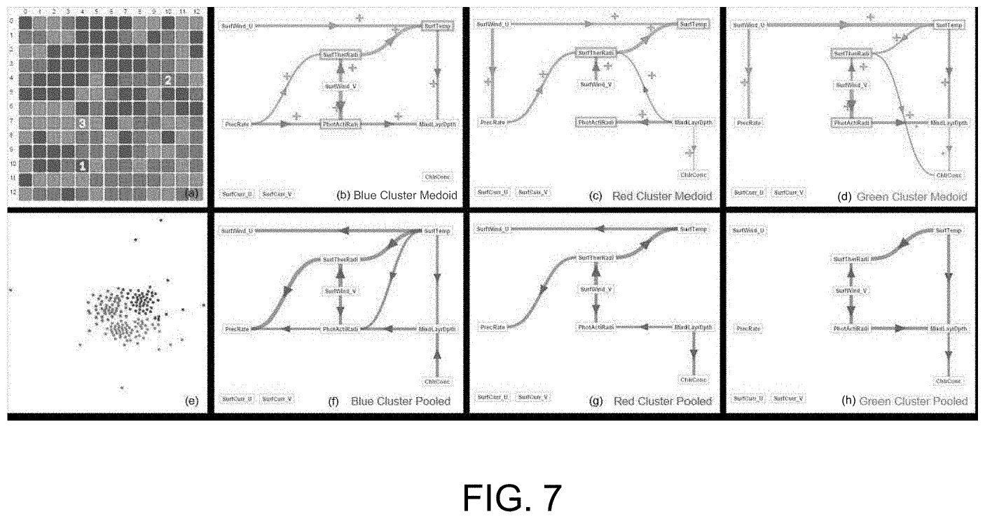

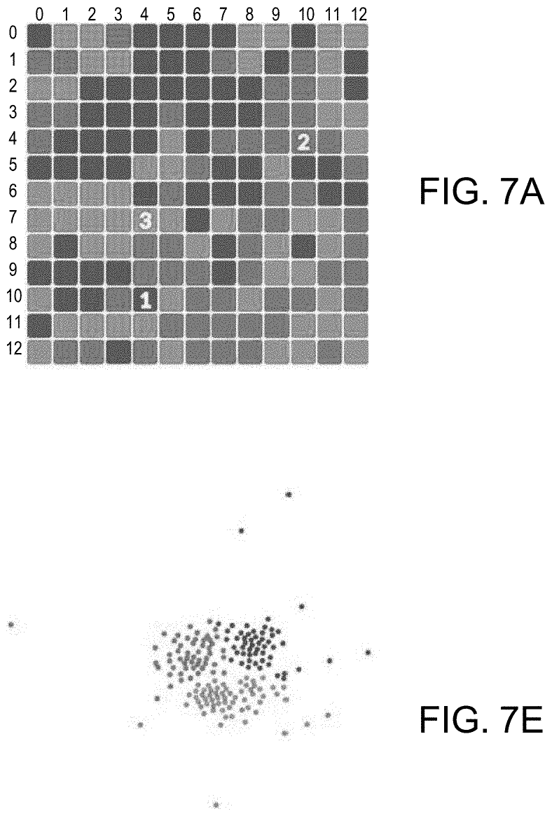

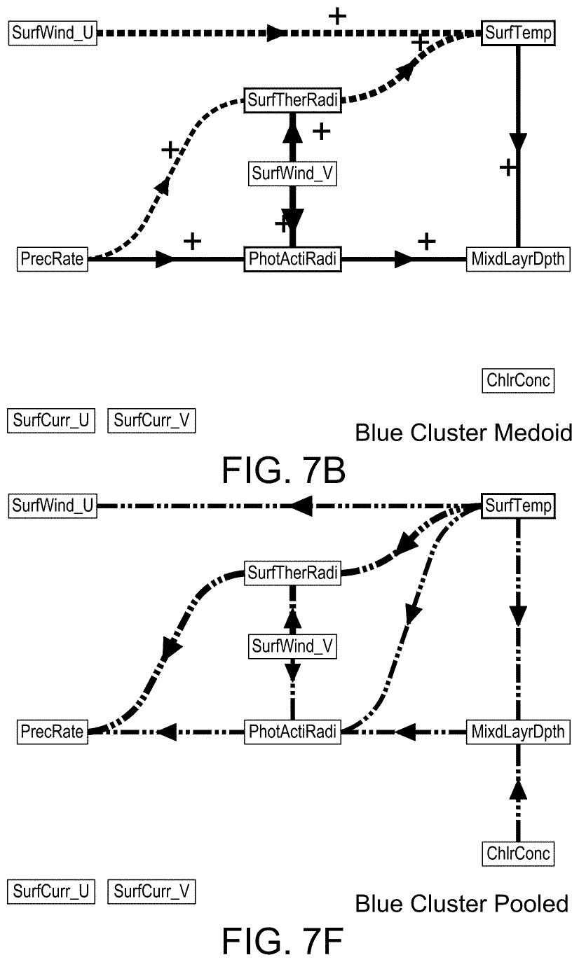

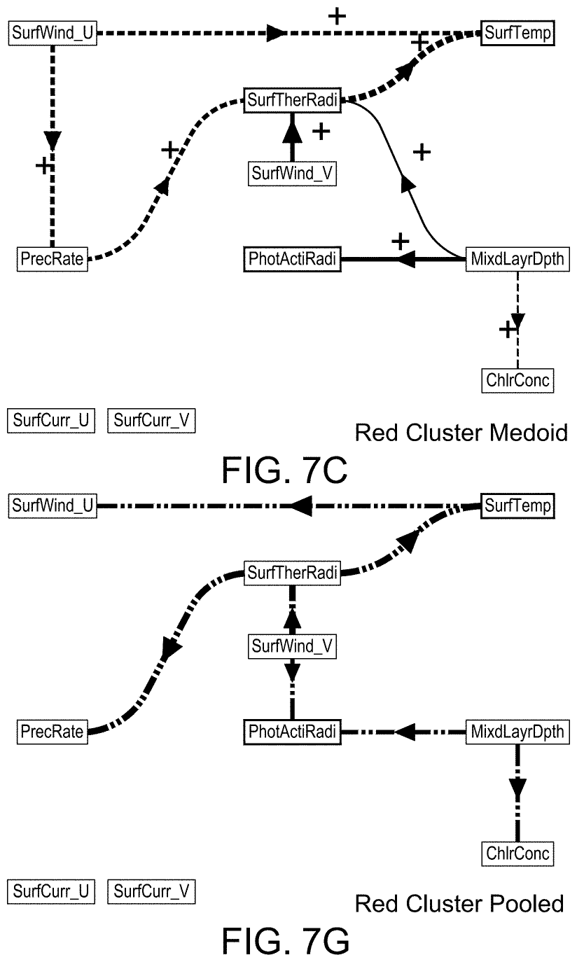

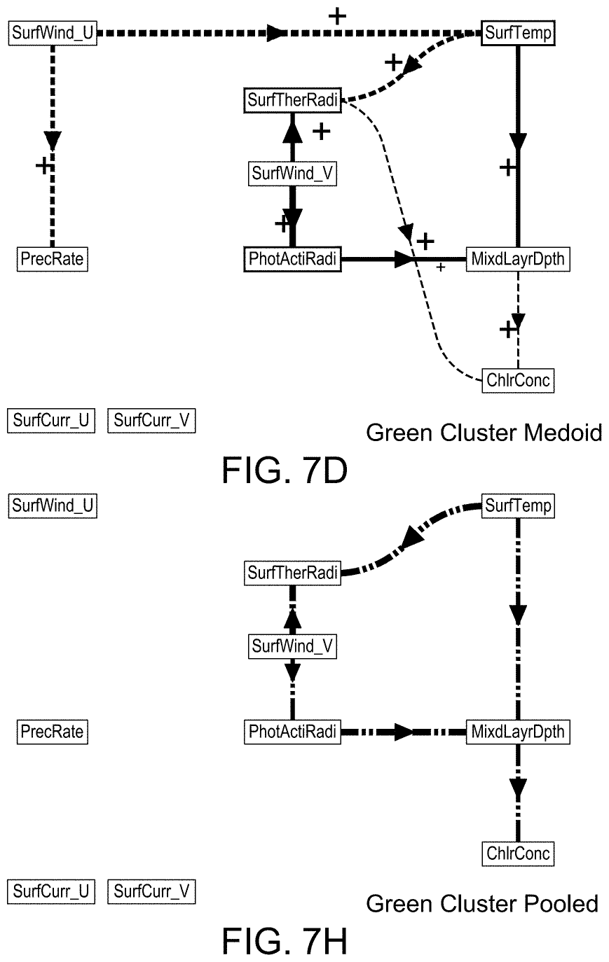

In certain aspects or embodiments, in order to find possible groupings of models derived from a dataset, k-medoids clustering is applied which is an effective method in finding the representative objects among all. In the shown example, by setting k=3 with the controls in FIG. 1F, a new heatmap is generated as shown and described in greater detail hereinbelow in connection with FIG. 7A.

By way of background, the set of causal relations between variables of a multidimensional datasets is usually depicted as a Directed Acyclic Graph (DAG) where variables are nodes and a directed edge between two nodes means the first causes the second. In certain aspects or embodiments, algorithms learning the structure of such DAGs can be roughly classified into two categories—score-based algorithms and constraint-based algorithms. The former typically associate a DAG with a score function, e.g. the Bayesian Information Criterion (BIC), and performs, for instance, a greedy search in the space of all possible DAGs. Examples are the GES algorithm (D. M. Chickering, “Optimal structure identification with greedy search,” J. Mach. Learn. Res., vol. 3, pp. 507-554, 2002) and the K2 algorithm (G. Cooper and E. Herskovits, “A Bayesian Method for the Induction of Probabilistic Networks from Data,” vol. 347, pp. 309-347, 1992).

Since the number of possible structures is super-exponential in the number of variables, such algorithms usually suffer drawbacks such as a high search cost. In contrast, the constraint-based algorithms build causal networks according to the constraints of dependencies and conditional dependencies in the data. Some well-known algorithms are SGS (P. Spirtes, C. Glymour, and R. Scheines, Causation, Prediction, and Search. New York, N.Y.: Springer New York, 1993), PC (D. Colombo and M. H. Maathuis, “Order-independent constraint-based causal structure learning,” J. Mach. Learn. Res., vol. 15, no. 1, pp. 3741-3782, 2014), IC (J. Pearl and T. S. Verma, “A theory of inferred causation,” Stud. Log. Found. Math., vol. 134, pp. 789-811, 1995), and Total Conditioning (J. P. Pellet and A. Elisseeff, “Using Markov Blankets for Causal Structure Learning,” J. Mach. Learn. Res., vol. 9, pp. 1295-1342, 2008) and others. These constraints are usually learned with conditional independence (CI) tests via partial correlation, G2 statistics, or other techniques. Such algorithms are commonly based on several strong assumptions of data distributions which are rarely satisfied by real-world data. As a consequence, when applied to real-world data none can guarantee an exact model, especially when there are latent or non-linearly related variables.

Several causal modeling methods can be used to parameterize the learned DAG (Directed Acyclic Graph). The two most common choices are Bayesian Networks (BN) and Structural Causal Models (SCM). The former quantifies causal relations with conditional probability tables, and the latter quantifies causal relations with linear functions plus Gaussian noise, e.g. linear regression and logistic regressions. As the knowledge of data distribution required in Bayesian Networks (BN) is usually difficult to acquire in practice, in accordance with an embodiment of the disclosed method and system, an algorithm of Total Conditioning and PC is implemented in order to infer causal structures and then parameterize them as Structural Causal Models (SCM) models.

FIG. 2 provides an illustration of a workflow associated with visual causality analysis, in accordance with an embodiment of the disclosed system and method. In general, the aim of data analysis and visualization is to help identify the causes of observed events. Integrating emerging technologies can facilitate causality discovery in numerous endeavors, including the sciences, engineering, medicine, the humanities, industry, business, and governance. Humans analyze causality through observation, experimentation, and a priori knowledge. Today's technologies enable us to make observations and carry out experiments on an unprecedented scale, resulting in a deluge of data. This results in immense opportunities to discover new causation relationships, but managing such data also presents unparalleled challenges. Numerous technologies including visual analytics, data repositories and grids, computer-assisted workflow and process management, and quantum computing are improving the process of causality discovery. FIG. 2 shows how these technologies could provide decision support in a typical organization and aid hypothesis generation and evaluation in a scientific investigation.

By way of background, visual analytics (VA) has become the de facto standard process for integrating data analysis, visualization, and interaction to better understand complex systems. VA generally rests on the following assertions: 1) statistical methods alone cannot convey an adequate amount of information for humans to make informed decisions-hence the need for visualization; 2) algorithms alone cannot encode an adequate amount of human knowledge about relevant concepts, facts, and contexts, hence the need for interaction; 3) visualization alone cannot effectively manage levels of details about the data or prioritize different information in the data, hence the need for analysis and interaction; and 4) direct interaction with data alone isn't scalable to the amount of data available, hence the need for more effective analysis and visualization.

In particular, illustrated in FIG. 2 is the workflow of an exemplary process associated with visual causality analysis as initially proposed by Chen et al. (M. Chen et al., “From Data Analysis and Visualization to Causality Discovery,” Computer., vol. 44, no. 10, pp. 84-87, 2011), which aims to provide decision support 27 in a typical organization and aid hypothesis generation 28 and evaluation in a scientific investigation. In such process, data repository 21 is the initial step that tackles the availability of and hence, the analysis of huge amounts of data. Next, the system performs data fusion and comparative visualization in step 22. The fusion of concepts and models are applied; global/external event records and visualization occurs; and historical event records and visualization sub-processes occur in step 22. Real-world or simulated data is compiled in step 29. Next, event and data visualization is performed in step 23. Correlation analysis and visualization occurs in step 24. Next the system performs causation analysis and visualization in step 25. Local causation models are formed in step 26. Causation analysis and visualization in step 25 drives the decision support module 27. Local causation models help drive the hypothesis support in step 28.

One of the earliest attempts of such a system is the Growing-polygons scheme which captures causation at the process level, i.e. as a sequence of causal events. Growing-polygons scheme uses animated polygon colors and sizes to signify causal semantics. The work of Vigueras and Botia considers ordered events in a distributed system as causations and visualizes their dependencies as causal graphs. Focusing on the upstream-downstream relations of variables, ReactFlow visualizes causal relations as pairwise pathways connecting duplicated variables in two columns. Some other efforts in the visual mining of causation include OutFlow and EventFlow. Both visualize temporal event sequences as alternative pathways and use event chains to explore embedded patterns. Liu et al. visualize event streams as flows aligned by event types. However, none of these known systems leverage(s) automated algorithms for causal discovery, and so they generally do require significant user input to acquire any such knowledge.

Hence, disclosed is an improved visual analytics system that implements an improved visual interface with the capability of performing automatic causal inference as originally proposed by inventors, J. Wang and K. Mueller, “The Visual Causality Analyst: An Interactive Interface for Causal Reasoning,” IEEE Trans. Vis. Comput. Graph, vol. 22, no. 1, pp. 230-239, 2016. Such prior system generates causal networks as color-coded 2D graphs visuals with force-directed layouts and offers a set of interactive tools for the user to examine the derived relations. The prior graph visualization system has been widely used also in visualizing Bayesian belief networks, correlation networks, uncertainty networks, and many other graph-based analytic models. However, the disclosed system provides improved visualization and more comprehensive analytic capabilities that can handle many practical difficulties in real-world causality analysis than prior visualization analytics systems, as described in further detail hereinbelow.

Accordingly, in certain aspects or embodiments, such novel visual analytics system and method provides a new visualization platform to provide a new and more effective visualization of causal networks that better exposes the flow of causal sequences; a scoring function along with corresponding visual hints that can be used to compare alternative causal models; an improved method for handling heterogeneous data in causal inference along with their experimental evaluation; interactive facilities that allow users to explore data sub-divisions from which different models can be inferred; and mechanisms for diagnosing (or pooling) all derived models to recognize valuable causal relations and patterns as described in greater detail hereinbelow in connection with example embodiments provided in FIGS. 3-9.

The disclosed system and method as shown in FIG. 1 is directed to a causality VA system that follows in certain embodiments the sub-processes (20-30) of FIG. 2. More specifically, the parallel coordinates view as shown in FIG. 1C serves as the component for data visualization. Users have the option to start from either a causality model or a correlation graph as shown in FIG. 1A. The path diagram view as shown in FIG. 1B and the regression analysis view shown in FIG. 1D then allows the visual analysis of both causation and correlation. The analytics on local causation models are achieved through the data subdivision view as shown in FIG. 1E and the model heatmap as shown in FIG. 1F, with which user can visually examine each model derived from a data subdivision as well as the pooled models, with improved support for decision making and hypothesis evaluation.

In certain aspects or embodiments, the visual analytics system implemented a single model, generally serves two major purposes: (1) to communicate the automatically derived relations for the causal network and/or (2) allow users to examine their own proposed causal links as well as ones derived by algorithms. Multiple models may also be analyzed that arise from data subdivisions.

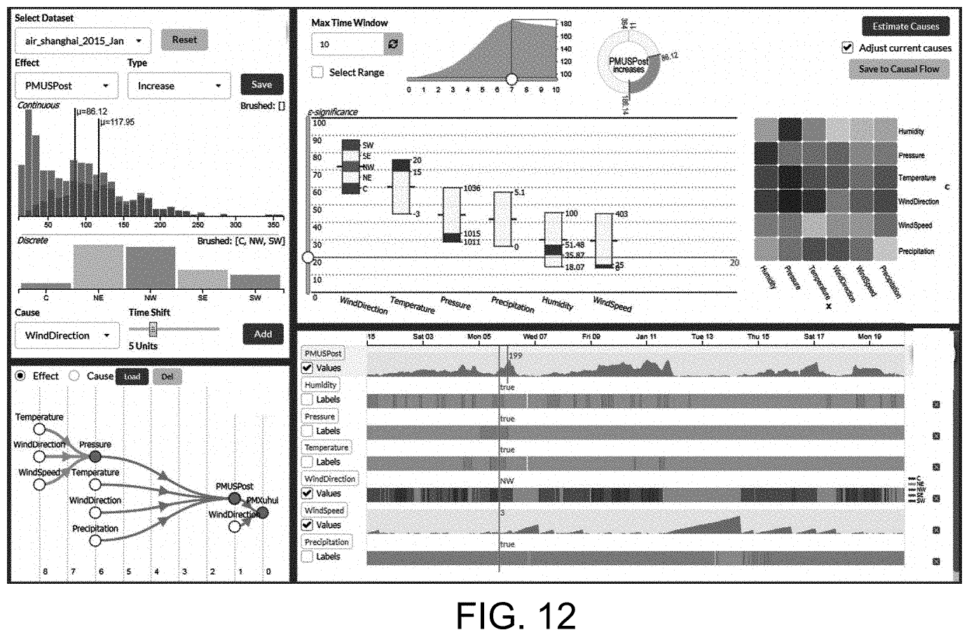

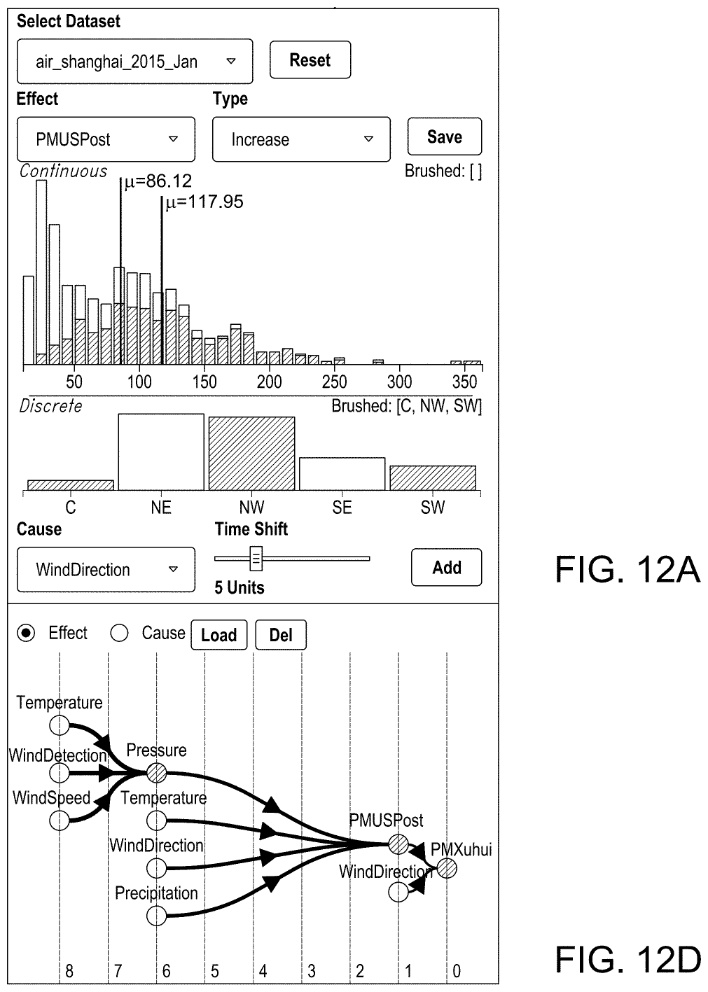

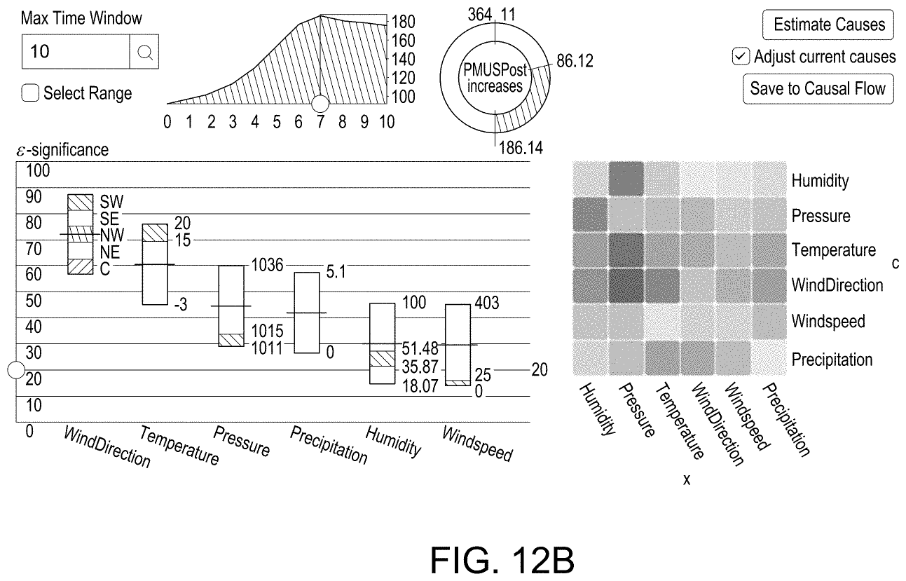

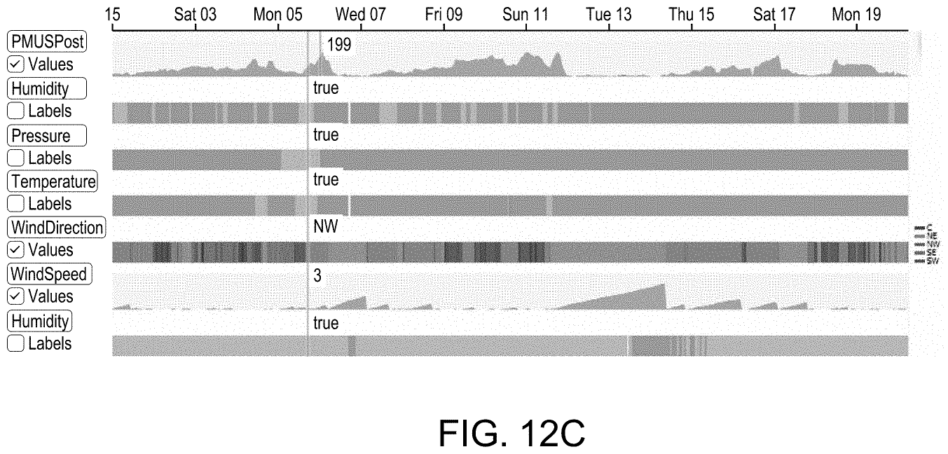

Shown in FIG. 2A is a flowchart illustration of a process associated with causal model editing, in accordance with any embodiment of the disclosed system and method. In the first step 40, the system loads the data that is to be analyzed in order to process such data, visually analyze and expediently identify the causes of observed events. Such observations has numerous applications including science, engineering, medicine, the humanities, industry, business and governance. Such visualization based analytics is desirable as statistical methods alone, algorithms visualization alone, and/or direct interaction with data alone, cannot process nor convey an adequate amount of information so that humans can digest or make informed decisions based thereon. Next in step 41, the system computes and generates an initial causal model. The system next draws the causal model as a causal flow visualization, for example, as shown in exemplary embodiments described hereinbelow in connection with FIGS. 3A-3D or FIG. 12D.

Revealing and determining the causal explanations of an observed phenomenon is one of the ultimate goals for data analysts, yet it is one of the most difficult tasks in science. The advantage of knowing causality, rather than just correlation, is that the former provides much clearer guidance in predicting the effects of actions.

While knowing that a causal relation exists is enlightening, knowing when the change will occur can also be crucial, as it instructs how and when actions should be taken. For example, knowing the timing of biological processes will allow us to intervene properly to prevent disease; knowing the causes that drive the price of a stock in the stock market will enable profitable trading; knowing that secondhand smoking causes lung cancer in 10 years may motivate people to kick the habit and lead to legislation that prohibits public smoking—on the other hand, people would be far less worried if the time delay was 90 years. This fine but powerful nuance of time is at the very root of causality and hence, visual analytics.

Disclosed in certain embodiments is a dedicated visual analytics system that guides analysts in the task of investigating temporal phenomena and their causal relations associated with windows of time delay. Also disclosed is a visual analytics system that guides analysts in the task of investigating static phenomena. The system may leverage probability-based causality theory where the probability of a phenomenon or an event occurring at a certain time, is defined as the time points at which a variable's value falls into a specified range. An event c is considered a potential cause of another event e if c happens always before e within a fixed time window and if it elevates the probability of e occurring. Then, the significance score of a potential cause is computed by testing it against each of the other causes, whereas causes with larger scores are considered better explanations of the effect.

After a proper set of causes and the time delay is obtained, the user can save the results into the causal flow chart associated with temporal-based relations (for example as illustrated in FIG. 12D), and the system can store the Causal Flow by user selection for example as shown at the top-right corner menu of FIG. 12B. The system upon user selection, can adjust current causes and/or save to causal flow. If some previous result exists, in certain embodiments the system will merge them by matching the nodes representing the same event and build a tree structure with the significant causal relations. The causal tree is laid out in a similar fashion as the flow diagram described hereinabove in connection with FIGS. 3A-3D. In certain embodiments, instead of equally spacing nodes in different levels of the flow, the nodes may be modified such that the distance between a cause and an effect signifies their time lag. This is further denoted by the time axis on the bottom and the dashed indicator lines. The link's color (or line boldness in FIG. 12D) indicates the type of the effect—red links in FIG. 12C (or bold directional lines in FIG. 12D) point to Decrease and green links in FIG. 12C (or regular directional lines in FIG. 12D) point to Increase or ValueIn (referring to FIGS. 12C-12D described further hereinbelow). The nodes in the chart can be reloaded either as a cause or an effect. Hence, in accordance with a time-bearing model or a static-based visualization model, the disclosed system will generate the causal model as a causal flow visualization in step 42, in accordance with exemplary causal flow visualizations shown and described in connection with FIGS. 3A-3D or FIGS. 2A-D hereinbelow.

Proceeding to step 43, the system next permits the system to edit the visualized causal model by adding, deleting and/or redirecting any causal edges in the causal model. When an edge is added, the user suspects or believes there may be a causal relation.

In certain embodiments, a framework for static phenomena visualization may convey both local causal sequences as well as the overall network structure. Hence, disclosed is a novel approach that visualizes causal networks as path diagrams for static-bearing phenomena. In a causal path diagram, a causal relation is visualized as a straight or curved path from the cause to the effect variable denoted by named nodes. Such design is in part, based on previous works using pathways to represent relation or event flows. The arrow mark in the middle of a path signals the direction of the relation. In order to remit the clutter of local structures, i.e. sequences of causal relations, the path diagram is laid out using spanning trees of the network built with for example, using a Breadth-first Search. More specifically, the system may first layout the nodes of the spanning trees to fit the canvas in a left-to-right manner regarding their parent-child relations, and then add back all edges during rendering. Variables not related to others are isolated at the bottom.

As such, in the disclosed embodiment, paths of causal sequences will connect and direct from left to right, intuitively forming causal stories. Finally, although the generated diagrams are usually clear enough for demonstrating the causal paths, users are also allowed to adjust it manually by dragging each node. An example causal flow diagram generated in step 42, is shown in FIG. 3A, that includes nodes mostly positioned left to right in topological order following their dependencies. The flow of causations, especially those with strong relations, become even clearer after weak relations (narrow paths) have been filtered out (which is a function included in the disclosed visual interface).

The system further permits updating and/or refinement of the causal model, re-drawing, adding score glyphs and/or updating network score bars in step 44 of FIG. 2A, as described in greater detail in connection with example path diagram shown in FIG. 4 and Equations (1)-(2) described further hereinbelow.

Accordingly, in certain aspects or embodiments, one of the tasks of visual causality analysis is to provide visual evidence supporting a user's decision on refuting or accepting causal relations. This can be achieved by scoring each relation as well as the overall network with proper metrics. Although common statistics calculated from regression residuals, for example, F-statistics and r-squared, are capable of measuring the model goodness of fit, such statistics usually do not take model complexity into consideration. This implies that just by adding more relations into the model these statistics will mostly improve. However, this can potentially lead to overfitting, which means that the model is an extremely good fit for the dataset from which it was learned, but generates huge errors on any other dataset recorded from the same source. In certain aspects or embodiments, when a model is overfitted or an extremely good fit for the dataset, it generally refers to the model being too specialized to the data it has been trained on. In such cases, the model is not general enough to predict new unseen data within a tolerable margin of error. For example, such overfitting is analogous or similar to trying to have a complex curve fit all data in a regression instead of just a line.

In order to support interactive analysis, the system provides visual feedback along with each of the user's operations and the updates of the parameters. The system in certain embodiments permits saving the discoveries in an overview for later re-examination and/or updating of models, in accordance with step 44 of FIG. 2A. The system will continue to allow the user to edit the visualized causal model by adding/deleting/redirecting causal edges in step 43.

In accordance with example implementation of representative visual causal models shown in FIGS. 7A-H, the process of causal model subdivision and pooling is described in connection with FIG. 2B. In certain aspects or embodiments, pooling allows analysts to compare between and extract credible relations from the derived multiple causal models via a pooling process that can either occur at the causal link level or at the model level.

The analytics on local causation models are achieved through loading of data for analysis and the creation of data subdivisions in step 50 of FIG. 2B (as shown for example, in FIG. 1E) and/or creation of the model heatmap (as shown for example, in FIG. 1F). In certain aspects or embodiments, the visual analytics system permits visual examination of each model derived from a data subdivision as well as the pooled models, hence providing support for better informed decision making and hypothesis evaluation.

By way of background, the purpose of pooling at the causal model level is to recognize the possible grouping of causal models so that common causal relations can be summarized from models in the same group and different causal trends can be compared between models in different groups. In order to achieve this, in certain embodiments each causal graph may be represented as an adjacency matrix. Since a causal model features both its structure and parameters, the regression coefficient of each edge may be used as the corresponding element in the matrix. Then, the system can pool at the causal model level by clustering these adjacency matrices to uncover the different causal mechanisms embedded in them.

Next, the system will compute a causal model for each data subdivision created in step 51. The system will proceed to generate a representation of all causal models, the model heatmap and/or the model similarity plot in step 52 of FIG. 2B.

In step 53 of FIG. 2B, the system permits pooling of all the causal models, either by clustering in the model similarity plot or by pooling causal links. In certain aspects or embodiments in order to summarize the common and credible relations from models in each cluster, the system conducts pooling at the causal links level. The simplest pooling strategy that occurs at the causal link level is to count the frequency of each possible causal relation observed in all models. Then by setting thresholds on such statistics, only causal relations observed more than a certain number of times are returned, resulting in a combined model. A potential shortcoming of such strategy is that it equally considers all observed causal models, while they may actually have different levels of credibility. This might be fine for datasets in which all bracketed subsets enclose a sufficient number of records. However, in other scenarios where the dataset is bracketed into a large number of subdivisions each containing only limited data samples, pooling by frequency may potentially enlarge the impact of the false relations found in low credibility models.

When a group of models is following similar causal processes, it is reasonable to infer that those true causal relations will be observed frequently in models with higher credibility so that they should be emphasized in pooling; while models with lower credibility can be considered random noise and thus should have a small weight. When a dataset is evenly partitioned (this is important as BIC is sensitive to sample numbers n for example as described in connection with Equation (2) as described hereinbelow), the credibility of causal models learned from each data subset can be measured by their model scores. Then, as all possible causal relations form a complete graph, wherein for each edge of the graph, there is assigned a normalized score, that is calculated by summing up the credibility of all models in which the relation is observed. Further example implementations of the pooling method are described hereinbelow in connection with FIGS. 7-9.

Hence, in certain aspects or embodiments, pooling at the causal model level can be achieved for example, in step 53 of FIG. 4, by clustering adjacency matrices to uncover different causal mechanisms embedded in them. Next in step 54, the system updates all the causal model and data subdivisions and can draw updated causal models, model heatmap and/or model similarity plots in step 52, and repeat processes 52-54 as required.

As described hereinabove, the disclosed system and method as shown in FIG. 1 is directed to a causality VA system that follows in certain embodiments the sub-processes 20-30 shown in FIG. 2; steps 40-44 shown in FIG. 2A and/or steps 50-54 shown in FIG. 2B. More specifically, the parallel coordinates view as shown in FIG. 1C serves as the component for data visualization. Users have the option to start from either a causality model or a correlation graph as shown in FIG. 1A. The path diagram view as shown in FIG. 1B and the regression analysis view shown in FIG. 1D then allows the visual analysis of both causation and correlation. The analytics on local causation models are achieved through the data subdivision view as shown in FIG. 1E and the model heatmap as shown in FIG. 1F, with which user can visually examine each model derived from a data subdivision as well as the pooled models, with improved support for decision making and hypothesis evaluation.

In certain aspects or embodiments, the visual analytics system implemented a single model, generally serves two major purposes: (1) to communicate the automatically derived relations for the causal network and/or (2) allow users to examine their own proposed causal links as well as ones derived by algorithms. Multiple models may also be analyzed that arise from data subdivisions as described in connection with processes shown in FIGS. 2A-2B.

Exemplary implementations of the visualization of the causal network by visual inference of single causal models, in particular models derived from analysis of an example AutoMPG dataset, is shown and described in connection with FIGS. 3A-3D and FIG. 4. FIG. 3A illustrates an exemplary path diagram visualization of the network, in accordance with an embodiment of the disclosed system and method.

While force-directed graphs such as shown in example visualization FIG. 3A, could be a feasible choice for demonstrating the overall structure of the network, such graphs may suffer from drawbacks, such as a dense and unpredictable layout. With such layouts, local structures in causal sequences can become difficult to observe and/or analyze, especially when they are part of more complex networks. However, these local structures can often be of great interest to domain users. For instance, Dang et al. shows that recognizing the upstream and downstream causal relation of variables is commonly required by biologists when examining relations between proteins and biochemical reactions. While such systems may succeed in visualizing local causal relations as pairwise pathways, they prove to be less successful in conveying global structures of the network.

In accordance with one or more embodiments, the disclosed system and method overcomes the above-recited drawbacks by creating a framework that conveys both local causal sequences as well as the overall network structure. Hence, in certain aspects or embodiments a novel approach is disclosed that visualizes causal networks as path diagrams, for example as shown in FIG. 3, comprising representative and illustrative path diagrams shown in FIGS. 3A-D. As described, FIG. 3A illustrates an exemplary path diagram visualization of the network, in accordance with an embodiment of the disclosed system and method. In particular, FIG. 3A provides a visualization representation of a causal network chain or flow, with a force-directed layout. FIG. 3B illustrates an exemplary path diagram after setting an edge coefficient threshold value of 0.3, in accordance with an embodiment of the disclosed system and method. FIG. 3C illustrates an exemplary visualization of the network as a force-directed graph, in accordance with an embodiment of the disclosed system and method. It provides a standard network diagram using state of the art technology. FIG. 3D illustrates an exemplary orthogonal graph visualization of a causal network, in accordance with an embodiment of the disclosed system and method. In particular, FIG. 3D provides a visualization as a causal chain or flow in particular, shown as an orthogonal circuit schematic layout.

In a causal path diagram, a causal relation is visualized as a straight or curved path from the cause to the effect variable denoted by named nodes. Such design is based on known works using pathways that represent relation or event flows. The arrow mark 33 in the middle of a path 30, 31 signals the direction of the relation. In order to remit the clutter of local structures, i.e. sequences of causal relations, the path diagram is laid out using spanning trees of the network built with Breadth-first Search. More specifically, the system and method first layouts the nodes of the spanning trees to fit the canvas in a left-to-right manner regarding their parent-child relations, and next adds back all edges during rendering. Variables not related to others shall be isolated at the bottom. By such, most paths of causal sequences will connect and direct from left to right, intuitively forming causal stories. Finally, although the generated diagrams are usually clear enough for demonstrating the causal paths, users are also allowed to adjust the diagrams for example, manually by dragging and/or adjusting each node.

Besides the directional structure, parameterized relations also come with a set of statistical coefficients quantitatively measuring their respective strengths and significances. In an embodiment, the disclosed system and method comprises a visual interface in which the width of a path signifies the strength of the relation measured by linear (targeting numeric variables) or logistic (targeting categorical variables) regression coefficients. Using the color code for causal semantics, for example green paths 30 denote positive causal influence and red paths 31 denote a negative influence. Compound relations between levels of categorical variables and other variables are colored yellow 35. Node colors indicate variable type—blue for numeric and yellow for categorical. A node's border thickness suggests the level of fit of the variable's regression model measured by r-squared (for linear regression) or McFadden's pseudo r-squared (for logistic regression) coefficients, both have a value range of 0 to 1, in accordance with an embodiment.

Referring back to FIG. 3A, shown is an illustration of a path diagram visualization of the network using a first application, for example, the causal network learned from the AutoMPG dataset. The nodes are mostly positioned left to right in topological order following their dependencies. The flow of causations, especially those with strong relations, become even clearer after weak relations (narrow paths) have been filtered out (which is a function included in the visual analytics system interface). For example, FIG. 3B shows the same network with a coefficient (path width) threshold value of 0.3. In FIG. 3B, several causal paths flow from left to right. One of the causal path flows in FIG. 3B, is Cylinder→Displacement→Weight→MPG, which indicates that it is weight rather than the size of the engine that is directly affecting a car's gas mileage. This can be a useful finding for a car company, which now knows that it can counter-balance the adverse effect a big engine has on mpg by designing a car with a lighter chassis but designed for increased structural stability. Hence, in FIG. 3B, the edge coefficient (and/or path width) threshold value was adjusted from the original path diagram visualization shown in FIG. 3A.

The force-directed graph that is considered a state of the art standard network diagram, is shown in FIG. 3C. An example orthogonal graph is shown in FIG. 3D, wherein nodes are connected by orthogonal edges. Both path diagrams FIGS. 3C & 3D, demonstrate the AutoMPG network facilitates a fair comparison. Compared to these two previous methods, the disclosed improved path diagram exposes flow of causal sequences embedded in the network in a more prominent way than the two competing methods. Future work will compare the three methods in a formal setting.

The processes of editing and/or visual model refinement with model scoring is performed in certain embodiments, during steps 43-44 of FIG. 2A. According to FIG. 2, one of the major tasks of visual causality analysis is to provide visual evidence supporting a user's decision on refuting or accepting causal relations. This can be achieved by scoring each relation as well as the overall network with proper metrics. Although common statistics calculated from regression residuals, e.g. F-statistics and r-squared, are capable of measuring the model goodness of fit, they usually do not take model complexity into consideration. This implies that just by adding more relations into the model, these statistics will mostly improve. However, this can potentially lead to overfitting, which means that the model is an extremely good fit for the dataset from which it was learned, but generates huge errors on any other dataset recorded from the same source. Hence, based on William of Occam's parsimony principle, models should be maintained as simple as possible. The idea is that by adding new relations to a causal model, the system can obtain an improvement in its fit to the data to some degree, but at the same time the model also becomes “worse” because it is harder to fit new data. The question then becomes how complex should the model be for a given dataset.

The Bayesian Information Criterion (BIC) which is applicable to both linear and logistic regressions, serves well in answering the question as to how complex the model should be generated for a given dataset. BIC approach rewards the improvement in fit but may also punish for increasing model complexity. Hence, for a single regression model, BIC is formulated in accordance with Equation (1) provided hereinbelow as:

BIC=−2 ln \hat{L}+k ln(n) Equation (1)

wherein L is the likelihood of the model, k is the number of independent variables, and n is the number of data points. The BIC of a linear regression can be computed from residuals in accordance with Equation (2) provided hereinbelow as:

BIC=n ln RSS/n+k ln(n) Equation (2)

where the residual sum of squares is defined by Equation (2A) provided hereinbelow as:

RSS=Σ(yᵢ−ŷ)² Equation (2A)

wherein ŷ is the predicted value of the dependent variable given values of independent variables in a regression equation, and yᵢ is the actual observed value of the dependent variable. The likelihood of logistic regressions can be computed directly using logistic functions. Equation (2) hereinabove also suggests that a smaller BIC score with small residuals and less parameters implies a better regression model.

For each variable in a causal network, variable k in Equation (2) as defined hereinabove, is the number of incoming directed edges. Variables with no observed cause can be fitted with a null model (with only the error term, thus k=0). As such, a causal edge is preferable only when it reduces the error term of the first part of Equation (2) more than it increases the complexity term of the second part of the equation, i.e. it reduces the regression's BIC. Further, in certain embodiments, the difference of a regression's BIC with and without a certain independent variable can be interpreted qualitatively following Table 1. According to Table 1, if adding a causal edge causes the BIC of the regression model to be reduced by more than 10 points, the resulting model can be deemed as “very strongly” better and the edge should be deemed as favored. An edge may be added if the user or system determines that there may be a causal relation. Such edge will not be added if it renders the model more complex without adding a meaningful causal relation.

TABLE 1

| \|BICₚ-BIC_{q}\| | Evidence Against Model q |
|---|---|
| 0 to 2 | Not worth more than a bare mention |
| 2 to 6 | Positive |
| 6 to 10 | Strong |
| >10 | Very Strong |

Table 1 provides a Qualitative interpretation of s BIC score difference, wherein p is a regression model with one extra independent variable added to q.

Based on this fact, an automated analysis process can be applied whenever the DAG is parameterized by regressions. Since each node implies a variable regressed on its causes linked by all the incoming edges, the system assigns each edge a level of importance by calculating the regression's BIC change when the edge is removed while keeping all other causes. If the BIC score increases after removing it, the edge should be recognized as valid and a green plus glyph is attached to it in the path diagram (referring to FIG. 4 described hereinbelow). Otherwise, the edge is considered doubtful and a red minus glyph is placed. The size of the glyph encodes how much the score would change such that bigger glyphs indicate larger score changes. However, since changes larger than 10 points can all be classified into the “very strong” category, the maximum glyph size can be correspondingly fixed. As such, good causal relations, as well as false ones suggested by the data, can be visually recognized. Hence, referring back to FIG. 2A, such processes described in connection with Equations (1)-(2) hereinabove, can be applied in steps 44-45 of FIG. 2A during editing and/or further refinement of the causal model including adding score glyphs and updating network score bars.

The sum of all the BIC calculated from these regressions can be used as the score of the overall causal network g, which is used as the score of the overall causal network g, which is defined by Equation (3) provided hereinbelow as:

F(g)=ΣᵢBICᵢ Equation (3)

where BICᵢ is the BIC of the regression model on variable vi. Such a scoring strategy has also been adopted by many score-based inference algorithms to score potential causal structures.

Based on the model score, a colored bar is rendered whenever the user modifies the network, showing the impact of the modification on the overall model. In certain embodiments, a red bar means the overall model score is rising and a green bar stands for a score decreasing. The length of the bar encodes by how much the score has changed. With these visual hints, users are made aware if they have made an improvement with respect to refining the model currently under analysis and/or study.

Referring to FIG. 4, illustrated is an example in which a path 39 is added from Displacement 37 to MPG 32 to the original causal network path representation shown in FIG. 3A. While most relations are valid according to the green plus glyphs, the red minus next to the newly added edge or path 39 indicates that it is increasing the BIC score of the regression of MPG, thus increasing the total model score. In particular, adding an edge signifies that the user and/or system determines that there might be causal relation. However, in the example shown in FIG. 4, with relation path 39 now added between Displacement 37 to MPG 32, it is found in the example, to not be causally related. Hence, for example, by knowing the displacement of a car, one cannot predict the car's MPG. Thus, adding this edge 39 in effect makes the model more complex without necessarily adding a meaningful causal relation.

However, a valid edge has a meaningful causal relation and direction. For example, there could be a directed edge from smoking to cancer. Knowing that someone smoked signifies that the system and/or user can predict that the person might get cancer. But, generally not vice versa, since knowing that someone has cancer does not necessarily mean that this person has smoked.

The score bar shows the model score changed about 2 points (“Positive” according to TABLE 1 hereinabove), so it is suggested to be removed. The Akaike information criterion (AIC) (referring to K. P. Burnham and R. P. Anderson, “Multimodel Inference: Understanding AIC and BIC in Model Selection,” Sociol. Methods Res., vol. 33, no. 2, pp. 261-304, 2004), which is defined very similar to BIC but with a less stringent punishment for model complexity, is also a widely applied scoring strategy used in model selection. While the AIC can work the same function as BIC and might be preferred in some circumstances, the example implementation uses BIC since it is more often adopted in causality studies, in particular with emphasis more on solving the issue of overfitting.

In accordance with an embodiment, disclosed is a visual analytics system and method associated with processing and visual analysis of heterogeneous data. In particular, disclosed is the analytics of heterogeneous data containing both numeric and categorical variables. Such analytics involving heterogeneous data are generally problematic when learning the structure of a causal DAG which requires a CI test method capable of testing and conditioning on variables of arbitrary distributions. However, typical CI tests using partial correlation or the G² test generally can only handle either numeric or categorical data, and none can handle both. Simply binning all numeric variables and applying the G² test can be a plausible solution but it comes at the potential drawback of experiencing significant information loss. Using such known approaches, not only is there a loss in value scales, but also the order of bins will be ignored in the G² tests, both of which can introduce error relations in the result.

Another recently proposed solution is the Global Mapping (GM) strategy (referring to J. Wang and K. Mueller, “The Visual Causality Analyst: An Interactive Interface for Causal Reasoning,” IEEE Trans. Vis. Comput. Graph., vol. 22, no. 1, pp. 230-239, 2016), which re-orders and re-spaces categorical variables' levels so that Pearson's correlations involving categorical variables are generally maximized with respect to all numeric variables in the dataset. This allows the CI test via partial correlation to be applied to all, which also means a more expedient inference process since the G² test usually takes much longer.

More specifically, the GM strategy assigns values to level j of categorical variable v_{c} according to the following Equation (4) defined hereinbelow as:

$${v}_{c} ( j ) ∝ {\sum }_{i = 1}^{D} {Θ}_{{i}^{ρ} {i}^{μ ( {v}_{i} ( j ) )}} \qquad Equation ( 4 )$$

wherein μ(vᵢ(j)) is the average of numeric variable vᵢ corresponding to level j of v_{c}, ρᵢ is the maximized Pearson's correlation between vᵢ and v_{c}, and Θᵢ decides the sign of ρᵢ by comparing the level orders of v_{c} regarding vᵢ and regarding the numeric variable most correlated with v_{c}, when there are D numeric variables in total. A noted shortcoming of GM is that the mapped values are still discrete while CI tests via partial correlation assume they are continuous. In order to ease this issue, in accordance with an embodiment of the disclosed system and method, an un-binning (UB) process is added after GM in which mapped levels are converted to value ranges separated by the middle point of two levels. For example, if a three-level variable is mapped to values {0, 0.4, 1}, the converted ranges shall be {[−0.2, 0.2], [0.2, 0.7], [0.7, 1.3]}. Then data points are randomly assigned with values in the according range based on a Gaussian distribution. By such, categorical variables can be simulated to be continuous.

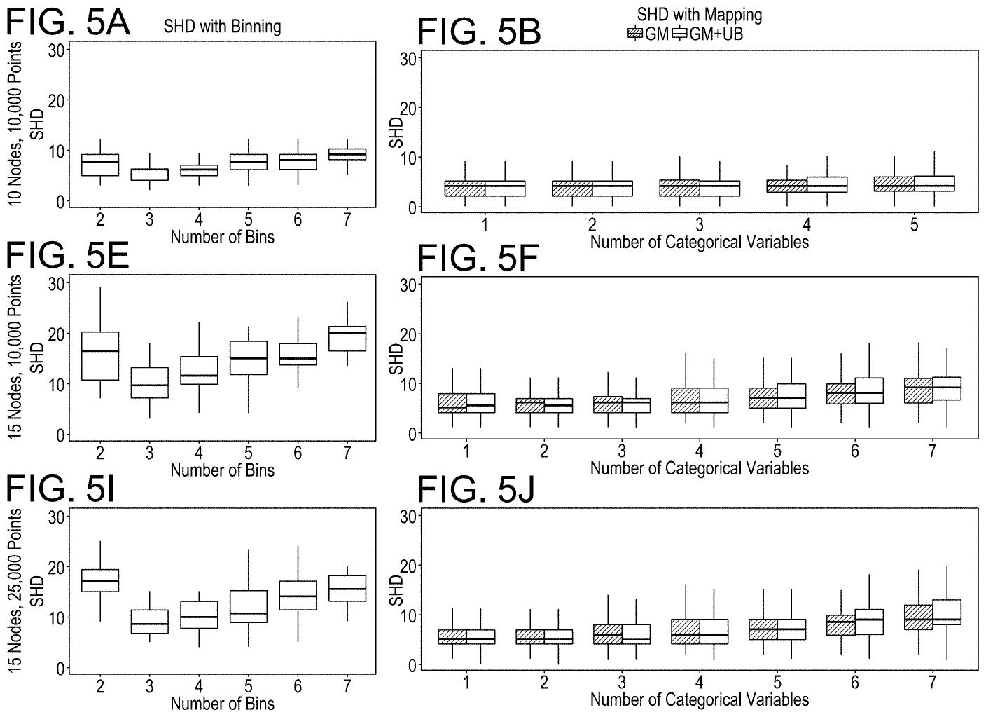

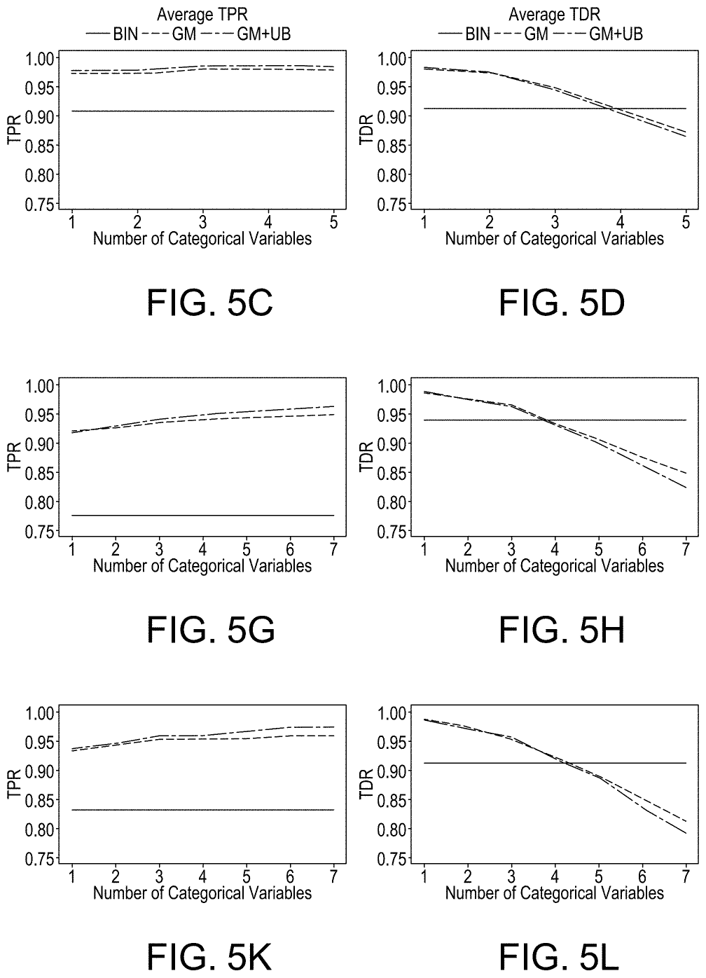

Experimental evaluations with respect to the impact of GM with and without UB (un-binning) is described in greater detail hereinbelow with respect to FIG. 5. In particular adding the un-binning process after GM improved the results of the analysis by simulating categorical variables to be continuous as described hereinabove with respect to processing heterogeneous data by adding the un-binning (UB) process.

In accordance with an embodiment, the disclosed visual analytic system method supports the visual investigation of multiple causal models underlying a dataset. The mechanism, along with illustrative examples are described in greater detail hereinbelow.

In certain aspects or embodiments, according to Simpson's Paradox, a relation found in the overall data may not hold in certain data subdivisions, and conflicting relations buried in some specific data ranges may cancel each other so that none can be observed in the general population. Such effect has often been observed for example, in correlation analysis [Z. Zhang, K. T. Mcdonnell, E. Zadok, and K. Mueller, “Visual Correlation Analysis of Numerical and Categorical Data on the Correlation Map,” IEEE Trans. Vis. Comput. Graph., vol. 21, no. 2, pp. 289-303, 2015.

As an example, by bracketing the price of a product to lower ranges one may see positive correlations with sales, while negative correlations come with a higher price range. In addition, causal relations with opposite directions may also exist as feedback loops. For instance, the price of a product will affect sales when sales are low, but a large number of sales can also reduce the cost and so lower the price. As a result, it is often the case that multiple causal models differing in both structure and regression parameters can arise from data partitions. Ignoring such facts and always learning the model using the whole dataset will potentially lead to faulty relations returned by inference algorithms. Without data partitioning, the regression model constructed will probably contain considerable large residuals. Understanding that the BIC of a model is computed from such residuals (in accordance with Equation (2)), refining these miscalculated causal models based on their score change can also be difficult in this situation.

In order to eliminate or at least reduce such disturbances and reveal the different causal models hiding in the data, an interactive parallel coordinates interface (for example, as shown in FIG. 1C) but other multivariate visualization methods could be employed as well. Using the parallel coordinates in FIG. 1C, users can directly observe potentially attractive data subdivisions and partition the data by adjusting the brushed value range of variables. Conversely, data partitions can also be detected in automated fashion based on unique values of some variables or as data clusters recognized by clustering algorithms, using the interactive facilities shown for example, in FIG. 1E.

These interactive facilities also allow users to manage the recognized partitions. Users can save a partition as a tag, recall it in the parallel coordinates by clicking the tag, or fit it to a causal structure by for example, selection of the “Fit Model” button. Even further, the users can learn a causal model from each such data subdivision and refine it with the visual approaches described in connection with FIGS. 3-4 hereinabove, including visual model refinement with model scoring and analytics of heterogeneous data.

In certain aspects or embodiments, different causal models can be discovered from data using an embodiment of the visual analytics system and method, through an illustrative example, for example, leveraging the Sales Campaign dataset. Such dataset contains 10 numerical variables and 600 records describing several important factors in sales marketing and their effects on a company's financials. Each sample in the dataset represents a sales person's sales behaviors. Three data clusters have been recognized by k-means clustering (T. Kanungo, D. M. Mount, N. S. Netanyahu, C. D. Piatko, R. Silverman, and A. Y. Wu, “An efficient k-means clustering algorithm: analysis and implementation,” IEEE Trans. Pattern Anal. Mach. Intell., vol. 24, no. 7, pp. 881-892, 2002) and are colored blue, yellow and red, respectively (with interactive capabilities as shown in FIG. 1E).

While k-means are implemented in certain aspects or embodiments and for exemplary implementations herein, the proper choice of clustering algorithms may vary depending on the data being analyzed. When constructing the causal model, in an example implementation called Example 1 herein the following background knowledge is assumed. A sales pipeline starts with a lead generator developing prospective customers called Leads. When some leads return positive feedback, they become WonLeads and an increased sales pitch at cost of CostPerWL is invested in each of them, so that they might be further developed into real customers called Opportunities. The TotalCost reports the actual cost of each sales person. The goal of the entire efforts is to increase the expected return on investment (ExpectROI) and ultimately maximize the pipeline revenue (PipeRevn).

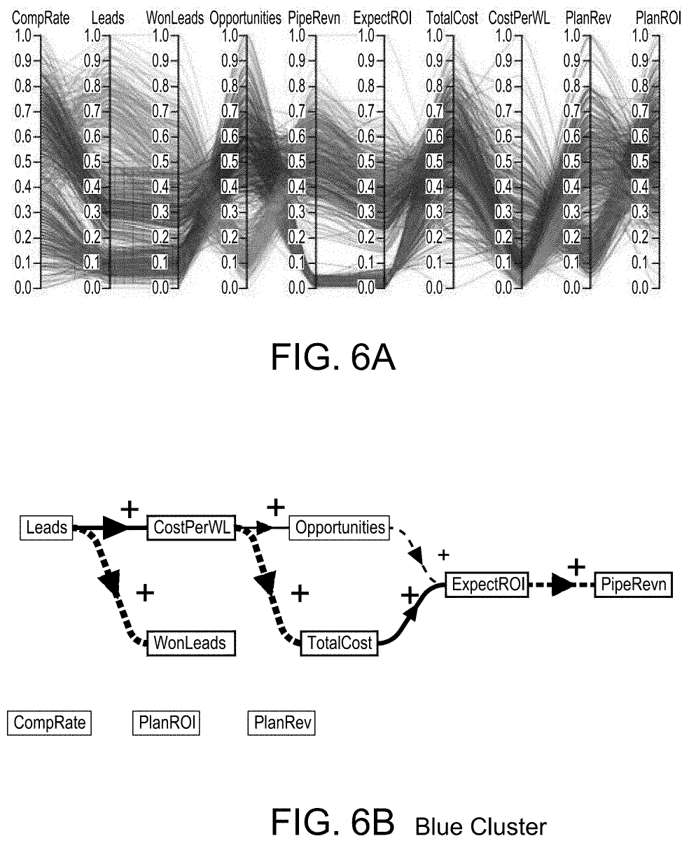

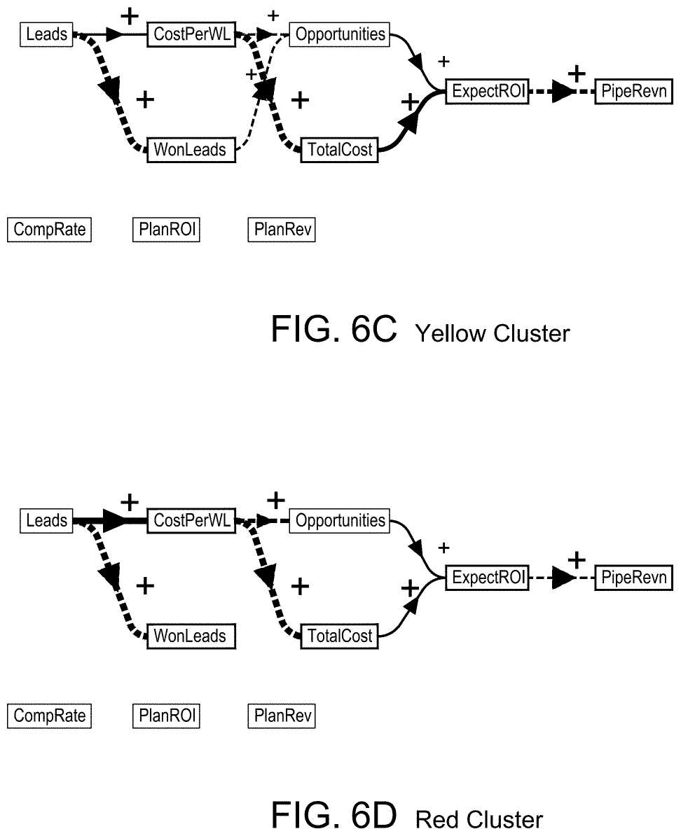

In an earlier work (for example, J. Wang and K. Mueller, “The Visual Causality Analyst: An Interactive Interface for Causal Reasoning,” IEEE Trans. Vis. Comput. Graph., vol. 22, no. 1, pp. 230-239, 2016), several meaningful relations were determined, but these were conjunctive over the entire population of sales people in the dataset. However, when looking at the three clusters in the parallel coordinates for example as shown in FIG. 6A, it is more meaningful to consider the three groups of sales people separately, as it is obvious that they are behaving very differently. It is likely that by doing so, specific sales plans can be strategized for each of them. Hence, by selecting click the “Infer on Each” button in FIG. 1E and three causality graphs are generated (for example, as shown in FIGS. 6B, 6C and 6D). The path diagrams shown therein, permit specified prescriptive analytics to be made for each sales group. Specifically, causality analysis on the Sales Campaign dataset containing three sales groups is shown in FIG. 6. In FIG. 6A, the parallel coordinates view of an exemplary data analytics interface displaying the three clusters of the dataset is shown. In FIGS. 6B-6D, the path diagrams of causal networks are generated from the corresponding sales groups, as shown. It is noted that both the structure and parameters of the three networks are somehow different, which implies different facts in sales behaviors.

First, the three causality graphs have some structures that are similar, which is consistent with the background knowledge that there must be some marketing model guiding the sales behaviors. From the three graphs in FIGS. 6B, 6C and 6D, it can be deduced that CompRate, PlanROI, and PlanRevn are not related in the pattern, and thus adjusting any of these variables will likely not affect revenue. A relation observed in all three graphs is that ExpectROI is directly affecting PipeRevn in a positive manner. This implies that the company's revenue prediction model seems to work well. TotalCost is consistently caused by CostPerWL, which is reasonable as investing in each customer represents the major costs in the pipeline. Further sound business facts realized by all groups are: (1) higher TotalCost will reduce ExpectROI, and (2) more Leads will require a reduction of CostPerWL (which is natural when the budget is fixed).

The pathway CostPerWL→Opportunity→ExpectROI is somehow different for each model, implying distinct patterns in each group's sales behaviors. In the causality graph of the blue cluster (shown in FIG. 6B), it is striking to see that more investment on each won lead is not bringing them more “opportunities” (referring to the negative effect of CostPerWL on Opportunities), (i.e. they might have invested too much on each customer and probably inappropriately). However, the opportunities they obtain with their approach are profitably increasing ExpectROI and revenue, and so overall, they are successful. In contrast, the sales people in the yellow group (shown in FIG. 6C) are gaining more opportunities from their investments (referring to the positive relation from CostPerWL to Opportunities), however, this is not bringing them more revenue, as Opportunities is not positively related to ExpectROI. Thus, such yellow group should work on increasing the profit of each closed deal. Finally, the sales group of the red cluster converts much less ExpectROI into PipeRevn, as indicated by the thinner green arrow between these two in FIG. 6D. Based on the negative causal relation from Opportunities to ExpectROI, this may have similar reasons than for the yellow cluster that their deals are not profiting, although their generous investment in CostPerWL does bring them many opportunities. Hence, the red cluster might better reduce the cost of each won lead and focus on increasing the profit.

Hence, based on the different causal patterns observed in the example implementation, the analyst team may have many suggestions for each sales group. While discussing specific strategies is beyond the scope of the disclosed system and method, the case study presented in FIGS. 6A-D demonstrates that causality analysis with data partitioning can indeed reveal different causal facts that is hidden in the data.

In accordance with an embodiment, causal model visual diagnostics is disclosed. While causal inference on data subdivisions can result in multiple models revealing different causal patterns, diagnosing these models by investigating their similarities can often reveal interesting knowledge, especially when the data is bracketed into a large number of subsets and a corresponding number of models are learned. Meanwhile, doing so also brings the issue that the number of data points available to learn each model will be heavily reduced with more partitions that are added. This may potentially lower the statistical saliency of causal relations so that they may often be missed. Reducing p-value thresholds in CI tests could be a solution, however, it also results in more false relations and thus in less credible models. In order to uncover the common causal patterns and extract reliable relations from all learned models, disclosed is a visual pooling process that can either occur at the causal link level or at the model level. Specific visual pooling strategies leveraging a real-world dataset is described further hereinbelow in connection with FIGS. 7A-7H (in accordance with the disclosed embodiment of a pooling method, described hereinabove in connection with FIG. 2B).

In particular, FIG. 7 illustrates a diagnostic of causal models learned from the Ocean Chlorophyll dataset by conditioning on each geolocation, in accordance with an embodiment of the disclosed system and method. FIG. 7A illustrates a heatmap of all models clustering into three clusters. FIGS. 7B-7D illustrate the representative models for the three clusters corresponding to the numbered tiles in FIG. 7A. FIG. 7E illustrates the t-SNE layout of these models' adjacency matrices in which it is observed that there are indeed three clusters. FIGS. 7F-7H are pooled causal relations from the three clusters accordingly, with a credibility coefficient threshold of 0.5

The purpose of pooling at the causal model level is to recognize the possible grouping of causal models so that common causal relations can be summarized from models in the same group and different causal trends can be compared between models in different groups. In order to achieve this, each causal graph is represented as an adjacency matrix. Since a causal model features both its structure and parameters, the regression coefficient of each edge is used as the corresponding element in the matrix. Next, the system can pool at the causal model level by clustering these adjacency matrices to uncover the different causal mechanisms embedded in them.

In demonstrating the pooling at the causal model method, the Ocean Chlorophyll dataset is utilized in an example implementation. The dataset was merged from several satellite data sources, monitoring the area of S22°˜S25°, E50°˜E53° (located at the south Madagascar sea). Each data source contains a particular physical property—ocean surface temperature, surface currents speed, wind speed, thermal radiation, precipitation rate, and water mixed layer depth, or a biological property—photosynthesis radiation activation and chlorophyll concentration. Such satellite data come in different horizontal resolutions and were recoded into a 0.25-by-0.25-degree resolution in longitude and latitude. At each of the 169 geolocations, the time series spans 12 years (from 1998 to 2009) and were averaged in months (thus 144 data points). Partitioning data by each geolocation, 169 causal models are learned. FIG. 1F contains the heatmap of these models, where a darker tile 1 denotes a model with a lower model score (thus better goodness) following the criterion as set forth in connection with visual model refinement with model scoring process described in connection with Equations (1)-(3), Table 1 and FIG. 4 hereinabove. Shown in FIG. 1B is the causal model denoted by the highlighted tile (that is colored in orange) as depicted in heatmap illustrated in FIG. 1F.

In order to determine possible groupings of the 169 models derived from the dataset, applied is k-medoids clustering (referring to H. S. Park and C. H. Jun, “A simple and fast algorithm for K-medoids clustering,” Expert Syst. Appl., vol. 36, no. 2 PART 2, pp. 3336-3341, 2009), which is an effective method in determining the representative objects among all. In the shown example in FIG. 7, by setting k=3 with the controls shown in FIG. 1F, a new heatmap is generated as shown in FIG. 7A. The three tiles marked with numbers 1, 2 and 3 denote the medoid models found by the clustering algorithm, i.e. the most representative model in each cluster. These three medoid causal models are visualized in FIG. 7B as (blue cluster), FIG. 7C (red cluster), and FIG. 7D (green cluster).

The system places the nodes at the same location for each model to facilitate comparisons therebetween for the analyst. In the example shown in FIGS. 7A-7H, the user seeking to use this dataset to relate the unique cycle of the chlorophyll concentration variation with other variables, and hence, the most attractive difference for the user could be that the ChlrConc is associated with other variables differently in the three representative models. Users can also examine other models by clicking on tiles of the heatmap shown in FIG. 7A. Also, the system can cluster models into more groups with controls shown in FIG. 1F, although it is observed that there are indeed three dense areas in the t-SNE layout of these models' adjacency matrices, as shown in FIG. 7E.

In order to summarize the common and credible relations from models in each cluster, pooling is performed at the causal links level. The simplest pooling strategy that occurs at the causal link level is to count the frequency of each possible causal relation observed in all models. Then by setting thresholds on such statistics, only causal relations observed more than a certain number of times are returned, resulting in a combined model. A shortcoming of such strategy is that it equally considers all observed causal models, while they may actually have different levels of credibility. This might be fine for datasets in which all bracketed subsets enclose a sufficient number of records. However, for other scenarios where the dataset is bracketed into a large number of subdivisions each containing only limited data samples, pooling by frequency may potentially enlarge the impact of the false relations found in low credibility models. When a group of models is following similar causal processes, it is reasonable to infer that those true causal relations will be observed frequently in models with higher credibility so that they should be emphasized in pooling; while models with lower credibility can be considered random noise and thus should have a small weight. When a dataset is evenly partitioned (this is considered important since BIC is sensitive to sample numbers n as defined in Equation (2)), the credibility of causal models learned from each data subset can be measured by their respective model scores. Then, as all possible causal relations form a complete graph, assigned to each edge of the graph, is a normalized score calculated by summing up the credibility of all models in which the relation is observed. Specifically, the credibility score Cₑ(eⱼ) for edge eⱼ is calculated as:

$${C}_{e} ( {e}_{j} ) = \frac{{\sum }_{i} {δ}_{ij} ( {F}_{max} - {F}_{i} )}{N ( {F}_{max} - {F}_{min} )} \qquad Equation ( 5 )$$

where δᵢⱼ=1 if eⱼ is included in model i, otherwise δᵢⱼ=0; Fᵢ is the score of model i, while Fₘₐₓ and Fₘᵢₙ are the largest and the smallest score of all N models. By such, edges with larger (e) are considered and have higher credibility. Users can then work with a slider control to filter out edges with small scores, leaving only reliable relations.

The effect of such pooling strategy is illustrated by the continued example of the Ocean Chlorophyll dataset. After clustering the causal models into three clusters, three combined models are pooled and shown in FIGS. 7F, 7G and 7H, respectively. A credibility threshold of 0.5 is applied so that only strong credible causal relations are retrieved. Looking at the three models, there are seemingly some causal loops between environmental and biological variables in the whole area as causal relations with opposite directions between the same pair of variables are observed in different models. However, one direction of the loop could be more dominating than the other in some sub-areas. For example, MaxLayrDepth is a good predictor of PhotActiRadi in the pooled models of the blue and the red clusters, but the relation is reversed in the green cluster's model. Similarly, MaxLayrDepth is the only variable strongly associated with ChlrConc but the causal mechanisms are different in the three models.

In accordance with certain aspects or embodiments, further disclosed is a causality based method for analyzing time series which can identify dependencies with time delays. A visual analytics framework is further disclosed that allows users to both generate and test temporal causal hypotheses. A novel algorithm that supports the automated search of potential causes and their values or value ranges, given the observed data is further disclosed. Several usage scenarios that demonstrate the capabilities of such causality framework is further described hereinbelow.

There is a struggle, an unmet concern in current system that determine causal models (whether temporal or not) as follows. Namely, (1) the results of automated causal models from observational (non-experimental) data are error prone, and (2) there are many plausible causal models. The disclosed system and method instead envisions a better system, one in which the concerns are met by permitting the expert to use the system and use it to: (1) resolve the errors and (2) select the model best suited to accomplish his/her mission and task, and gleam the insight he/she is searching in the analysis of such data.

The disclosed system and method is embodied in an interactive visual interface composed of a set of dedicated data visualizations and augmented by a set of computational data analysis modules to streamline the insight gathering process. It is interactive so the user can be creative, can be in control to further tailor and/or fine-tune the automated process and has the power of self-determination with respect to the goals they are seeking to accomplish vis-à-vis the data analytics of particularized data. The system comprises novel visual interfaces for rendering various complex computations and analytics of the data set, especially since the visual pathway is the fastest way to render and to reach the centers of the human brain where insight is formed and decisions are made. The disclosed system and method implements user-driven data analytics so the human can tend to the more complex tasks that even machines have struggled to solve expediently for humans.

Hence, the disclosed system and method overcomes the recited insufficiencies hereinabove associated with determining causal models (whether temporal or not) based on observational data and also can include expert analysis into the loop of the system to be effectively involved in interactive analysis process using effective, automated and interactive visual interfaces. Such visual analytics system supports analysts in the process with automated visual feedback using the complex novel algorithms underlying the system processes in generating the automated visual feedback.

Even more particularly, disclosed is a dedicated visual analytics system and method that guides analysts in the task of investigating temporal phenomena and their causal relations associated with windows of time delay. The system leverages probability-based causality theory, wherein the probability of a phenomenon or an event in time is defined as the time points at which a variable's value falls into a specified range. An event c is considered a potential cause of another event e if c occurs always before e within a fixed time window and if it elevates the probability of e occurring. Then, the significance score of a potential cause is computed by testing it against each of the other causes, whereas causes with larger scores are considered better explanations of the effect.

The general goal of a visual analytics solution for causality is to support human decision for example, in business settings, scientific investigations, and other applications. The novelty of the disclosed system and method contemplates that such visual analytics systems should provide the ability to both formulate and evaluate hypotheses in order to facilitate and/or stimulate creative thinking. The disclosed system and method is designed to serve these needs (for example, as further described hereinbelow in connection with FIGS. 12A-12D). An earlier attempt along these lines is the Growing-polygons system (N. Elmqvist and P. Tsigas; Animated visualization of causal relations through growing 2d geometry; Information Visualization, 3(3):154-172, 2004) which captures causality as a sequence of causal events (and/or a process), and uses such animated polygon sizes and colors to signify causal semantics. Adopting the idea of causal graphs, Vigueras and Botia (G. Vigueras and J. A. Botia; Tracking causality by visualization of multi-agent interactions using causality graphs; In Int. Workshop on Programming Multi-Agent Systems, pages 190-204, 2007) consider ordered events in a distributed system as causally dependent and visualize their relations in colored 2D graphs. An example system Reactionflow (T. N. Dang, P. Murray, J. Aurisano, and A. G. Forbes. Reactionflow: an interactive visualization tool for causality analysis in biological pathways. BMC proceedings, 9(6):56, 2015) arranges duplicate variables in two columns and visualizes causal relations between them as pairwise pathways, assisting user query operations along the causal chains.

In addition, taking time delays into consideration, Li, et al. use Granger causality to measure the activity of brain neurons and build a 3D visual analytics system for this task. More recently, DIN-Viz was devised as a visual system for analyzing causal interactions between nodes in influence graphs simulated over time. Bae et al. evaluate different representations of causal graphs and claim that while arrows or tapered edges can result in better recognizability, a sequential layout performs similar to a force-directed layout when it comes to readability. Although effective in causality visualization, none of the aforementioned frameworks offers an automated inference function, and so all have to rely solely on user input for initial causal relations.

The first visual system with automated causal reasoning was proposed recently by Wang and Mueller (J. Wang and K. Mueller. The visual causality analyst: An interactive interface for causal reasoning. IEEE Trans. Vis. Comput. Graphics, 22(1):230-239, 2016). It utilizes CMC based algorithms and provides a set of interactive tools that allow the user to examine the derived relations. A further development of this work offers the capability of analyzing different models that may inhabit separate data subdivisions or subspaces, and it also improves the causal graph visualizations by expressing them as color-coded flow diagrams. However, as mentioned, CMC based methods do not consider time, and thus such system suffers the drawback that it cannot be used for analyzing temporal dependencies

Hence, in certain aspects or embodiments, disclosed is a system that can analyzing common patterns in temporal events and is considered previously a key research challenge in the domain of visual analytics. Previous works (including OutFlow and EventFlow), visualize temporal events in a short sequence as alternative pathways and explore the embedded patterns as event chains. A further development of the latter uses aggregation to process large numbers of event types in a single pathway. WireVis for example, builds the connection between events in a time sequence by monitoring a set of user-defined keywords and visualizing the detected relations as a network. Liu et al. visualizes user-defined events in click-streams as flows aligned by event types; interactive tools are provided to identify sequential patterns. Lee and Shen detect salient local features called trends in time series data and utilize visual tools for matching and grouping similar patterns. Some other works also discusses the role of time and analytical methods for such information in the context of text analysis and collaborative analysis. None of these works, however, implements causality theories to infer the dependencies between events in time.

Finally, logic-based causality (referring to S. Kleinberg. A logic for causal inference in time series with discrete and continuous variables. In Proc. Int. Joint Conf. on Uncertainty in AI, pages 943-950, 2011: S. Kleinberg, P. N. Kolm, and B. Mishra: S. Kleinberg and B. Mishra. The temporal logic of causal structures. In Proc. Int. Joint Conf. on Uncertainty in AI, pages 303-312, Montreal, 2009) was devised more recently for analyzing the dependencies among temporal events. Such works depict causality as hypothetical relations between logic propositions with an arbitrary time lag. The true causes among all potential ones can then be identified via significance tests. However, the disclosed system and method builds upon these known systems and applies it into a much improved visual analytics pipeline. The disclosed system and method also enables creativity and/or permits human analysts to get effectively involved in the interactive analysis process.

The disclosed system and method is not confined to logic-based causality. General causality theory does not prohibit the use of time as a means to define and order causal relations. These relations can then be confirmed or rejected using the conditional independence test system used for static causal diagrams. Logic-based causality theory is not directed to the disclosed algorithms that accomplish automated searches of potential causes.

In logic-based causality, a causality hypothesis is a presumed relationship between several logic propositions with a non-negative time lag. A proposition describes an observed phenomenon or event, such as for example, a wind speed <15 km/h, or a blood glucose level of 70-100 mg/dl which is the normal blood sugar level before a meal for a human without diabetes. A Boolean-valued state formula is consistent with one or several atomic propositions, each testing if a variable satisfies a numerical constraint, for example, a≤4.1 or equation below

b∈[10, 18]∧v>3 where a, b, and v are observed variables.

Given two state formulas c and e where c causes e, a path formula specifies the direction, the strength, and the window of time delay of the causal relation. Formally, this path formula is written in leads-to notation as:

$$c \begin{matrix}\geq r , \leq s \\ \geq p\end{matrix} e \qquad Equation ( 6 )$$

which means if c is true, e will become true with a probability at least p after a delay between r and s time units, where 0≤r≤s≤∞. For example, in the causal hypothesis of smoking causes cancer in 5 to 10 years with 55% probability, the propositions of [smoking=True] and [cancer=True] each makes a state formula, and then the path formula hypothesizes that there is a 55% chance that the causal relation will happen when considering a time lag of 5 to 10 years.

Let T be a time sequence. A time point t in T satisfying a state formula, c is written as t/=_{T}c, and a subsequence of time points π^{t} starting from t that satisfies the path formula c [symbol] ≥r, ≤s with e written as π^{t} [symbol] _{T} c [symbol] ≥r, ≤sₑ. Then the probability of the path formula is calculated as Equation (7) provided hereinbelow as:

$$\frac{\vert \{ t ∈ T : {π}^{t} {⊨}_{T} c {\geq r , \leq s}^{} e \} \vert}{\vert \{ t ∈ T : t {⊨}_{T} c \} \vert} \qquad Equation ( 7 )$$

which defines the number of time points starting from the time at which the causal relation holds divided by the number of times the cause is active. Although a state formula in classic logic-based causality theory can comprise multiple propositions and can be defined recursively, it is assumed in certain embodiments that there is only one atomic proposition in each state formula, and one proposition corresponds to one event/phenomenon. In order to check the truth values of a conjunction of multiple state formulas, the system checks the label of each event at every time point, and then merges all the labels at a matching time using a logical and operation.

In certain aspects or embodiments inferring causes is performed. The inference, or testing, of an event c being a cause of the effect e is based on the assumption that the true cause always increases the probability of the effect (in certain aspects, a preventative can be viewed as something that lowers the probability of e, as raising the probability of ¬e). Thus, c is a potential cause (or a prima facie cause {referring to S. Kleinberg and B. Mishra. The temporal logic of causal structures. In Proc. Int. Joint Conf. on Uncertainty in AI, pages 303-312, Montreal, 2009}) of e if, taking consideration of the relative window of time delay, it satisfies Equation (8) defined hereinbelow as:

P(e)<p and P(e|c)≥p Equation (8)

where P(e|c) is calculated in accordance with Equation (7) hereinabove.

Additionally, if the effect e is defined on a continuous variable vₑ and the system is seeking to determine potential causes that are simply lowering or increasing the value of vₑ (as opposed to a value falling into a specific range), the expected value of vₑ can be used instead for better sensitivity to change. As such, c is considered a potential cause of e when Equation (9) is satisfied defined hereinbelow:

E[υₑ]≠E[υₑ|c] Equation (9)

Here, the ≠ sign can be replaced by either > or < to stipulate only positive or negative causes. The conditional expected value can be calculated as defined in Equation (10) hereinbelow as:

$$E [ {v}_{e} \vert c ] = {\sum }_{y} y \frac{θ ( [ {v}_{e} = y ] ⩓ c )}{Θ ( c )} \qquad Equation ( 10 )$$

where y are values in vₑ's domain and Θ(x) denotes the number of time points where x holds.

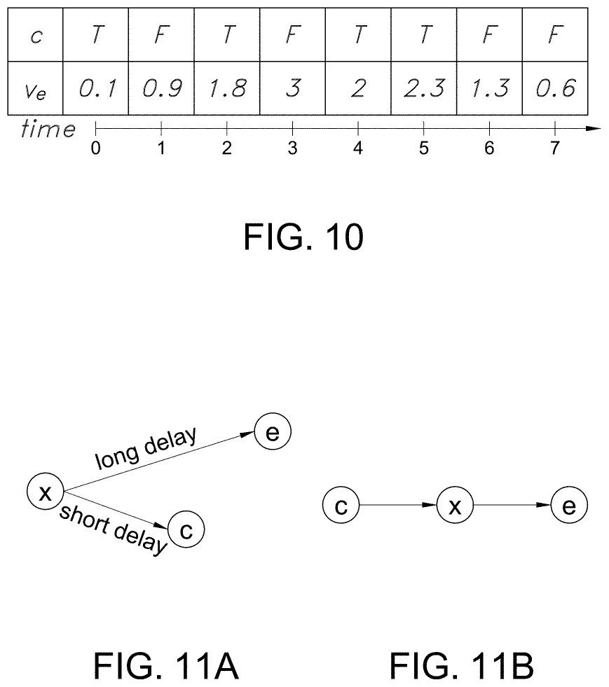

In order to further illustrate, shown in FIG. 10 is a short sequence of observed values of a continuous variable vₑ and an event c.

In particular, FIG. 10 illustrates a sequence of continuous variables in inferring a potential cause. Assuming there is a short sequence of a continuous variable vₑ and an event c. With a time delay of 1 unit, there is E[vₑ]=1.5, averaging all values of vₑ, and

E[vₑ|c]=(0.9+3+2.3+1.3)/4=1.875, so c should be a potential cause of vₑ according to Equation (9). 4. If instead an event e=[vₑ>E[e]], then P (e)=0.5 and P (e|c)=0.5, such that c is not a potential cause of e.

When considering a time shift of exactly 1 unit, E[vₑ]=1.5, which is the average of vₑ's values, and E[vₑ|c]=(0.9+3+2.3+1.3)/4=1.875. As E[vₑ|c]>E[e], c increases the expected value of vₑ and thus is a potential cause of it. However, if the system seeks to determine the positive cause by instead bounding vₑ to a specific range, or to a specific value such as a mean of vₑ, the event e would be defined as [vₑ>E[vₑ]]. Then, the result would have P (e)=0.5 (e occurs 4 times out of 8 time points) and P (e|c)=0.5 (2 out of 4), where c would not be considered a potential cause because it is not raising the probability of e. This shows the reduced sensitivity to change that comes with trying to be more specific.

One can further generalize this theory to a set of causes X of an effect e. The system would measure the influence of X towards e by calculating the change of the probability of e as P(e|X)−P(e) or the change of expected value of vₑ as E[vₑ|X]−E[vₑ], depending on the definition of e. Note that while the conditional probability is bounded within [0, 1], the expected value could be any amount, and either positive or negative.

However, the causal relation between events c and e is only considered potential if they satisfy Equations (8) or (9). In certain embodiments, this is due to two possible situations where 1) c and e are actually independent but are commonly caused by another event x (the confounder) with c being caused earlier than e (referring to FIG. 11A), or 2) c causes e indirectly via x (chaining, as shown in FIG. 11B). In either condition, it is observed that Equation (8) or (9) holds and erroneously mark c as directly causing e. One way to eliminate such error is to compare the distribution of e when c and x both occur, for example, P (e|c∧x), to that when only x is present, for example, P (e|¬c∧x). Then, the two will be found equal (or almost equal) if c is a spurious cause of e.

Shown in FIG. 11, are two situations where an event c can be erroneously considered as causing the event e with Equations 8 and 9. In FIG. 11A, c and e are independent but are commonly caused by the confounder event x with c being caused earlier than e. In FIG. 11B, c causes e by chaining via another event x.

When considering multiple time series in a dataset, for a given effect, it can be recognized by a number of potential causes. In order to identify the real causes that can better explain the effect, Eells (citing E. Eells. Probabilistic causality. Cambridge University Press, 1991) proposed the average significance of a potential cause c, among all potential causes X towards the effect e as defined by Equation (11) as:

$${ɛ}_{a v g} ( c , e ) = {\sum }_{x ϵ X / c} \frac{P ( e \vert c ⩓ x ) - P ( e {\vert}_{⫬} c ⩓ x )}{\vert X / c \vert} \qquad Equation ( 11 )$$

where X/c is the set of potential causes excluding c and |X/c| is the number of events in it. At least two potential causes are required in certain embodiments in order to make the computation meaningful and all calculations are associated with a preset time window. Then, by setting a certain threshold ε, c is called an ε-significant cause of e if |ε_{avg}(c, e)≥ε. Further, if e stands for the increase or decrease of a continuous variable vₑ over the time window, the conditional probability in Equation (11) hereinabove can be replaced by the conditional expected value such that is defined by Equation (12) hereinbelow as:

$${ɛ}_{a v g} ( c , e ) = {\sum }_{x ϵ X / c} \frac{E [ {v}_{e} \vert c ⩓ x ] - E [ {v}_{e} {\vert}_{⫬} c ⩓ x ]}{\vert X / c \vert} \qquad Equation ( 12 )$$

Although the ε threshold is decisive in testing if a cause is significant, its value can be difficult to determine automatically in practice. In presence of a large number of (for example, thousands) potential causes where significant causes are rare, the ε_{avg} values of all potential causes usually follow a Gaussian distribution. As a result, the problem can be solved by testing the significance of a null hypothesis where significant values favoring the non-null hypothesis deviate from the distribution. However, this theoretical method cannot really be applied in most of the disclosed embodiments, since such a large number of time-series and causal events are rarely encountered, especially when just seeking to explore the impact of some specific causes on the target. In such cases, the ε threshold can only be assigned empirically and interactively by the analyst. This requirement for user assistance, together with other analytical tasks that are described hereinbelow in greater detail, necessitated the disclosed visual analytics system.

Since a potential cause elevates the probability (referring to Equation (8)) or alters the expected value (referring to Equation (9)) of the effect, the process of searching for a cause c is the same as deciding an appropriate numerical constraint on the cause variable v_{c}, on which c is made, so that Equations (8) or (9) can be satisfied. This is relatively easy and straightforward when v_{c} has discrete values, where the system can simply scan through v_{c}'s domain and make c take all the values satisfying the condition. The search becomes more complex when v_{c} is continuous. One solution is to discretize v_{c} and then apply the same scanning process, but determining a discretization strategy is difficult. The disclosed system and method addresses such drawbacks by instead only analyzing at v_{c} at time points t where e holds after the specified time delay (i.e. v_{c}(t) [symbol] ≥r, ≤sₑ), and record all such v_{c}(t) as T_{c}. Next, the system discretizes v_{c} adaptively by clustering values in T_{c}. The idea is to consider values that v_{c} frequently takes and leads to the occurrence of e as possibly causing e.

The clustering process takes a similar approach as the incremental clustering for high-dimensional data but is applied in 1-D. The disclosed system iteratively scans values in T_{c} until all clusters converge or the algorithm reaches a maximum number of iterations. In each iteration, a value is assigned to a cluster center if the distance between them is smaller than some threshold θ. A new cluster is added when a point is too far away from all clusters. The threshold θ controls the size of the clusters, which decides how v_{c} will be discretized later. Finally, the system transforms v_{c} by considering the value range each cluster covers as a level, and test if it fulfills Equations 8 or 9. If multiple levels are returned, the system seeks to merge them if they overlap and takes the one that best elevates e as the most possible cause. An exemplary set of pseudo code is provided hereinbelow in Algorithm 1.

Algorithm 1: Estimating a potential cause

Input: The effect event e, a continuous variable v_{c}, distance threshold θ,
max iteration n
Output: A potential cause c of e

| | |
|---|---|
| 1 | T_{c} = {v_{c}(t)\|v_{c}(t) [symbol] ≥ r, ≤ sₑ}}; |
| 2 | i = 1; |
| 3 | clusters = [{the first value in T_{c}}]; |
| 4 | while i ≤ n and clusters not converging do |
| 5 | foreach v ∈ T_{c} do |
| 6 | foreach cluster center α ∈ clusters do |
| 7 | if \|α − v \| < θ then |
| 8 | Add v to α; |
| 9 | else |
| 10 | Make v a new center in clusters; |
| 11 | end |
| 12 | end |
| 13 | end |
| 14 | Update all cluster centers and remove outliers; |
| 15 | i = i + 1; |
| 16 | end |
| 17 | foreach k ∈ clusters do |
| 18 | Make cₖ an event on v_{c} constrained by values in k; |
| 19 | Check if cₖ satisfies Eq. 8 or 9; |
| 20 | end |
| 21 | Merge events if their value constraints overlap; |
| 22 | return the event c ∈ {cₖ} that maximally elevates e |

In certain aspects or embodiments, the system modifies the incremental process such that it searches clusters in batches instead of singly incremented, and then the algorithm can be easily parallelized, enabling scalability. Also, the trade-off of taking different θ values is that a larger θ tends to produce a looser constraint (a larger value range of v_{c}) in c, often resulting in a smaller P (e|c) or an E[vₑ|c] closer to E[vₑ]—a smaller θ results in the opposite. This is similar to the problem of under-/over-fitting. In example implementations, when θ equals 0.15 of v_{c}'s value, the range often reaches satisfying results within five (5) iterations

In order to guide the design of the disclosed system, many causality theories were reviewed, especially on logic-based causality, and their applications in different fields. The high-level analytical tasks were identified and considered for the currently disclosed system as described in greater detail hereinbelow.

One of the important tasks (T1) of the disclosed system is generating causal propositions and hypotheses. Identifying important phenomena in time and generating hypothetical causal relations between them is often the first step in causality analysis. Most current work on temporal causality achieves this either by manually grouping relevant data values and then assigning them semantic meanings or by conducting an exhaustive search after evenly partitioning the data into a large amount of sections each considered an event. Both of these approaches are limited in efficiency and flexibility. As in logic-based causality, a causal relation is defined over a time lagged conditional distribution, analysts should be given direct access to such information so that causal propositions and hypotheses can be generated with visual support. In addition, since an effect can have multiple causes, an overview of the values and boolean labels of each time series in a synchronized fashion could also help for observing the compound relations. The disclosed system and method provides such access.

A second important task (T2) is to identify significant causes under specified time delay. Revealing the true causes of an effect under a certain window of time delay is the most common task when investigating causality within time series. Examples are found in temporal causality analysis of for example, the stock market, biomedical data, social activities, and terrorist activities. While the significance threshold determining the truthfulness of causes may often need to be decided empirically, a visual system should externalize the levels of significance of each cause and provide interactive tools supporting the analyst's decision-making process. The disclosed system provides such capability.

Yet, a third important task (T3) is the capability to analyze the change of causal influences over time. The level of significances and influences of a cause toward the effect could differ over different windows of time delay. Thus, it is often considered valuable to analyze such change, so that the proper timespan of a causal relation can be identified, as well as a proper window of time delay for identifying other significant causes. The latter, however, is mostly assigned empirically with a limited set of values in the mentioned examples. When the knowledge on the data is incomplete, a visual analytics system should support analysts in such tasks by providing the causal influences toward the effect associated with all possible time delays in consideration. The disclosed system also provides such capability.

Yet, a fourth important task (T4) is interactive analysis. As mentioned, logic-based causality analysis can often be associated with a number of parameters to be determined by analysts empirically, e.g., the numerical constraints in the causal propositions, the window of time delay, and the threshold in the significance tests. Determining all these parameters is an essential task in temporal causality analysis and often requires interaction. This is also the case in many existing visual analytics systems for causality analysis without time. In order to support interactive analysis, the system should provide visual feedback along with each of the user's operations and the updates of the parameters. Users should also be able to save the discoveries in an overview for later re-examination. In summary, the disclosed visual causality analysis with time is an interactive process of generating and testing causal hypotheses and deciding proper time windows. Hence, a dedicated analytics system supports analysts in this process couple with automated visual feedback in accordance with an embodiment of the disclosed system and method.

FIG. 12 illustrates an exemplary visual analytics interface for analyzing the Air Quality dataset. In FIG. 12A, the interface consists of the conditional distribution view for generating temporal events and causal hypothesis. In FIG. 12B, illustrated is the causal inference panel comprising several components for analyzing temporal causal relations. In FIG. 12C the time sequence view is illustrated for examining synchronized time series. The interface facilitates examination and recognition of temporal causal relations. FIG. 12D provides an illustration of the causal flow chart displaying an overview of the established causal relations. Each of FIGS. 12A-12D provide respective illustrations in accordance with an embodiment of the disclosed system and method.

FIG. 12 shows an overview of a visual analytics interface analyzing the Air Quality dataset. The exemplary interface is composed of a conditional distribution view (shown in FIG. 12A) for generating causal propositions and hypotheses, the causal inference panel (shown in FIG. 12B) consisting of several visual components for testing causal relations with time delays, the time sequence view (shown in FIG. 12C) for examining synchronized values and labels across time series, and the causal flow chart (shown in FIG. 12D) providing an overview of the recognized causal relations. The causal inference panel helps to automate the temporal causal inference process. The interface runs in a web browser. All of the example interactive visualizations are implemented with D3.js and the UI is constructed with Semantic-UI (for example, https://semantic-ui.com/). The causality analysis modules and server APIs are coded in Python with Flask. Datasets are maintained with MongoDB.

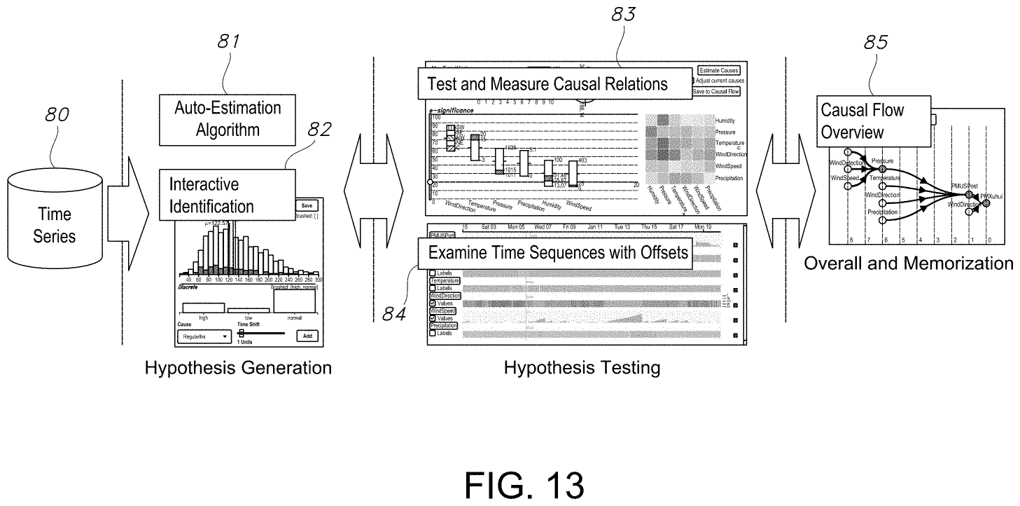

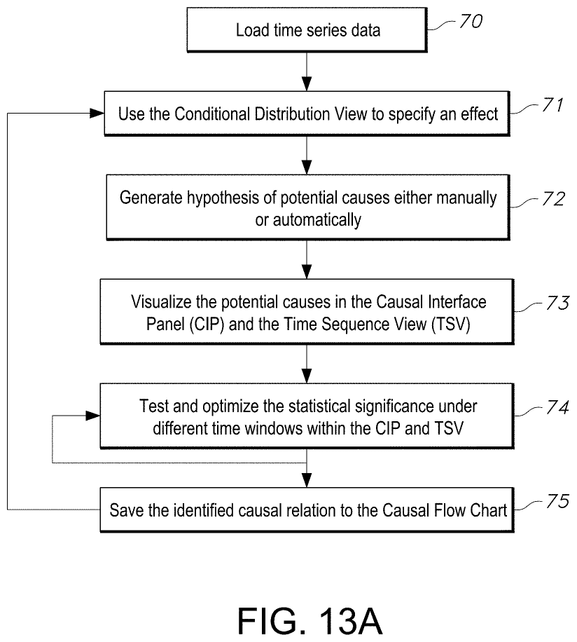

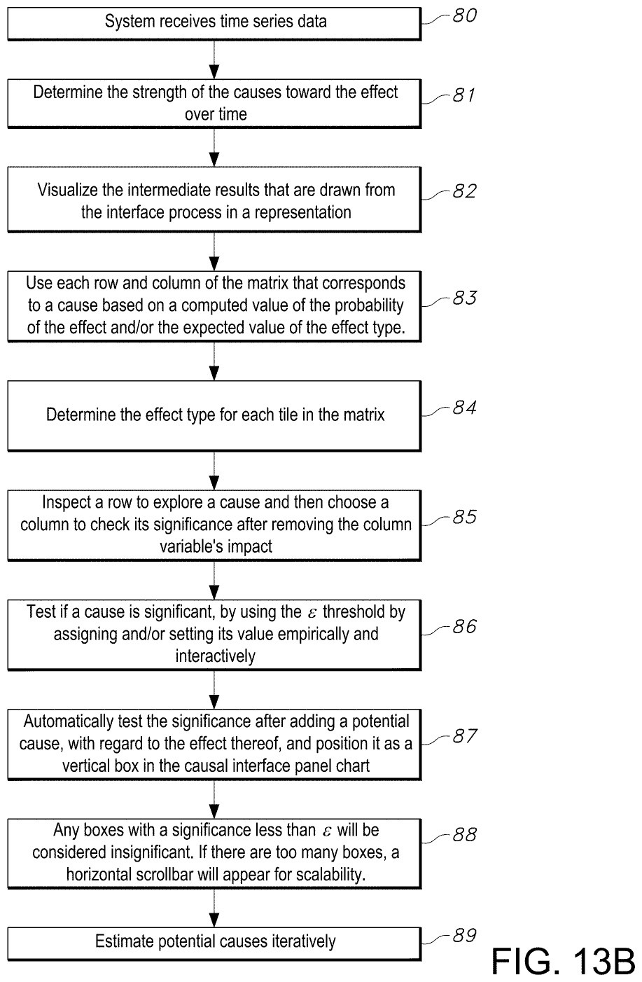

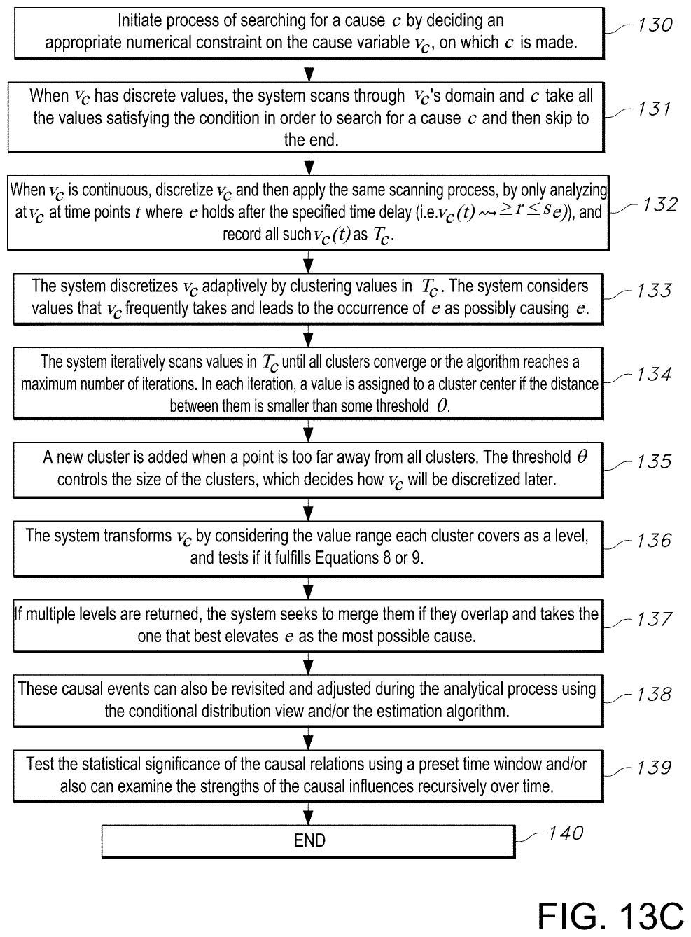

An illustration of an analytical pipeline associated with an exemplary visual analytics system is provided in FIG. 13. In particular, a user first generates hypotheses either interactively or automatically. The added events are tested and visualized in the causal inference panel and the time sequence view. At last, results can be saved and revisited with the causal flow.

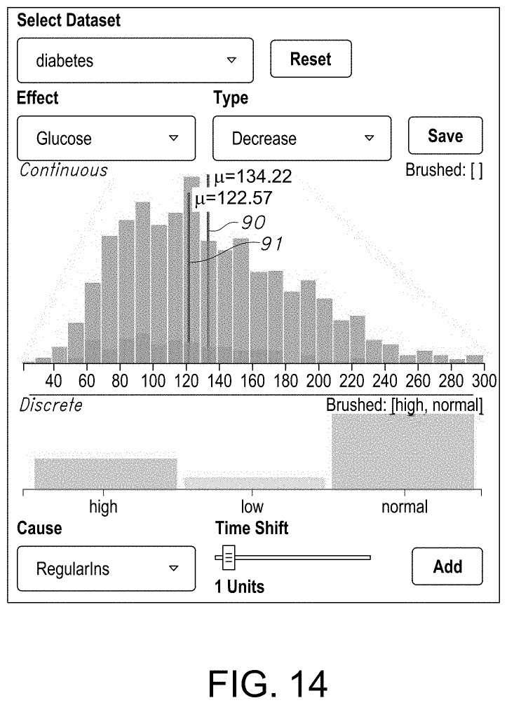

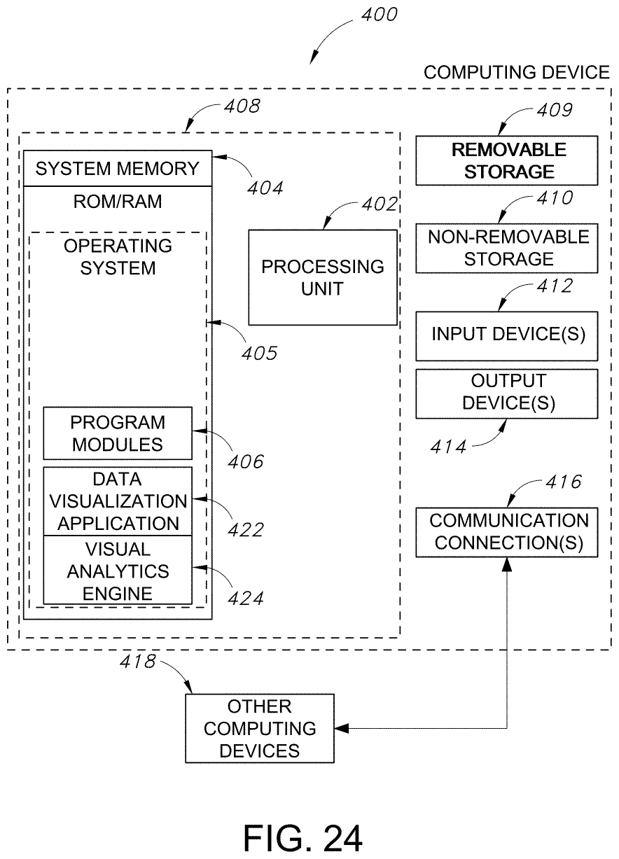

After loading in the time series 80, the user first uses the conditional distribution view, for example as shown in FIG. 14, to specify an effect phenomenon. Next, the system then generates causal hypotheses of potential causes either manually with the interactive identification 82 utility or automatically with the estimation algorithm 81 (Tasks: T1, T4). Next, the identified causal events are visualized 84 in the causal inference panel as well as in the time sequence view. These causal events can also be revisited and adjusted during the analytical process in the conditional distribution view (as shown in FIG. 24) and with the estimation algorithm. Using the interactive components, the user can test 83 the statistical significance of the causal relations under a preset time window and examine the strengths of the causal influences recursively over time 84 (Tasks: T2, T3, T4 as defined hereinabove).

After reaching a set of reliable causal relations with a proper time offset, the user may save the results to the causal flow chart 85. The causal flow chart 85 provides an overview of all recognized causal relations, as well as a repository in which a user can revisit saved results and further extend the causal chains along time with all the other visual components (T4).

The design and functionality of each component of the visual analytics interface is further described. An example simple medical dataset is utilized, which is part of a complex dataset fetched from the UCI repository. The dataset has three time series recoded in a 1-hour interval, monitoring a patient's intake of two types of insulin (RegularIns and UltralenteIns), and the blood glucose level (Glucose). The patient took RegularIns regularly at a low, normal, or high dose and sometimes took UltralenteIns together.

The Conditional Distribution View as shown in enlarged view in FIG. 14, provides a potential cause that is defined as an event that perturbs the distribution of the effect with time delays. In particular, FIG. 14 illustrates a visualization providing the conditional distribution view displaying the distribution (top graph—blue bars) and the conditional distribution (top graph—green bars) of the variable Glucose, in accordance with an embodiment of the disclosed system and method. The later is conditioning on [RegularIns∈ {normal, high}] (bottom bars) with 1 unit time delay. The blue 90 and green 91 vertical lines show the expected value of Glucose before and after the conditioning.

Such conditional distribution view allows analysts to directly observe the time-lagged phenomenon and hence make causal hypotheses. This view features two histograms, one on the top for the effect variable and one on the bottom for the cause variable. On the bottom histogram, a user can brush (if the variable is continuous) or click (if discrete) to set a value constraint on the cause variable. After setting the time shift using the bottom slider, a time-lagged conditional distribution will be rendered overlapping the top histogram. The user can select the effect type as ValueIn and brush on the top histogram to setup a Boolean valued effect, so that its causes will be later tested using Equations 8 and 11. If the effect variable is continuous, the event type can also be either Increase or Decrease so that Equations 9 and 12 can be applied to search for its positive or negative causes.

As mentioned hereinabove, FIG. 14 illustrates an example using the conditional distribution view to analyze a medical dataset. The analysis is whether taking the regular insulin can indeed reduce the patient's blood glucose. The user can select Glucose as the effect variable, rendering the blue histogram as shown in FIG. 14. Since the variable is continuous, the effect type Decrease is selected indicating that the user and/or system is seeking its negative causes. Next, the discrete variable RegularIns is selected as the cause, rendering the bars on the bottom of FIG. 14. After clicking and/or selecting the bars of high and normal and setting a 1 unit time delay, a conditional distribution is rendered as the green bars overlapping the blue ones in FIG. 14. Since RegularIns has many missing values (the patient only takes insulin three or four times a day), the green bars are much shorter as a result. The blue 90 and green 91 lines in the top histogram of FIG. 14 represent the expected values of the original and the conditional distribution, respectively. As it is observed that the expected value of Glucose is lowered from 134μ(as shown in blue line 90) to 122μ (as shown in green line 91), the ‘Add’ button may be selected, adding [RegularIns∈{high,normal}] as a potential cause to be tested.

The Causal Inference Panel is shown in FIG. 12B. The causal inference panel consists of several parts, as shown in FIG. 12B: 1) an area chart with a slider shows the influences of the causes over time; 2) a donut chart next to the area chart emphasizes the strength of the causal influences at the specified time delay; 3) a box chart visualizes the causes ranked by their significance; 4) a colored matrix on the bottom-right corner visualizes the decomposed results from the significance tests described hereinabove. Controls for the estimation algorithm are shown on the top right button in FIG. 12B.

After adding a potential cause, the system will automatically test its significance with regard to the effect and position it as a vertical box in the box chart. The boxes are ordered by significance and a small handle attached to each box in the center indicates its significance level. Users can move a vertical slider up and down to set the ε-threshold. All boxes with a significance less than ε will be considered insignificant and rendered in gray. If there are too many boxes, a horizontal scrollbar will appear for scalability.

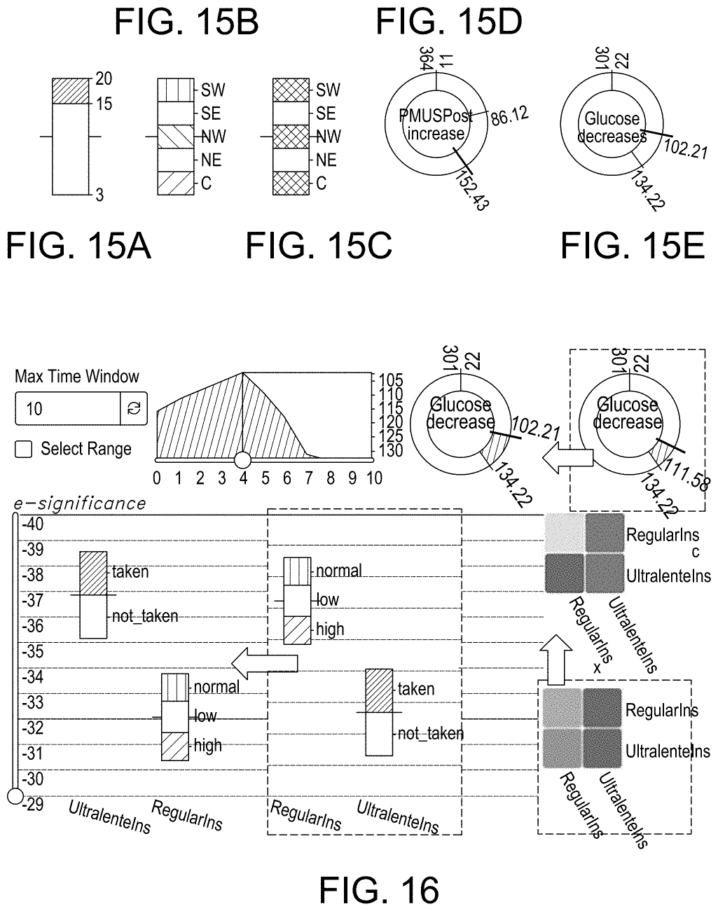

The visual encoding of the boxes is shown in FIGS. 15A-C. All boxes have the same size. The colored segments in a box represent the value constraint of the event, annotated by the labels on the right. For a significant cause, the color scheme is decided by its continuous value type (shown in FIG. 15A) or discrete (shown in FIG. 15B) value type, otherwise, is colored gray (shown in FIG. 15C).

FIG. 15 provides an illustration including a visual encoding of events in the causal inference panel. FIG. 15A illustrates a box in the box chart representing a significant cause exerted on a continuous variable. FIG. 15B illustrates a significant cause exerted on a discrete variable. FIG. 15C illustrates a insignificant cause. FIG. 15D illustrates a positive effect (Increase type) with elevated expected value. FIG. 15E illustrates a negative effect (Decrease type). Each of FIGS. 15A-15E provide respective illustrations each in accordance with an embodiment of the disclosed system and method.

Referring back to FIG. 12B, the area chart depicted in FIG. 12B visualizes the strength of the causes toward the effect over time. When looking for causes of a Decrease type effect, a lower expected value is considered a stronger influence. The area chart is colored red to indicate this, else it is colored green (as shown in FIG. 12B). The donut chart next to the area chart uses the same color scheme and shows the effect variable's expected value or probability change at the current time delay setting. The two indicators show the exact value difference (referring to FIGS. 15C-15D). The slider below the area chart sets the time delay used in the significance tests, either as an exact number of units or a window (by checking Select Range box in FIG. 12B to show two handles). Whenever the slider moves, the box and donut charts will update according to the results delivered from the causality analysis. Moving the threshold slider in the box chart will also update these two charts—only significant causes influence the effect variable, in certain embodiments.

The colored matrix on the right side of FIG. 12B visualizes the intermediate results from the inference process. Each row and column of the matrix corresponds to a cause. A tile in the diagonal is colored according to the value of P (e|c)−P (e) or E[vₑ|c]−E[vₑ] as defined in Equations 8 or 9. A non-diagonal tile at row of cause c and column of cause x is colored by the value of P (e|c∧x)−P (e|¬c∧x) or E[vₑ|c∧x]−E[vₑ|¬c∧x] as defined by Equations 11 and 12. If the effect type is Decrease, tiles with negative values will be colored blue and positive values are colored red. If the effect type is instead Increase, the opposite scheme applies. Therefore, a tile with negative values will be colored blue and positive values are red. The value, and the equation used for computing the value, will pop up as a tooltip when the user hovers the mouse over a tile. In this way, the user can inspect a row to explore a cause and then choose a column to check its significance after removing the column variable's impact.

The design of the visualizations is mainly motivated by the analytical tasks that the user/expert desires to support. For instance, the pairwise character of the intermediate results from Equations 11 and 12 naturally inspired the matrix view. However, feedback from visualization experts was also taken into account. For example, one design has a circular layout visualized all events in form of donut charts. In this layout the effect was placed in the center, surrounded by the causes. However, this design lacks scalability. The circle would become too crowded with a large number of donuts, and causes with similar significance were potentially placed far away from one another, which made comparisons difficult. However, the horizontal box chart can overcome these issues and thus is considered a more preferred embodiment for analysts.

In order to illustrate further, the medical dataset example shown in FIG. 16 can be referred to. FIG. 16 provides an illustration of an analytics visualization using the medical dataset. The causal inference panel provides visualization of analyzing the influence of RegularIns and UltralenteIns on Glucose. With a 1 unit time delay, all visualizations are in the state as shown in the dashed area, with RegularIns being a more effective cause lowering Glucose. However, with a 4 units offset, the panel updates and UltralenteIns becomes the more significant one.

In particular, the box configuration in the dashed inset of FIG. 16 shows the outcome of the analysis presented in FIG. 14 hereinabove, where the time delay was set to 1 hour and RegularIns was chosen as the main cause, with another potential cause being [Ultra-lenteIns=taken]. The inset shows that RegularIns is a more significant cause than UltralenteIns at that 1 hour time delay. However, the area chart in FIG. 16 indicates that the max effect is reached after 4 hours. Therefore, by moving the time slider to 4, all visualizations in the panel update and it is observed that UltralenteIns now becomes the most significant cause. This essentially means that while both insulins are effective at lowering the blood sugar level of the patient, the UltralenteIns reaches the peak effect at a later time.

More detail can be revealed when inspecting the two matrices in FIG. 16, where the diagonal tile of UltralenteIns always has a darker color than RegularIns. However, with a 1 hour delay (matrix inside the dashed box in FIG. 16), the tile at [row=RegularIns, col=UltralenteIns] is darker than that of [row=UltralenteIns, col=RegularIns]. This means the spurious effect of UltralenteIns is removed in the significance test, making RegularIns the more important cause for reducing Glucose. This situation is reversed with the 4 hour delay, thus col=UltralenteIns becomes the more significant one. It also would be represented with a darker tile which in such case, indicates that its effect is larger.

Being able to examine time sequences is a requirement for time series analytical systems. The disclosed time sequence view (as shown in FIG. 12C) presents an enhanced rendering of this. The time sequences are stacked, with the specified effect on the top. In an embodiment, each of the sequences can be rendered in two modes: 1) label mode; and 2) value mode, which can be switched by clicking the check box on the left. The first mode (label mode) visualizes the Boolean labels of an event at each time as a strip of colored bars (green for true, red for false, referring to the Humidity sequence shown in FIG. 12C). The value mode visualizes the sequence either as an area chart if the variable is continuous (referring to the WindSpeed shown in FIG. 12C), or as a strip of bars colored by the level the discrete variable takes at each point of time (referring to the WindDirection in FIG. 12C) with the legend on the right. In both cases, missing values are left blank and long sequences are scrollable.

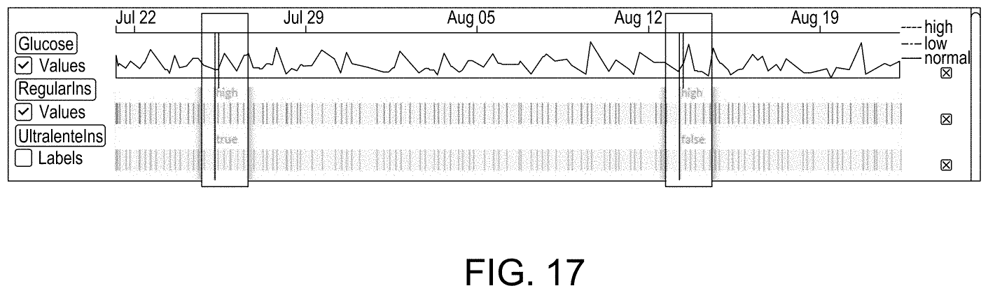

A user can click on the variable name of a sequence to revisit and adjust the event's value constraint in the conditional distribution view. An event can be removed with the delete button on the right of the sequence. Two indicator lines will be rendered and move along with the mouse pointer. The longer line shows the value or label, depending on the visualization mode, of each cause at the time point the pointer is hovering on. The other shows the value or label of the effect ahead with a time shift in line with the setting in the inference panel. FIG. 17 provides an example of an exemplary illustrative medical dataset where the sequences of Glucose and RegularIns are in value mode and UltralenteIns is in label mode.

In particular, FIG. 17 provides the time sequence view visualizing the illustrative medical dataset with a 4 unit time offset. The two highlighted areas are observations when moving the mouse pointer over the sequences, indicating that taking UntralenteIns together with RegularIns would help reduce Glucose level.

Using the 4 unit delay as set earlier, by moving the mouse over the sequences, FIG. 17 shows the indicator lines at two respective time points. It is observed that with the same dose of RegularIns, the Glucose would have a lower value if UltralenteIns=taken, which confirms the earlier determination as described hereinabove.

The Causal Flow Chart as shown in FIG. 12D, provides an illustration of a chart displaying an overview of established causal relations. After a proper set of causes and the time delay is obtained, the user can save the results into the causal flow chart shown in FIG. 12D, by clicking the Save to Causal Flow button at the top-right corner of FIG. 12B. If some previous result exist, the visual analytics system will seek to merge them by matching the nodes representing the same event and build a tree structure with the significant causal relations. The causal tree is laid out in a similar fashion as the causal flow diagrams as described hereinabove for example, in connection with FIGS. 3A-3C. However, instead of equally spacing nodes in different levels of the flow, the nodes are situated such that the distance between a cause and an effect signifies their time lag. This is also informed by the time axis on the bottom and the dashed indicator lines. The link's color indicates the type of the effect—red links point to Decrease and green links to Increase or ValueIn. The nodes in the chart can be reloaded either as a cause or an effect. The disclosed system in certain embodiments, will automatically decide if it should be reloaded or merged into the current relations.

Current visual analytics systems work on using visual analytics to determine causality relations among variables and have mostly been based on the concept of counterfactuals. As such, the derived static causal networks did not take into account the effect of time as an indicator for causal dependencies. However, knowing when a change in a causal relation will occur can be crucial for decision making as it affects how and when actions should be taken. In order to address this need, the novel visual analytics system and method, is dedicated visual analytics system that guides analysts in the task of investigating events in time series to discover causal relations associated with windows of time delay. In order to make the search efficient, novel algorithms are implemented (as described hereinabove with respect to Equations 8 and 9 that can automatically identify potential causes of specified effects. The system leverages probabilistic-based causality to help analysts test the significance of each potential cause and measure their influences toward the effect. The interactive interface features a conditional distribution view and a time sequence view for interactive causal proposition and hypothesis generation, as well as a novel box plot for visualizing significance and influences of causal relations over the time window. Analytical results for different effects can be intuitively visualized in a causal flow diagram. The effectiveness of the system with several exemplary case studies using real-world datasets is further described hereinabove.

Referring to FIG. 13A, shown is a flowchart outlining the steps in generating time series based analytics and identified causal relations in generating a causal flow chart. The visual analytics system performs visual analytics on temporal events by analyzing dependencies among temporal events, in certain embodiments. Logic-based causality was devised more recently for analyzing the dependencies among temporal events. It depicts causality as hypothetical relations between logic propositions with an arbitrary time lag. The true causes among all potential ones can then be identified via significance tests. The disclosed system further improves upon such logic-based causality and applies it in the disclosed novel visual analytics pipeline. The novel framework also enables human analysts to be effectively involved in the interactive analysis process. In addition, the disclosed system implements logic based causality theories to infer dependencies between events in time more effectively and efficiently.

In particular, FIG. 13A provides a flowchart illustration of an exemplary process used in generating time series based analytics in order to identify causal relations in generating a analytics based causal flow representation, in accordance with an embodiment of the disclosed system and method. In step 70, the system loads time series based data used in the analysis of time-based phenomena associated with such data. The system implements a conditional distribution view in order to generate causal propositions and hypotheses, for example as shown and described hereinabove in connection with FIG. 12A and FIG. 14. The conditional distribution view is implemented by the disclosed system in order to specify an effect in step 71.

The conditional distribution view in step 71 allows analysts to directly observe the time-lagged phenomenon and hence make causal hypotheses. This conditional distribution view (for example, shown in FIG. 12A or FIG. 14) features two histograms, one on the top for the effect variable and one on the bottom for the cause variable. On the bottom histogram, a user can brush (if the variable is continuous) or click (if discrete) to set a value constraint on the cause variable. After setting the time shift using the bottom slider, a time-lagged conditional distribution will be rendered overlapping the top histogram.

During step 72, after loading in the time series data in step 70, the conditional distribution view (for example shown in FIG. 12A, top green chart in FIG. 12B, or FIG. 14), is used to specify an effect phenomenon. Such conditional view visualizes the precomputed strengths of the causes for the chosen effect for the respective time delays. Such conditional distribution view facilitates the generating of causal hypotheses of potential causes either manually with the interactive utility or automatically using an estimation algorithm (T1—to generate causal propositions and hypotheses; T4—perform interactive analysis). It is noted that controls for the estimation algorithm are placed on the top right “estimate causes” button shown in FIG. 12B and thereby permits interactive analysis.

In certain embodiments using a clustering technique at the specified time delay, the value ranges of a given cause variable at which the effect occurs can be determined. This is shown for example in the color box chart, shown in FIG. 12B, wherein the WindDirection variable has several value intervals (shown in different boxes with emphasis of varying directional lines (vertical, left diagonal, right diagonal lines)). The other variables all have single value ranges of different interval widths (for example for cause variables shown as Temperature, Pressure, Precipitation, Humidity, WindSpeed).

Hence, two above-described automated processes are occurring. The area chart shown in top FIG. 12B, shown in green, visualizes the precomputed strengths of the causes for the chosen effect for all time delays. In addition, a clustering technique may be implemented at the specified time delay shown in box chart of FIG. 12B, to determine and show where the value intervals occur, for example, at a particular c-significance value for variable, WindDirection.

Next, the identified causal events are generated by the system and hence, now visualized in the causal inference panel 83 in FIG. 13 and/or in the time sequence view 84 in FIG. 13, during step 73.

In certain aspects or embodiments, the causal inference panel consists of several parts, as shown in FIG. 12B: 1) an area chart with a slider shows the influences of the causes over time; 2) a donut chart next to the area chart emphasizes the strength of the causal influences at the specified time delay; 3) a box chart visualizes the causes ranked by their significance; and/or 4) a colored matrix on the bottom-right corner visualizes the decomposed results from the significance tests. Controls for the estimation algorithm are located on the top right corner of the inference panel shown in example interface in FIG. 12B.

In particular, the colored matrix on the right side of FIG. 12B visualizes the intermediate results that are drawn from the inference process. Each row and column of the matrix corresponds to a cause that is associated with a computed value of the probability of the effect and/or the expected value of the effect type. A tile in the diagonal is colored according to the computed value of P (e|c)−P (e) or E[vₑ|c]−E[vₑ] as defined in Equations 8 or 9. A non-diagonal tile at row of cause c and column of cause x is colored based on the computed value of P (e|c∧x)−P (e|¬c∧x) or E[vₑ|c∧x]−E[vₑ|¬c∧x] as defined by Equations 11 and 12. If the effect type is Decrease, tiles with negative values will be colored blue and positive red. If the effect type is instead Increase, the opposite scheme applies. Therefore, a tile with negative values will be colored red and positive values are blue. The value, and the equation used for computing the value, will pop up as a tooltip when the user hovers the mouse over a tile. In this way, the user can inspect a row to explore a cause and then choose a column to check its significance after removing the column variable's impact.

It is noted that while the c threshold is decisive in testing if a cause is significant, its value can be difficult to determine automatically in practice. The drawbacks of such determinations for example in computing ε_{avg} values of all potential causes by using Equations (11) and (12), are addressed and improved by the disclosed system and method. In particular, the c threshold value can be assigned empirically and interactively by an analyst in certain embodiments, using the disclosed system and method.

The disclosed system and method will automatically test the significance after adding a potential cause, specifically with regard to the effect thereof, and position it as a vertical box in the causal inference panel chart (as shown in FIGS. 15A-E). The boxes are ordered by significance and a small handle attached to each box in the center indicates its significance level. Hence, users can then move a vertical slider up and down to set the ε-threshold. All boxes with a significance less than ε will be considered insignificant and rendered in gray in FIG. 15C. If there are too many boxes, a horizontal scrollbar will appear for scalability.

Since a potential cause elevates the probability (referring to Equation (8)) or alters the expected value (referring to Equation (9)) of the effect, the process of searching for a cause c is the same as deciding an appropriate numerical constraint on the cause variable v_{c}, on which c is made, so that Equations (8) or (9) can be satisfied. This is relatively easy and straightforward when v_{c} has discrete values, where the system can simply scan through v_{c}'s domain and make c take all the values satisfying the condition. The search becomes more complex when v_{c} is continuous. One solution is to discretize v_{c} and then apply the same scanning process, but determining a discretization strategy is difficult. The disclosed system and method addresses such drawbacks, by instead only analyzing at v_{c} at time points t where e holds after the specified time delay (i.e. v_{c}(t) [symbol] ≥r, ≤sₑ), and record all such v_{c}(t) as T_{c}. Next, the system discretizes v_{c} adaptively by clustering values in T_{c}. The idea is to consider values that v_{c} frequently takes and leads to the occurrence of e as possibly causing e.

Hence, the clustering process takes a similar approach as the incremental clustering for high-dimensional data but is applied in 1-D. The system iteratively scans values in T_{c} until all clusters converge or the algorithm reaches a maximum number of iterations. In each iteration, a value is assigned to a cluster center if the distance between them is smaller than some threshold θ. A new cluster is added when a point is too far away from all clusters. The threshold θ controls the size of the clusters, which decides how v_{c} will be discretized later. Finally, the system transforms v_{c} by considering the value range each cluster covers as a level, and test if it fulfills Equations 8 or 9. If multiple levels are returned, the system seeks to merge them if they overlap and takes the one that best elevates e as the most possible cause. An exemplary set of pseudo code is provided hereinabove in Algorithm 1.

In certain aspects or embodiments, the system modifies the incremental process such that it searches clusters in batches instead of singly incremented, and then the algorithm can be easily parallelized, enabling scalability. Also, the trade-off of taking different θ values is that a larger θ tends to produce a looser constraint (a larger value range of v_{c}) in c, often resulting in a smaller P (e|c) or an E[vₑ|c] closer to E[vₑ]. Whereas, a smaller θ results in the opposite—a tighter constraint (a constraint with a smaller value range of v_{c}) in c, often resulting in a larger P (e|c) or an E[vₑ|c] more distant to E[vₑ]. This is similar to the problem of under-/over-fitting. In example implementations, when θ equals 0.15 of v_{c}'s value, the range often reaches satisfying results within 5 iterations.

These causal events can also be revisited and adjusted during the analytical process using the conditional distribution view and/or the estimation algorithm in step 74 (T4). Using the interactive components of the interactive user interface, for example shown in FIG. 12, the user can test the statistical significance of the causal relations in step 74 using a preset time window and/or also can examine the strengths of the causal influences recursively over time (using tools or tasks T2—identify significant causes under specified time delay; Task T3—analyze the change of causal influences over time; Task T4—interactive analysis).

In particular, after adding a potential cause, the visual interface system will automatically test the significance with regard to the effect and position it as a vertical box in the box chart. The boxes are ordered by significance and a small handle attached to each box in the center indicates its significance level. Users can move a vertical slider up and down to set the ε-threshold. All boxes with a significance less than ε will be considered insignificant and rendered in gray. If there are too many boxes, a horizontal scrollbar will appear for scalability.

The visual encoding of the boxes is shown in example visualization in FIGS. 15A-C as described hereinabove. The boxes have the same size with the colored segments in a box representing the value constraint of the event, annotated by the labels on the right. For a significant cause, its color scheme is decided by its continuous (FIG. 15A) value type or discrete (FIG. 15B) value type. Otherwise, the boxes are colored gray (as shown in FIG. 15C).

After reaching a set of reliable causal relations with a proper time offset, the user may save the results to the causal flow chart in step 75, for example by storing to a computer readable medium or database. The causal flow chart provides an overview of all recognized causal relations, as well as a warehouse where a user can revisit saved results and further extend the causal chains along time with all the other visual components (using tool T4—interactive analysis).

FIG. 13B provides a flowchart illustration of an exemplary process used in time series based analytics in order to identify causal relations and estimate potential causes iteratively, in accordance with an embodiment of the disclosed system and method.

In step 80, the system receives time series data for visual analytics thereof. Next, in step 81, the system determines the strength of the causes toward the effect over time. The system in step 82 visualizes the intermediate results that are drawn from the inference process in a representation. In step 83, the system scans each row and column of a matrix representation that corresponds to a cause based on a computed value of the probability of the effect and/or the expected value of the effect type. In step 84, the system determines the effect type for each tile in the matrix.

For example, the colored matrix on the right side of FIG. 12B visualizes the intermediate results that are drawn from the inference process in step 82. Each row and column of the matrix corresponds to a cause that is associated with a computed value of the probability of the effect and/or the expected value of the effect type in step 83. A tile in the diagonal is colored according to the computed value of P (e|c)−P (e) or E[vₑ|c]−E[vₑ] as defined in Equations 8 or 9. A non-diagonal tile at row of cause c and column of cause x is colored based on the computed value of P (e|c∧x)−P (e|∫c∧x) or E[vₑ|c∧x]−E[vₑ|¬c∧x] as defined by Equations 11 and 12. If the effect type is Decrease, tiles with negative values will be colored blue and positive red in step 84. If the effect type is instead Increase, the opposite scheme applies in step 84. Therefore, a tile with negative values will be colored red and positive values are blue. The value, and the equation used for computing the value, will pop up for example, as a tooltip when the user hovers the mouse over a tile. In this way, the user can inspect a row to explore a cause and then choose a column to check its significance after removing the column variable's impact in step 85.

Therefore, the system inspects a row to explore a cause and then selects a column to check its significance after removing the column variable's impact in step 85. The system will test if a cause is significant in step 86, by using the ε threshold by assigning and/or setting its value empirically and interactively. The system will proceed to automatically test the significance after adding a potential cause, with regard to the effect thereof, and position it as a vertical box in the causal inference panel chart in step 87. Any boxes with a significance less than ε will be considered insignificant. If there are too many boxes, a horizontal scrollbar will appear for scalability in step 88. The system will proceed to estimate potential causes iteratively in step 89.

In particular, it is noted that while the c threshold is decisive in testing if a cause is significant, its value can be difficult to determine automatically in practice. The drawbacks of such determinations for example in computing ε_{avg} values of all potential causes by using Equations (11) and (12), are addressed and improved by the disclosed system and method. Hence, the ε threshold value can be assigned empirically and interactively in step 86 by an analyst in certain embodiments, using an embodiment of the disclosed system and method.

The disclosed system and method will automatically test the significance after adding a potential cause, specifically with regard to the effect thereof, and position it as a vertical box in the causal inference panel chart (as shown in FIGS. 15A-E). The boxes are ordered by significance and a small handle attached to each box in the center indicates its significance level. Hence, users can then move a vertical slider up and down to set the ε-threshold. All boxes with a significance less than ε in step 88 will be considered insignificant and rendered in gray in FIG. 15C. If there are too many boxes in step 88, a horizontal scrollbar will appear for scalability.

FIG. 13C provides a flowchart illustration of an exemplary process used in time series based analytics in order to identify and test statistical significance of respective causal relations, in accordance with an embodiment of the disclosed system and method.

In step 130, the system initiates the process of searching for a cause c by deciding an appropriate numerical constraint on the cause variable v_{c}, on which c is made. Next, when the system determines that v_{c} has discrete values, the system in step 131 proceeds to scan through v_{c}'s domain and c take all the values satisfying the condition in order to search for a cause c, and then skips to the end in step 140.

However, when the system determines that v_{c} is continuous, it proceeds to discretize v_{c} and then apply the same scanning process in step 131, by only analyzing at v_{c} at time points t where e holds after the specified time delay (i.e. v_{c}(t) [symbol] ≥r, ≤sₑ), and record all such v_{c}(t) as T_{c}.

The system next discretizes v_{c} adaptively by clustering values in T_{c} in step 133. The system considers values that v_{c} frequently takes and leads to the occurrence of e as possibly causing e.

The system iteratively scans values in T_{c} in step 134 until all clusters converge or the algorithm reaches a maximum number of iterations. In each iteration, a value is assigned to a cluster center if the distance between them is smaller than some threshold θ.

Next, in step 135, a new cluster is added when a point is too far away from all clusters. The threshold θ controls the size of the clusters, which decides how v_{c} will be discretized later, during which discretization process, the system generally proceeds to transfer continuous functions, models, variables, and equations into discrete counterparts, for respective evaluation by the system.

The system next transforms v_{c} by considering the value range each cluster covers as a level, and tests if it fulfills Equations 8 or 9 in step 136. If multiple levels are returned in step 137, the system seeks to merge them if they overlap and uses the one that best elevates e as the most possible cause.

These causal events can also be revisited and adjusted in step 138 during the analytical process using the conditional distribution view and/or the estimation algorithm.

The system tests the statistical significance of the causal relations using a preset time window and/or also can examine the strengths of the causal influences recursively over time in step 139. The process ends at step 140.

### EXPERIMENTAL EVALUATIONS

The effectiveness of the Global Mapping (GM) as described hereinabove with respect to analysis of heterogeneous data, with and without UB, via three runs of experiments were conducted, comparing them to the strategy of equal-width binning of all numeric data. In the evaluation, the system used 100 randomly generated (Directed Acyclic Graphs) DAGs in each run as ground truth. In the embodiment, a DAG has 10 nodes in the first run and 15 nodes in the second and third runs. A node in a DAG has a 0.2 probability to connect to any other nodes. Coefficients of graph edges are uniformly distributed within the range [0.1, 1], based on which 10,000 data points are sampled for each DAG in the first two runs and 25,000 in the third run. Some randomly selected variables were then converted into categorical ones in each run with equal-width binning. The three aforementioned strategies applied with the PC-stable algorithm were tested under each setting, in seeking to reconstruct simulated DAGs from the sampled mixed-type data. All experiments were performed with the R package pcalg [M. Kalisch, M. Machler, D. Colombo, M. H. Maathuis, and P. Buhlmann, “Causal Inference Using Graphical Models with the R Package pcalg,” J. Stat. Softw., vol. 47, no. 11, p. 26, 2012].

The charts in each row of FIG. 5 show the results of each run. In particular, FIG. 5 provides an overview of experimental evaluation of the impact of GM with/without UB in the causal inference of heterogeneous data, comparing to the strategy of simply binning. Charts in each row are from experiments running on the same simulated dataset. Charts in each column visualize the same metric. FIGS. 5A, 5E, and 5I are the SHDs of rebuilt causal networks by binning numeric variables with different levels. FIGS. 5B, 5F and 5J are the SHDs from GM and GM+UB with different numbers of categorical variables included in the dataset. FIGS. 5C, 5G and 5K show the average TPR. FIGS. 5D, 5H and 5L show the average TDR of the reconstructed networks with the three strategies under different numbers of categorical variables.

The charts in the left most column (FIGS. 5A, 5E and 5I) visualize the Structure Hamming Distance (SHD) error of the causal models inferred with binning all variables into 2 to 7 levels, respectively. The SHD is defined as the minimum number of edge insertions, deletions, directions, and reversions needed to transform the estimated graph into the ground truth. In SHD, the deletion or the direction of an undirected edge is each counted as one error, while it counts as two errors if a directed edge needs to be reversed. In each of the three charts, it is observed that the SHD increases both when there are too few levels (equivalent to a loss of value scale) as well as when there are too many (ignorance of bin order). It is also observed that the error increases when reconstructing a larger network (comparing FIGS. 5A and 5E), but it drops when more data is available (FIGS. 5E and 5I).

The charts in the second column (FIGS. 5B, 5F, and 5J) demonstrate the SHD from GM (red boxes) and GM+UB (blue boxes) under the situation that at most 50% of variables are categorical. While the error increases when more categorical variables are introduced, both of the two strategies outperform the best case from binning in all three runs (compare FIGS. 5A, 5E and 5I). A deeper inspection is offered when looking at charts in the right two columns of FIGS. 5C, 5D, 5G, 5H, 5K and 5L, which shows the average True Positive Rate (TPR, the number of correct edges out of ground truth edges) and True Discovery Rate (TDR, the number of correct edges out of all found edges) of the results. Edge directions are omitted here. It can be deduced from FIGS. 5C, 5G and 5K, that GM+UB (blue line) generally shows a better TPR than GM (green line), which means more correct relations are discovered. However, FIGS. 5D, 5H, and 5L, reveal that the TDR from GM+UB drops much faster than the pure GM when there are more than 4 categorical variables in the first two runs and 5 in the third run, which means many error relations are falsely linked too. Also, both GM strategies tend to introduce more spurious relations than binning with more categorical variables in the dataset. It can be deduced that when the ratio of categorical variables is too large, the global re-ordering and re-spacing can no longer preserve the fidelity of the data.

Taking all of the experiment results into consideration, the GM strategy is preferred whenever no more than 30% of the variables in a dataset are categorical, while UB can further boost the inference accuracy. When there are more categorical variables, binning numeric variables could be a more plausible choice. Finally, the strategy is generally applied when learning the structure of causal networks. Conversely, in the subsequent parameterization, the original levels of the categorical variables are used as they can be well handled by logistic regressions. The disclosed system and method GUI allows users to choose from any of the three methods when working with heterogeneous datasets.

Case Studies:

the use of the novel system interface by analyzing two real-world datasets using various above-described techniques.

The First Case Study—Presidential Election Dataset:

Donald Trump's unexpected triumph in the 2016 US Presidential Election has gathered worldwide attention and sparked extensive discussion. Since most polls and political analyses before the election failed to predict the win, there has been strong interest in finding the causes of what led to it. In an attempt to gain insight into this question, in accordance with an embodiment, the disclosed visual analytics framework was used to conduct a causality analysis on the Presidential Election dataset. The dataset contains variables of the county-level election results and of each county's selected geographical features, i.e. population, vote rate, race ratios, income level, the level of education, etc., which are extracted from a more inclusive Kaggle data archive.

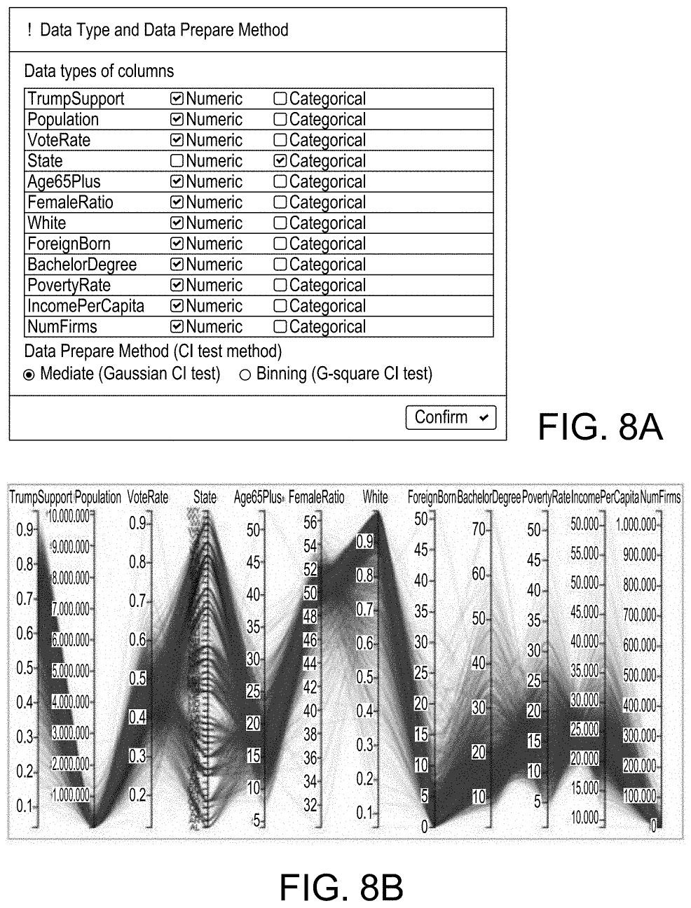

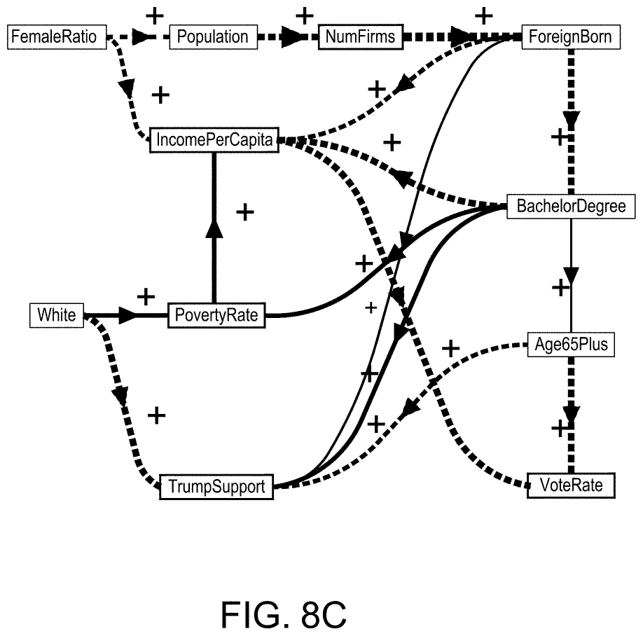

In order to analyze the dataset, the data was first loaded into the visual analytics system. Next, variable types (categorical or numeric) were selected as well as data preparation method (GM with UB or equal-width binning) via the pop-up window shown for example, in FIG. 8A. Then the data is visualized in the parallel coordinates as shown in FIG. 8B. Here, data points corresponding to counties of the 11 swing states (according to the website Politico) are brushed, as the election results in these areas are more decisive and Trump won in most of them. Next, by clicking “Go Causality!” the causal network of FIG. 8C is returned. It is observed that many interesting causal relations in FIG. 8C. For example, Age65Plus and White (population percentage of those aged 65 or plus and those identified as White) are positively causing TrumpSupport, which is the supporting rate of candidate Trump in the county. This means that older people and whites are mostly supportive for Trump. In addition, both of these two variables are positively causing VoteRate via different causal paths, implying Trump supporters are voting actively. On the other hand, those who were not preferring Trump are the immigrants and people with high education level, referring to the negative relation from ForeignBorn and BachelorDegree to TrumpSupport. However, the negative causal path ForeignBorn→BachelorDegree→Age65Plus→VoteRate indicates that more immigrants and more people with Bachelor degrees may indirectly hurt the voting rate. Besides, when looking at the parallel coordinates, values on the axes of ForeignBorn and BachelorDegree are generally much smaller than values on axes of Age65Plus and White, suggesting the latter two are much larger groups.

There are many more causal patterns that can be observed that may entail various social facts that are not fully listed herein. While the presented analytics provides a proposed explanation for the major reasons behind Trump's victory, the causality analysis can also be applied to other political datasets, e.g. poll data, in a similar manner, which can potentially improve prediction accuracy.

The ACT Dataset:

In another example case study implementation of the disclosed system and method, the original ACT dataset was used to study why high school graduates change majors at college and has been modified so that its variables are more suited in a causality context. There are about 230,000 data points, wherein each represents a participated student. A student would report his/her college major three times in total—the expected one at the senior year of high school (T1) and the actual major at the first and second year of college (T2 and T3). Majors are categorized into 18 fields. A test was also conducted at each point in time quantifying the student's fitness for his choice (Fit_T1/T2/T3). Other factors considered include a student's gender, ACT score, attended college type (2 or 4 years), and transfer between colleges.

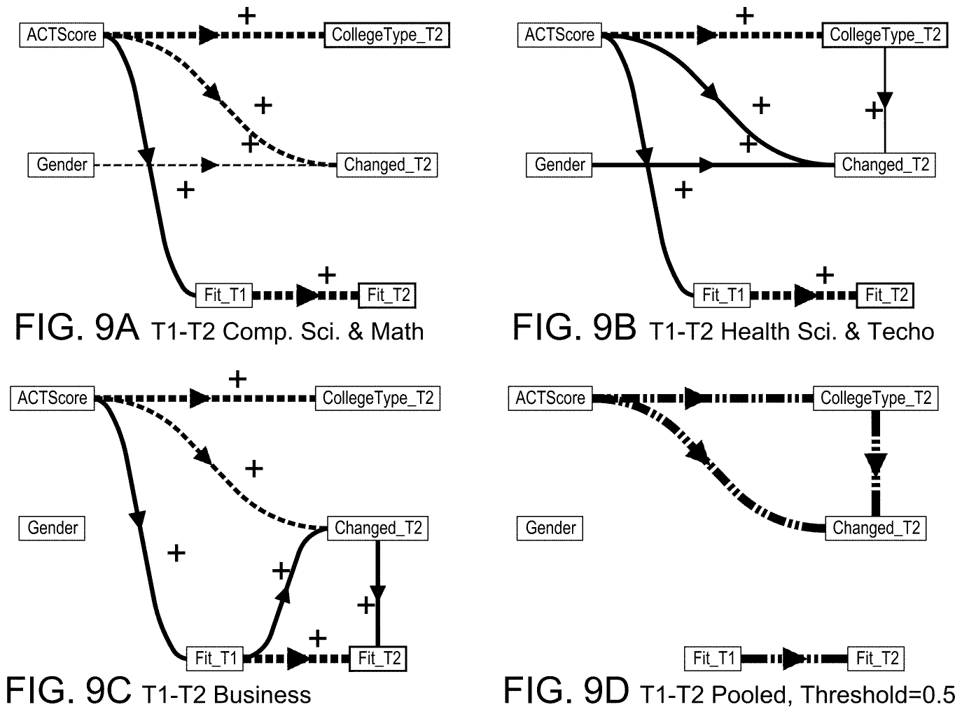

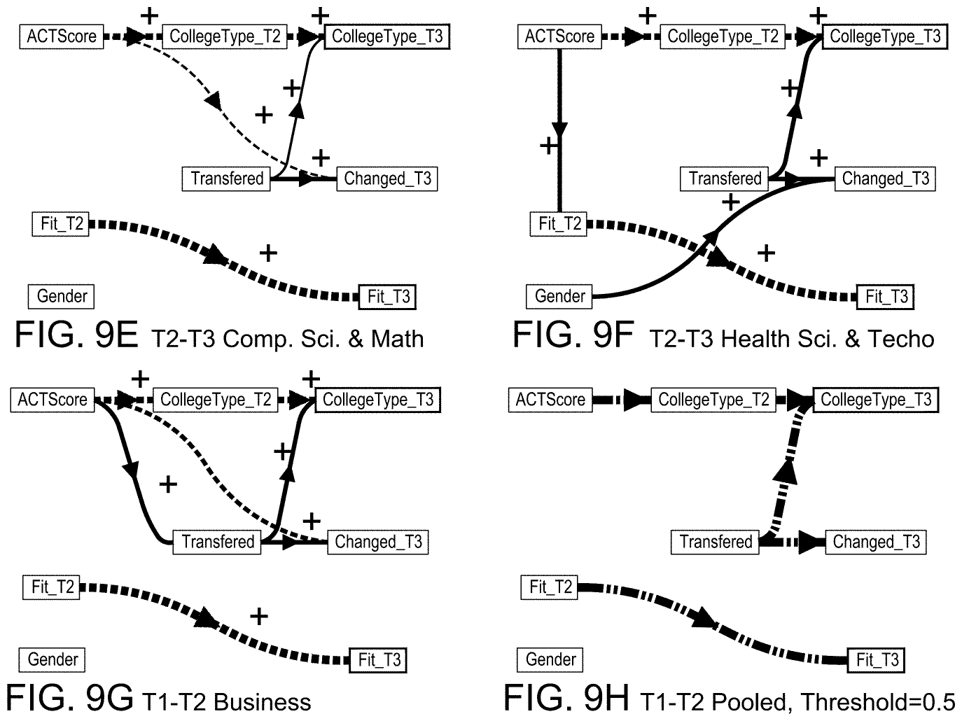

Since there are general two time frames at which a student may change majors (T1 to T2 and T2 to T3), the variables were arranged into two different but overlapping groups, each corresponds to a sub-dataset. Next, the first sub-dataset is further subdivided based on students' major at T1 and the second based on major at T2, so that students selecting different fields are studied separately, avoiding possible disturbances by Simpson's Paradox. Conditioning on these subdivisions, 36 causal networks (18 majors×2 sub-datasets) are inferred and refined with the disclosed visual analytics framework. Some causal networks are visualized as shown in FIG. 9. The nodes were placed at the same location for each model from the same sub-dataset in order to facilitate comparison.

FIG. 9 provides an illustration of a visualization of causal models inferred from the ACT dataset, in accordance with an embodiment of the disclosed system and method. In particular, FIGS. 9A, 9B, and 9C illustrate representative causal networks explaining why students changed to other majors when entering college. FIG. 9D illustrates a causal model pooled from the first group of 18 models learned from data subdivisions. FIGS. 9E-9G illustrate causal networks explaining why students changed major in the first two years in college. FIG. 9D illustrates a causal model pooled from the second group of 18 models.

FIGS. 9A, 9B and 9C are the causal models learned correspondingly from students who claimed at T1 that they would take Computer Science and Math, Health Science, and Business in college. Here Changed_T2 indicates whether the student entered a different major in the first year of college. There are some interesting observations when comparing the three figures. For example, in FIG. 9A, there is indicated a gender bias indicated by the positive edge Gender→Changed_T2. As males are valued 1 in the binary variable Gender, this implies that they are more likely than females to major differently from what they expected earlier. Meanwhile, ACTScore is also playing as a positive motivation. However, the two relations become just the opposite in FIG. 9B, implying that a low ACT score would very likely make a girl, who initially wanted to take Health Science, attend another major. It also appears that students who wanted to enter Business schools are the only group among the three who considered their fitness to the major (referring to Fit_T1→Changed_T2 in FIG. 9C), even though they usually didn't get to change to a better fitting one (the negative edge Changed_T2→Fit_T2). As each data subdivision has a sufficient but different number of data points, the strategy of pooling by frequency is then applied. FIG. 9D shows the causal relations pooled from the 18 models with a frequency threshold of 0.5. It is observed that a student's decision for college major is generally affected by his ACT score and the type of college he/she had been admitted to, while the fitness score is seemingly irrelevant in most cases.

In order to determine the motivation behind the major switch of a college student actually taking the above three majors at T2, the second data-subset variables are analyzed. FIGS. 9E, 9F, and 9G are the corresponding causal networks. FIG. 9H is the pooled model with the frequency threshold of 0.5. From these visualizations, it is observed that the transfer of college now becomes the most common reason for a student to change major, regarding the edge Transferred→Changed_T3 in the three models as well as in the pooled model, while gender bias can only be observed in very few fields, e.g. the edge Gender→Changed_T3 observed in FIG. 9F, but not in FIGS. 9E and 9G. Again, the fitness score is generally shown to be irrelevant.

Not all of the inferred models are listed herein, but examining them comparably can lead to many more interesting findings. Nevertheless, the case study on the ACT dataset has demonstrated that different models underlying data subdivisions can be effectively uncovered using the disclosed framework

Discussed in detail below are demonstrations of two usage scenarios featuring an embodiment of the disclosed system and method using two real-world datasets.

The first dataset used is an Air Quality dataset. This dataset has 8 attributes, each formatted as a time sequence of hourly measurements of the PM2.5 concentration in air and the weather conditions, both in the city of Shanghai, China. The PM2.5 are fine particles with a diameter of about 2.5 μm and they are one of the main air pollutants. The data were collected from two locations—the Shanghai US embassy (PMUSPost) and the Xuhui district (PMXuhui). The variables associated with weather conditions include Humidity, Pressure, Temperature, WindDirection, WindSpeed, and Precipitation. The dataset was retrieved from Kaggle and spans 5 years. Only the data of January 2015 (744 time points in total) was analyzed, since it was one of the worst months in 2015 for Shanghai at the time with respect to average air quality. Such dataset was selected to demonstrate an implementation of the disclosed system's use in analyzing more complex data.

DJIA 30 Dataset:

This second dataset reports daily stock prices of 30 Dow Jones Industrial Average (DJIA) companies from 2013 to 2017 (1203 opening days). For each stock, the highest share price of the day is reported. The data was fetched from the Investors Exchange data service. This dataset was used to demonstrate an exemplary implementation of the disclosed system in the support of strategizing in financial analysis.

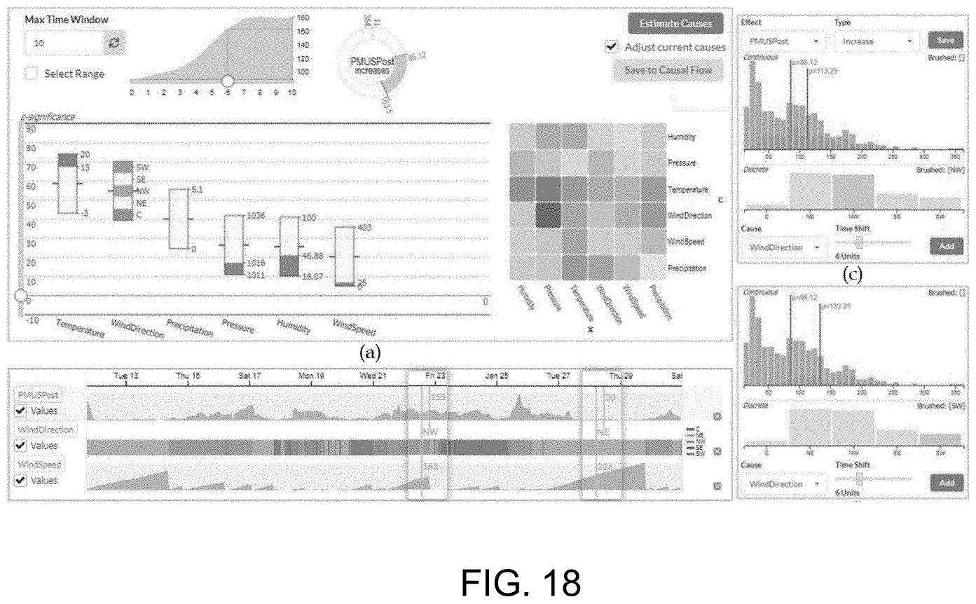

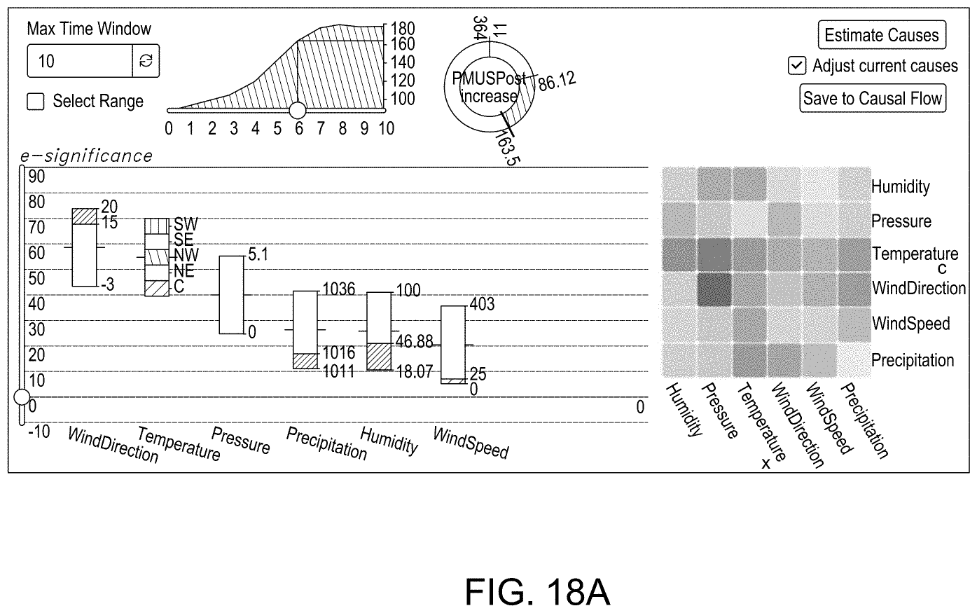

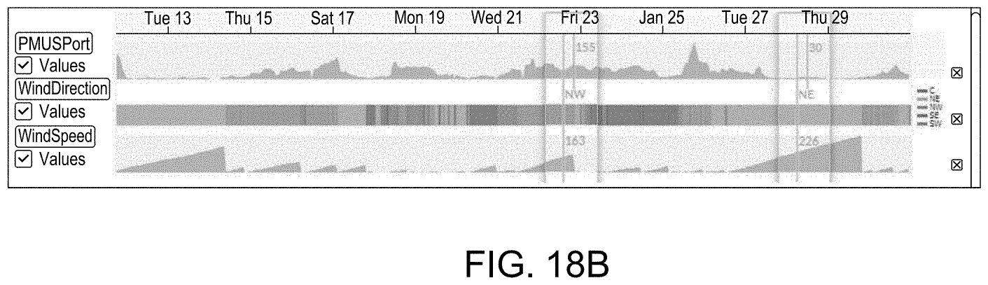

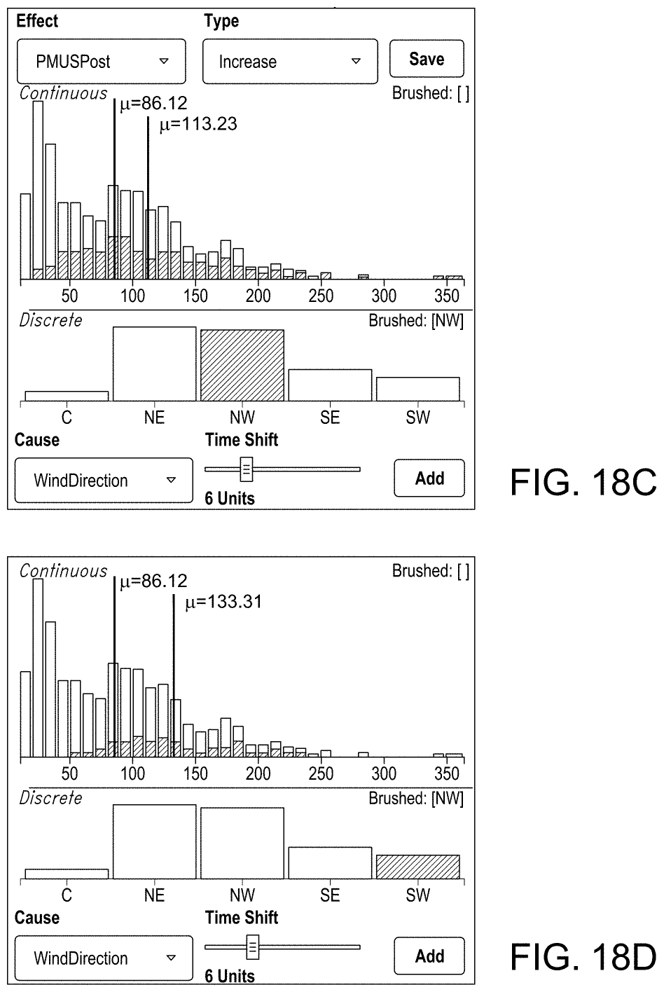

FIG. 18 illustrates an exemplary visual analytics interface for analyzing the Air Quality dataset. In FIG. 18A, the interface consists showing in graphical formats, the causes increasing the PMUSPost estimated automatically with a time delay set to 6 hours, in accordance with an embodiment of the disclosed system and method. In FIG. 18B, illustrated is an analytics representation associated with the time sequence view reveals that, while wind from the northeast reduces air pollution, wind from the northwest does not. FIG. 18C provides an illustration of the influence of northwest wind. FIG. 18D provides an illustration of the influence of the southwest wind. Each of FIGS. 18A-18D provide respective illustrations each in accordance with an embodiment of the disclosed system and method. Further analysis comparing the influence of northwest wind in FIG. 18C and southwest wind on PMUSPost in FIG. 18D, implies that the latter is the larger pollution source.

Hence, the Temporal Causality Analysis Using Air Quality Dataset Commences as Follows:

A public policy consultant, for example, named John, for purposes of illustration, would like to research the reason behind Shanghai's air pollution using the disclosed system. As the first step, John loads the Air Quality dataset and sets PMUSPost as an Increase type effect in order to learn what is increasing the PM2.5 in the air. John soon recognizes that exploring the potential causes one by one is rather tedious. Next, John queries the disclosed system to obtain a first estimate. John knows that since pollutants usually build up over time and accounting for this delay, an initial time delay of 6 hours is set up using the slider under the area chart in the causal inference panel. Then John selects the Estimate Causes button. John removes PMXuhui as a cause since it is not a natural weather condition. The result is shown in FIG. 18A. There are no initial big surprises for John—high Temperature (above 15 degrees Celsius), low WindSpeed (under 25 km/h) from the northwest or southwest direction (see WindDirection), no Precipitation, low Pressure (under 1016 pascal), dry air (Humidity below 46%), all contributed to the build-up of PM2.5 pollution. If all causes are satisfied, after 6 hours, the expected PM2.5 concentration would be almost twice the month average (as shown in the donut shape shown in FIG. 18A). The build-up process lasts about 7 to 8 hours before reaching the peak, according to the area chart.

Among all causes, one interesting observation John makes is that WindDirection is a much more significant cause than the low WindSpeed. This implies that the external input by wind is a very important factor responsible for Shanghai's air pollution. This can be further researched by looking at the time sequence view. FIG. 18B is a composition of two screen shots with two mouse locations. The two highlighted indicators, as well as some other places along the sequence, show that while a strong wind coming from northeast (colored orange in the time line of WindDirection) is reducing the PM2.5 concentration, the northwest wind (colored green) is not doing so. This makes perfect sense as next to Shanghai in the east is the Pacific Ocean while in the west is inland China. The wind coming from the sea brings clean, moist (improving Humidity) air, which reduces PM2.5 both directly and indirectly via chain relations.

More insights are gained when John clicks the label WindDirection in FIG. 18B to visit the time delayed conditional distribution. FIGS. 18C and 18D are two conditional distributions when only northwest wind or southwest wind is conditioned on. Comparing the two distributions, it appears that the southwest wind, although occurring less frequently, had been bringing more pollutant, implying the major pollution source.

At this point, John can make some policy suggestions based on his findings, which are not further discussed hereinbelow. Meanwhile, John further explores the dataset by analyzing the chaining effect between factors. For example, John might look into the causes of low Pressure, such as WindDirection and Temperature, or the time delay between the pollution in PMUSPost and PMXuhui (southwest to the US embassy) caused by wind direction. FIG. 12 described hereinabove, illustrates an overview of a visual analytics interface analyzing the Air Quality dataset. In particular, FIG. 12 shows a screen shot of a visual analytics representation after exploring all these relations and adding them to the causal flow chart, where John can gain an overview of the discovered temporal dependencies and revisit saved results by loading the nodes.

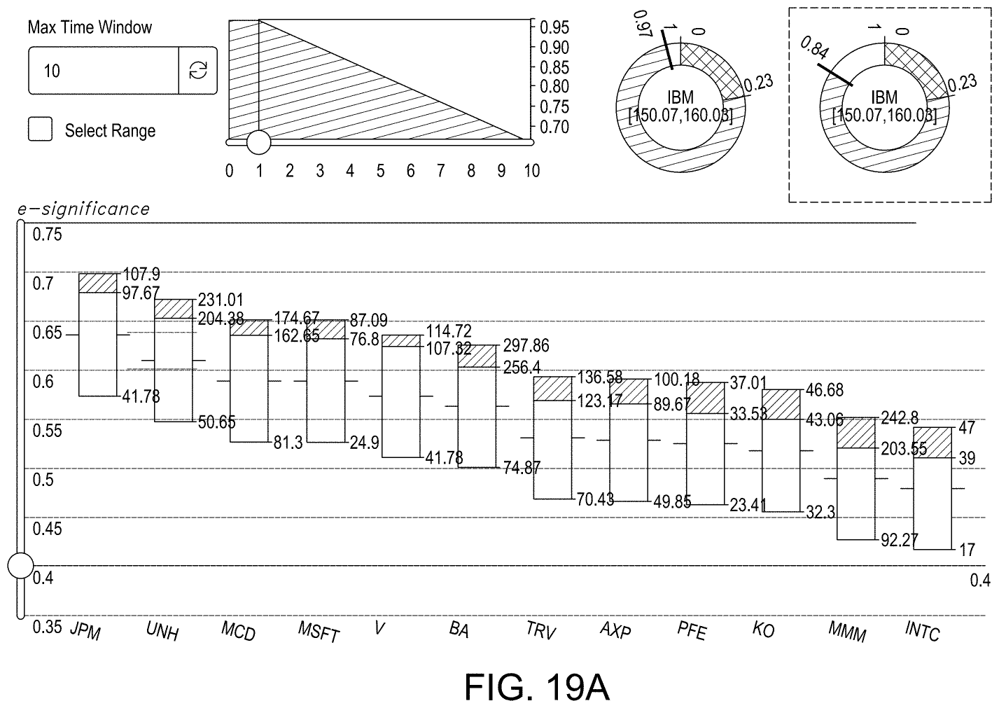

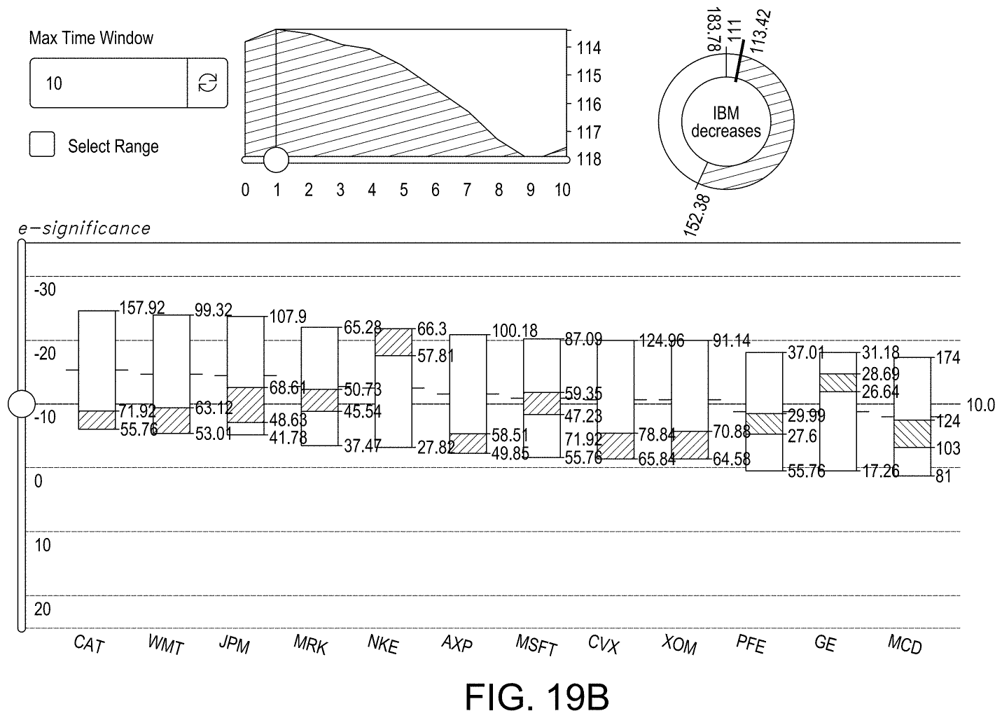

FIG. 19 illustrates analyzing the DJIA 30 dataset. FIG. 19A provides predictors of the share price of IBM falling into $150 to $160 with 1 day lagging. More boxes will show if the analyst drags the chart. With only the top five causes, the conditional probability drops from 97% to 84%. FIG. 19B shows factors related to the decreasing of IBM's share price.

SJIA 30 Dataset:

A financial consultant, name Jane, for purposes of illustration, is serving a customer who wants to transact some shares of IBM stocks. With the five years data of DJIA stock daily prices, Jane hopes to find out if there is any dependency between the share price of IBM and that of other stocks. Knowing such relations can be of great interest as it can help the investor 1) predict the development of prices of some specific stocks so that actions can be taken in advance, and more importantly, 2) reduce the risk by apportioning investments in stocks that are not highly dependent.

More particularly, FIG. 19 illustrates an exemplary visual analytics interface for analyzing the DJIA 30 dataset. In FIG. 19A, the interface consists of various graphical formats, providing predictors of the share price of IBM falling into $150 to $160 with 1 day lagging. FIG. 19B illustrates factors related to the decreasing of IBM's share price. Each of FIGS. 19A-19B provide respective illustrations of a visual analytics interface, each in accordance with an embodiment of the disclosed system and method.

Jane first wants to find out if there is any predictor for the share price of IBM falling into the range of 150 to 160 dollars, which is the target price range for the customer. A time window of 1 day is used, as it is often believed that there is a sharp drop in influence after that time window. By loading in the data, setting a ValueIn type effect event on IBM (which is the ticker symbol for IBM) with a value constraint of 150 to 160 in the conditional distribution view, clicking the auto-estimation button, and setting a ε-significance of 0.4, the causal inference panel of FIG. 19A is displayed. The visualizations are straightforward to understand—when all cause events occurred, i.e. the share prices of these stocks fell into the specified ranges, then there was a 97% chance the effect would occur. However, in certain aspects or embodiment, actually using this result to guide future actions could be impractical, since it requires all the predictor stocks to fall into their desired range. Hence, in order to achieve a looser condition, Jane can slide the ε threshold to a larger value. For example, with only the five most significant predictors in the display—JPM (JPMorgan Chase), UNH (UnitedHealth), MSFT (Microsoft), MCD (McDonald's) and V (Visa), however, the conditional probability will drop to 84% (the donut in the dashed area in FIG. 19A).

While it is Jane and the respective customer's call to make the final judgments and take the risk, FIG. 19A also reveals that prices of a stock could be influenced by others. In order to further investigate this, another example is given in FIG. 19B where predictors were looked for that lead to the share price of IBM falling lower than its average. Based on the visualization, it was determined that the low price of some stocks e.g., CAT (Caterpillar) fell under $71.92 per share, WMT (Wal-Mart) under $63.12 per share, AXP (American Express) under $58.51 per share, etc., all predicting a low share price of IBM. Thus, it may be a good strategy to not buy them together with IBM to lower the financial risk.

Each of the stocks in the dataset were not examined herein, but doing so would likely lead to many more interesting findings. Nevertheless, the case studies presented in this section show that the disclosed system and method is well suited for the temporal causality analysis of data in drastically different domains.

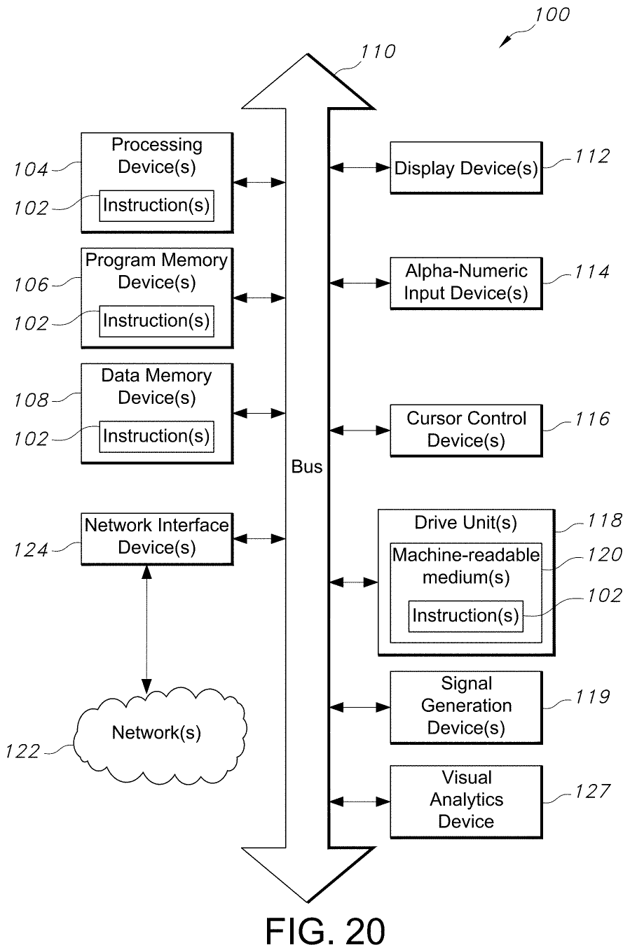

FIG. 20 is a block diagram of an embodiment of a machine in the form of a computing system 100, within which a set of instructions 102 is stored, that when executed, causes the machine to perform any one or more of the methodologies disclosed herein. In certain embodiments, the machine operates as a standalone device. In certain embodiments, the machine may be connected (e.g., using a network) to other machines. In a networked implementation, the machine may operate in the capacity of a server or a client user machine in a server-client user network environment. In alternative embodiments, the machine operates as a standalone device and/or may be connected (e.g., networked) to other machines. In a networked deployment, the machine may operate in the capacity of either a server or a client machine in server-client network environments, or it may act as a peer machine in peer-to-peer (or distributed) network environments. The machine may comprise a server computer, a client user computer, a personal computer (PC), a tablet PC, a personal digital assistant (PDA), a cellular telephone, a mobile device, a palmtop computer, a laptop computer, a desktop computer, a communication device, a personal trusted device, a web appliance, a network router, a switch or bridge, or any machine capable of executing a set of instructions (sequential or otherwise) that specify actions to be taken by that machine. The machine may be an onboard vehicle system, wearable device, a hybrid tablet, a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

The computing system 100 may include a processing device(s) 104 (such as a central processing unit (CPU), a graphics processing unit (GPU), or both), processor cores, compute node, an engine, etc., program memory device(s) 106, and data memory device(s) 108, including a main memory and/or a static memory, which communicate with each other via a bus 110. The computing system 100 may further include display device(s) 112 (e.g., liquid crystals display (LCD), a flat panel, a solid state display, or a cathode ray tube (CRT)). The computing system 100 may further include an alphanumeric input device 114, a user interface (UI) navigation device (e.g. mouse). In certain embodiments, a video display unit, input device and UI navigation device (and/or other control devices) may be incorporated into a touch screen display. The computing system 100 may include input device(s) 114 (e.g., a keyboard), cursor control device(s) 116 (e.g., a mouse), disk drive unit(s) 118, signal generation device(s) 119 (e.g., a speaker or remote control), and network interface device(s) 124.

The computer system 100 may additionally include a storage device 118 (e.g., a drive unit), a signal generation device 119 (e.g., a speaker), a visual analytics device 127 (e.g. analytics processor, module, engine, application, microcontroller and/or microprocessor), a network interface device 124, and one or more sensors (not shown), such as a global positioning system (GPS) sensor, compass, accelerometer, or other sensor (e.g. touch or haptic-based sensor).

The disk drive unit(s) 118 may include machine-readable medium(s) 120, on which is stored one or more sets of instructions 102 (e.g., software) embodying any one or more of the methodologies or functions disclosed herein, including those methods illustrated herein. The instructions 102 may also reside, completely or at least partially, within the program memory device(s) 106, the data memory device(s) 108, main memory, static memory and/or within the processor, microprocessor, and/or processing device(s) 104 during execution thereof by the computing system 100. The program memory device(s) 106, main memory, static memory and/or the processing device(s) 104 may also constitute machine-readable media. Dedicated hardware implementations, not limited to application specific integrated circuits, programmable logic arrays, and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present embodiment contemplates a machine-readable medium or computer-readable medium 120 containing instructions 102, or that which receives and executes instructions 102 from a propagated signal so that a device connected to a network environment 122 can send or receive voice, video or data, and to communicate over the network 122 using the instructions 102. The instructions 102 may further be transmitted or received over a network 122 via the network interface device(s) 124. The machine-readable medium may also contain a data structure for storing data useful in providing a functional relationship between the data and a machine or computer in an illustrative embodiment of the disclosed systems and methods.

While the machine-readable medium 120 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the present embodiment or that is capable of storing, encoding or carrying data structures utilized by or associated with such instructions.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and/or a digital file attachment to e-mail or other self-contained information archive or set of archives is considered a distribution medium equivalent to a tangible storage medium. Accordingly, the embodiment is considered to include any one or more of a tangible machine-readable medium or a tangible distribution medium, as listed herein and including art-recognized equivalents and successor media, in which the software implementations herein are stored. The term “machine-readable medium” shall accordingly be taken to include, but not be limited to, solid-state memories, and optical and magnetic media.

Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 102 may further be transmitted or received over a communications network 122 using a transmission medium via the network interface device 124 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G. and 4G LTE/LTE-A or WiMAX networks). Other communications mediums include, IEEE 802.11 (including any IEEE 802.11 revisions), Cellular technology (such as GSM, CDMA, UMTS, EV-DO, WiMAX, or LTE), and/or Zigbee, Wi-Fi, Bluetooth or Ethernet, among other possibilities. The term “transmission medium” shall be taken to include any intangible medium that is capable of storing, encoding, or carrying instructions for execution by the machine, and includes digital or analog communications signals or other intangible medium to facilitate communication of such software.

Although the present specification describes components and functions implemented in the embodiments with reference to particular standards and protocols, the disclosed embodiment are not limited to such standards and protocols.

The above-described methods for the disclosed visual analytics system and method may be implemented on a computer, using well-known computer processors, memory units, storage devices, computer software, and other components.

In order to provide additional context for various aspects of the subject invention, FIG. 20 and the following discussion are intended to provide a brief, general description of a suitable computing environment 100 in which the various aspects of the invention can be implemented. While the disclosure has been described above in the general context of computer-executable instructions that may run on one or more computers, those skilled in the art will recognize that the invention also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices. The illustrated aspects of the invention may also be practiced in distributed computing environments where certain tasks are performed by remote processing devices that are linked through a communications network. In a distributed computing environment, program modules can be located in both local and remote memory storage devices. A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer. Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

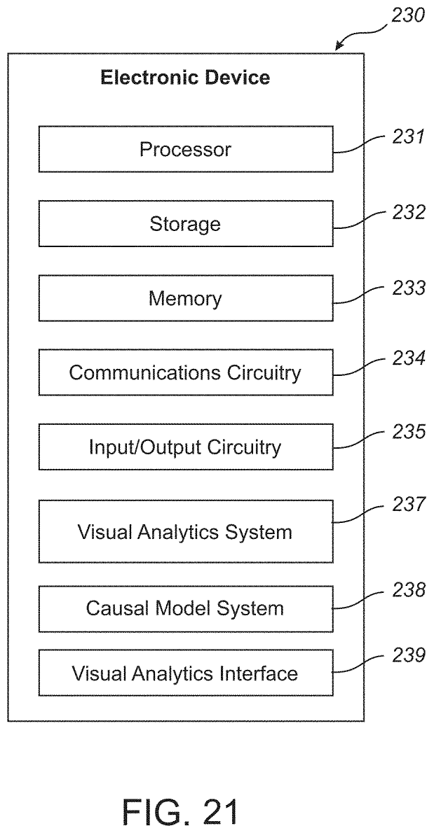

FIG. 21 is a schematic view of an illustrative electronic device for use with an visual analytics system in accordance with one embodiment of the technical disclosure. Electronic device 230 may include processor 231, storage 232, memory 233, communications circuitry 234, input/output circuitry 235, visual analytics system 237 (comprising one or more of processor, application, engine and/or module), causal model system 238 (comprising one or more of processor, application, engine and/or module) and visual analytics interface 239 (comprising one or more of display unit, application, engine, and/or module) and power supply. In some embodiments, one or more of electronic device components 230 may be combined or omitted (e.g., combine storage 232 and memory 233). In some embodiments, electronic device 230 may include other components not combined or included in those shown in FIG. 21 (e.g., a display, bus, or input mechanism), or several instances of the components shown in FIG. 21. For the sake of simplicity, only one of each of the components is shown in FIG. 21.

Processor 231 may include any processing circuitry operative to control the operations and performance of electronic device 230. For example, processor 231 may be used to run operating system applications, firmware applications, media playback applications, media editing applications, or any other application. In some embodiments, a processor may drive a display and process inputs received from a user interface.

Storage 232 may include, for example, one or more storage mediums including a hard-drive, solid state drive, flash memory, permanent memory such as ROM, any other suitable type of storage component, or any combination thereof. Storage 232 may store, for example, media data (e.g., music and video files), application data (e.g., for implementing functions on device 430), firmware, user preference information data (e.g., media playback preferences), authentication information (e.g. libraries of data associated with authorized users), lifestyle information data (e.g., food preferences), transaction information data (e.g., information such as credit card information), wireless connection information data (e.g., information that may enable electronic device 230 to establish a wireless connection), subscription information data (e.g., information that keeps track of podcasts or television shows or other media a user subscribes to), contact information data (e.g., telephone numbers and email addresses), calendar information data, and any other suitable data or any combination thereof.

Memory 233 can include cache memory, semi-permanent memory such as RAM, and/or one or more different types of memory used for temporarily storing data. In some embodiments, memory 233 can also be used for storing data used to operate electronic device applications, or any other type of data that may be stored in storage 232. In some embodiments, memory 233 and storage 232 may be combined as a single storage medium.

Communications circuitry 234 can permit device 230 to communicate with one or more servers or other devices using any suitable communications protocol. Electronic device 230 may include one more instances of communications circuitry 234 for simultaneously performing several communications operations using different communications networks, although only one is shown in FIG. 21 to avoid overcomplicating the drawing. For example, communications circuitry 234 may support Wi-Fi (e.g., an 802.11 protocol), Ethernet, Bluetooth® (which is a trademark owned by Bluetooth Sig, Inc.), radio frequency systems, cellular networks (e.g., GSM, AMPS, GPRS, CDMA, EV-DO, EDGE, 3GSM, DECT, IS-136/TDMA, iDen, LTE or any other suitable cellular network or protocol), infrared, TCP/IP (e.g., any of the protocols used in each of the TCP/IP layers), HTTP, BitTorrent, FTP, RTP, RTSP, SSH, Voice over IP (VOIP), any other communications protocol, or any combination thereof.

Input/output circuitry 235 may be operative to convert (and encode/decode, if necessary) analog signals and other signals into digital data. In some embodiments, input/output circuitry can also convert digital data into any other type of signal, and vice-versa. For example, input/output circuitry 235 may receive and convert physical contact inputs (e.g., from a multi-touch screen), physical movements (e.g., from a mouse or sensor), analog audio signals (e.g., from a microphone), or any other input. The digital data can be provided to and received from processor 231, storage 232, memory 233, or any other component of electronic device 230. Although input/output circuitry 235 is illustrated in FIG. 21 as a single component of electronic device 230, several instances of input/output circuitry can be included in electronic device 230.

Electronic device 230 may include any suitable mechanism or component for allowing a user to provide inputs to input/output circuitry 235. For example, electronic device 230 may include any suitable input mechanism, such as for example, a button, keypad, dial, a click wheel, or a touch screen. In some embodiments, electronic device 230 may include a capacitive sensing mechanism, or a multi-touch capacitive sensing mechanism.

In some embodiments, electronic device 230 can include specialized output circuitry associated with output devices such as, for example, one or more audio outputs. The audio output may include one or more speakers (e.g., mono or stereo speakers) built into electronic device 230, or an audio component that is remotely coupled to electronic device 230 (e.g., a headset, headphones or earbuds that may be coupled to communications device with a wire or wirelessly).

In some embodiments, I/O circuitry 235 may include display circuitry (e.g., a screen or projection system) for providing a display visible to the user. For example, the display circuitry may include a screen (e.g., an LCD screen) that is incorporated in electronics device 230. As another example, the display circuitry may include a movable display or a projecting system for providing a display of content on a surface remote from electronic device 230 (e.g., a video projector). In some embodiments, the display circuitry can include a coder/decoder (Codec) to convert digital media data into analog signals. For example, the display circuitry (or other appropriate circuitry within electronic device 230) may include video Codecs, audio Codecs, or any other suitable type of Codec.

The display circuitry also can include display driver circuitry, circuitry for driving display drivers, or both. The display circuitry may be operative to display content (e.g., media playback information, application screens for applications implemented on the electronic device, information regarding ongoing communications operations, information regarding incoming communications requests, or device operation screens) under the direction of processor 231.

Visual analytics system or engine 237, causal model system or engine 238 and/or visual analytics interface 239 (which may be integrated as one discrete component, or alternatively as shown, as discrete segregated components of the electric device 230) may include any suitable system or sensor operative to receive or detect an input identifying the user of device 230.

In some embodiments, electronic device 230 may include a bus operative to provide a data transfer path for transferring data to, from, or between control processor 231, storage 232, memory 233, communications circuitry 234, input/output circuitry 235 visual analytics system 237, causal model system 238, visual analytics interface 239 and any other component included in the electronic device 230.

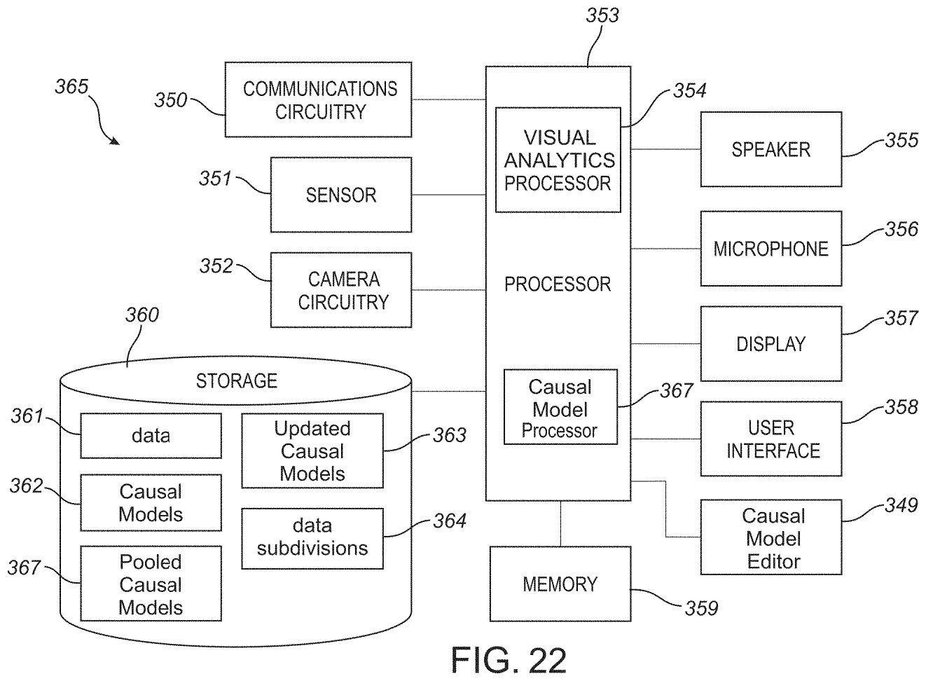

FIG. 22 illustrates a system block diagram including constituent components of an example mobile device, in accordance with an embodiment of the acoustic-based echo-signature system, including an example computing system.

The device 365 in FIG. 22 includes a main processor 353 that interacts with a motion sensor 351, camera circuitry 352, storage 360, memory 359, display 357, and user interface 358. The device 365 may also interact with communications circuitry 350, a speaker 355, and a microphone 356. The various components of the device 365 may be digitally interconnected and used or managed by a software stack being executed by the main processor 353. Many of the components shown or described here may be implemented as one or more dedicated hardware units and/or a programmed processor (software being executed by a processor, e.g., the main processor 353).

The main processor 353 controls the overall operation of the device 365 by performing some or all of the operations of one or more applications implemented on the device 365, by executing instructions for it (software code and data) that may be found in the storage 360. The processor may, for example, drive the display 357 and receive user inputs through the user interface 358 (which may be integrated with the display 357 as part of a single, touch sensitive display panel, e.g., display panel on the front face of a mobile device). The main processor 353 may also control the generating of updated causal models 363, generating data subdivisions 364, forming pooled causal models 367, and/or generating causal models 362.

Storage 360 provides a relatively large amount of “permanent” data storage, using nonvolatile solid state memory (e.g., flash storage) and/or a kinetic nonvolatile storage device (e.g., rotating magnetic disk drive). Storage 360 may include both local storage and storage space on a remote server. Storage 360 may store data 361, such as data sets for respective implementation by an embodiment of the visual analytics system and data generated by implementation of the disclosed visual analytics system and method, and stored as causal models 362, the formation of pooled causal models 367, the updated causal models 363, and/or respective data subdivisions 364 that are generated by respective implementation of the disclosed system and method, and respective software components that control and manage, at a higher level, the different functions of the device 365. For instance, there may be a visual analytics application and/or editor to accomplish the updating of stored causal models 363.

In addition to storage 360, there may be memory 359, also referred to as main memory or program memory, which provides immediate or relatively quick access to stored code and data that is being executed by the main processor 353 and/or visual analytics processor or engine 354 and/or causal model processor or engine 367. Memory 359 may include solid state random access memory (RAM), e.g., static RAM or dynamic RAM. There may be one or more processors, e.g., main processor 353, causal model processor 367 and/or visual analytics processor 354, that run or execute various software programs, modules, or sets of instructions (e.g., applications) that, while stored permanently in the storage 360, have been transferred to the memory 359 for execution, to perform the various functions described above. It should be noted that these modules or instructions need not be implemented as separate programs, but rather may be combined or otherwise rearranged in various combinations. In addition, the enablement of certain functions could be distributed amongst two or more modules, and perhaps in combination with certain hardware.

The device 365 may include communications circuitry 350. Communications circuitry 350 may include components used for wired or wireless communications, such as two-way conversations and data transfers. For example, communications circuitry 350 may include RF communications circuitry that is coupled to an antenna, so that the user of the device 365 can place or receive a call through a wireless communications network. The RF communications circuitry may include a RF transceiver and a cellular baseband processor to enable the call through a cellular network. In another embodiment, communications circuitry 350 may include Wi-Fi communications circuitry so that the user of the device 365 may place or initiate a call using voice over Internet Protocol (VOIP) connection, through a wireless local area network.

The device 365 may include a motion sensor 351, also referred to as an inertial sensor, that may be used to detect movement of the device 365. The motion sensor 351 may include a position, orientation, or movement (POM) sensor, such as an accelerometer, a gyroscope, a light sensor, an infrared (IR) sensor, a proximity sensor, a capacitive proximity sensor, an acoustic sensor, a sonic or sonar sensor, a radar sensor, an image sensor, a video sensor, a global positioning (GPS) detector, an RP detector, an RF or acoustic doppler detector, a compass, a magnetometer, or other like sensor.

The device 365 also includes camera circuitry 352 that implements the digital camera functionality of the device 365. One or more solid-state image sensors are built into the device 365, and each may be located at a focal plane of an optical system that includes a respective lens. An optical image of a scene within the camera's field of view is formed on the image sensor, and the sensor responds by capturing the scene in the form of a digital image or picture consisting of pixels that may then be stored in storage 360. The camera circuitry 352 may be used to capture images or retrieve stored images or other datasets that are analyzed by the processor 353 and/or visual analytics processor 354 in accomplishing certain one or more functionalities associated with the disclosed visual analytics system and method, using the device 365. In addition, causal model editor 349 may be connected to the one or more processors 353 in performing editing and/or refinement to the generated causal model by for example, adding, deleting and/or redirecting any causal edges in the causal model and/or otherwise, refining the causal model (for example, including adding score glyphs and updating network score bars).

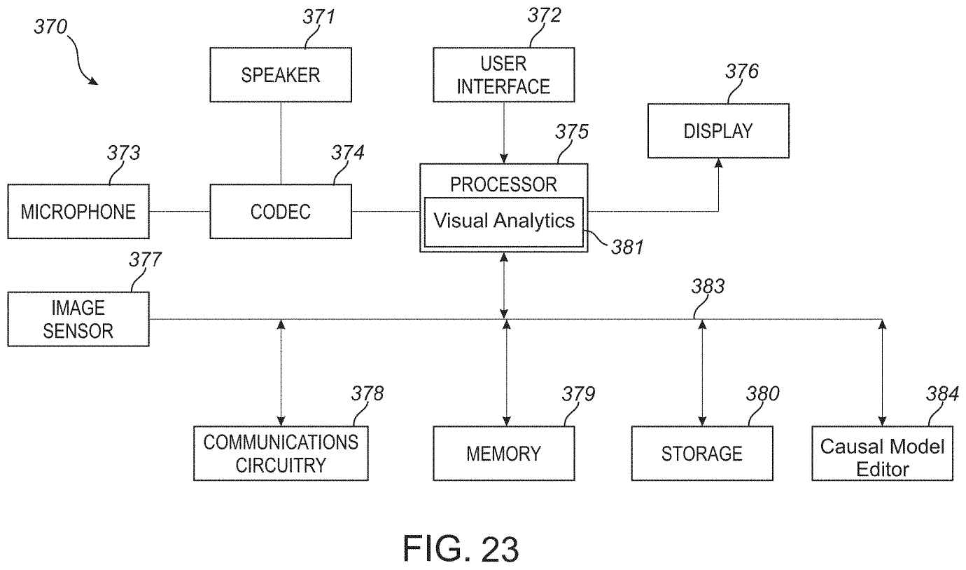

FIG. 23 illustrates a system block diagram including constituent components of an example mobile device, in accordance with an embodiment of the disclosed visual analytics system and method, including an example computing system.

More particularly, shown in FIG. 23 is a personal computing device 370 according to an illustrative embodiment of the invention. The block diagram provides a generalized block diagram of a computer system such as may be employed, without limitation, by the personal computing device 370. The personal computing device 370 may include a processor 375 and/or visual analytics processor 381 and/or an causal model editor 384 that may be integrated with processor 375 and/or as a segregated discrete component or module 381, storage device 380, user interface 372, display 376, CODEC 374, bus 383, memory 379, communications circuitry 378, a speaker or transducer 371, a microphone 373, and an image sensor 377. Processor 375 and/or visual analytics processor 381 may control the operation of many functions and other circuitry included in personal computing device 370. Processor 375, 381 may drive display 376 and may receive user inputs from the user interface 372.

Storage device 380 may store media (e.g., images, music and video files), software (e.g., for implanting functions on device 370), preference information (e.g., media playback preferences), lifestyle information (e.g., food preferences), personal information (e.g., information obtained by exercise monitoring equipment), transaction information (e.g., information such as credit card information), word processing information, personal productivity information, wireless connection information (e.g., information that may enable a media device to establish wireless communication with another device), subscription information (e.g., information that keeps track of podcasts or television shows or other media a user subscribes to), and any other suitable data. Storage device 380 may include one more storage mediums, including, for example, a hard-drive, permanent memory such as ROM, semi-permanent memory such as RAM, or cache.

Memory 379 may include one or more different types of memory, which may be used for performing device functions. For example, memory 379 may include cache, ROM, and/or RAM. Bus 383 may provide a data transfer path for transferring data to, from, or between at least storage device 380, memory 379, and processor 375, 381. Coder/decoder (CODEC) 374 may be included to convert digital audio signals into analog signals for driving the speaker 371 to produce sound including voice, music, and other like audio. The CODEC 374 may also convert audio inputs from the microphone 373 into digital audio signals. The CODEC 374 may include a video CODEC for processing digital and/or analog video signals.

User interface 372 may allow a user to interact with the personal computing device 370. For example, the user input device 372 can take a variety of forms, such as a button, keypad, dial, a click wheel, or a touch screen. Communications circuitry 378 may include circuitry for wireless communication (e.g., short-range and/or long-range communication). For example, the wireless communication circuitry may be WIFI enabling circuitry that permits wireless communication according to one of the 802.11 standards. Other wireless network protocol standards could also be used, either in alternative to the identified protocols or in addition to the identified protocols. Other network standards may include Bluetooth, the Global System for Mobile Communications (GSM), and code division multiple access (CDMA) based wireless protocols. Communications circuitry 378 may also include circuitry that enables device 300 to be electrically coupled to another device (e.g., a computer or an accessory device) and communicate with that other device.

In one embodiment, the personal computing device 370 may be a portable computing device dedicated to processing media such as audio and video. For example, the personal computing device 370 may be a media device such as media player (e.g., MP3 player), a game player, a remote controller, a portable communication device, a remote ordering interface, an audio tour player, or other suitable personal device. The personal computing device 370 may be battery-operated and highly portable so as to allow a user to listen to music, play games or video, record video or take pictures, communicate with others, and/or control other devices. In addition, the personal computing device 370 may be sized such that it fits relatively easily into a pocket or hand of the user. By being handheld, the personal computing device 370 (or electronic device 230 shown in FIG. 21) is relatively small and easily handled and utilized by its user and thus may be taken practically anywhere the user travels.

As discussed previously, the relatively small form factor of certain types of personal computing devices 370, e.g., personal media devices, enables a user to easily manipulate the device's position, orientation, and movement. Accordingly, the personal computing device 370 may provide for improved techniques of sensing such changes in position, orientation, and movement to enable a user to interface with or control the device 370 by affecting such changes. Further, the device 370 may include a vibration source, under the control of processor 375, 381, for example, to facilitate sending acoustic signals, motion, vibration, and/or movement information to a user related to an operation of the device 370 including for user authentication, navigation, visual analytics related functions. The personal computing device 370 may also include an image sensor 377 that enables the device 370 to capture an image or series of images (e.g., video) continuously, periodically, at select times, and/or under select conditions.

In addition, to accomplish visual analytics and related refinement of visual causal models, the system may further include a causal model editor 384 that comprises a set of instructions, application, microprocessor, engine and/or module that also users to apply their expertise, and/or to verify and edit causal model structure and/or links, and/or collaborate with a causal discovery algorithm(s) to identify and/or refine a valid causal network.

FIG. 24 illustrates a system block diagram of an example computing operating environment, where various embodiments may be implemented.

FIG. 24 and the below description are intended to provide a brief, general description of a suitable computing environment in which embodiments may be implemented. With reference to FIG. 24, a block diagram of an example computing operating environment for an application according to embodiments is illustrated, such as computing device 400. In a basic configuration, computing device 400 may include at least one processing unit 402 and system memory 404. Computing device 400 may also include a plurality of processing units that cooperate in executing programs. Depending on the exact configuration and type of computing device, the system memory 404 may be volatile (such as RAM), non-volatile (such as ROM, flash memory, etc.) or some combination of the two. System memory 404 typically includes an operating system 405 suitable for controlling the operation of the platform, such as the Windows® and Windows Phone® operating systems from Microsoft Corporation, Apple® IPhone, Android based or other contemplated operating systems. The system memory 404 may also include one or more software applications such as program modules 406, a data visualization application 422, and a visual analytics engine 424.

A data visualization application 422 may detect a gesture interacting with a displayed visualization. A visual analytics engine 424 of the application may determine attributes for a new visualization based on contextual information of the gesture and the visualization. The data visualization application 422 may execute an action integrating the attributes and the contextual information to generate the new visualization. This basic configuration is illustrated in FIG. 24 by those components within dashed line 408.

Computing device 400 may have additional features or functionality. For example, the computing device 400 may also include additional data storage devices (removable and/or non-removable) such as, for example, magnetic disks, optical disks, or tape. Such additional storage is illustrated in FIG. 24 by removable storage 409 and non-removable storage 410. Computer readable storage media may include volatile and nonvolatile, removable and non-removable media implemented in any method or technology for storage of information, such as computer readable instructions, data structures, program modules, or other data. Computer readable storage media is a computer readable memory device. System memory 404, removable storage 409 and non-removable storage 410 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 400. Any such computer readable storage media may be part of computing device 400.

Computing device 400 may also comprise input device(s) 412 such as keyboard, mouse, pen, voice input device, touch input device, and comparable input devices. Output device(s) 414 such as a display, speakers, printer, and other types of output devices may also be included. These devices are well known in the art and need not be discussed at length here.

Computing device 400 may also contain communication connections 416 that allow the device to communicate with other devices 418, such as over a wireless network in a distributed computing environment, a satellite link, a cellular link, and comparable mechanisms. Other devices 418 may include computer device(s) that execute communication applications, storage servers, and comparable devices. Communication connection(s) 416 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human analytics experts and/or other operators performing same. These human operators need not be co-located with each other, but each can be only with a machine that performs a portion of the program.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

In an alternative embodiment or aspect, dedicated hardware implementations, such as application specific integrated circuits, programmable logic arrays and other hardware devices, can be constructed to implement one or more of the methods described herein. Applications that may include the apparatus and systems of various embodiments or aspects can broadly include a variety of electronic and computing systems. One or more embodiments or aspects described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments or aspects, the methods described herein may be implemented by software programs tangibly embodied in a processor-readable medium and may be executed by a processor. Further, in an exemplary, non-limited embodiment or aspect, implementations can include distributed processing, component/object distributed processing, and parallel processing. Alternatively, virtual computing system processing can be constructed to implement one or more of the methods or functionality as described herein.

It is also contemplated that a computer-readable medium includes instructions 202 or receives and executes instructions 202 responsive to a propagated signal, so that a device connected to a network 122 can communicate voice, video or data over the network 122. Further, the instructions 102 may be transmitted or received over the network 122 via the network interface device 124.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any tangible medium that is capable of storing or encoding a set of instructions for execution by a processor or that cause a computing system to perform any one or more of the methods or operations disclosed herein.

In a particular non-limiting, example embodiment or aspect, the computer-readable medium can include a solid-state memory, such as a memory card or other package, which houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture and store carrier wave signals, such as a signal communicated over a transmission medium. A digital file attachment to an e-mail or other self-contained information archive or set of archives may be considered a distribution medium that is equivalent to a tangible storage medium. Accordingly, any one or more of a computer-readable medium or a distribution medium and other equivalents and successor media, in which data or instructions may be stored, are included herein.

In accordance with various embodiments or aspects, the methods described herein may be implemented as one or more software programs running on a computer processor. Dedicated hardware implementations including, but not limited to, application specific integrated circuits, programmable logic arrays, and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. The software may also utilize a signal containing computer instructions. A digital file attachment to e-mail or other self-contained information archive or set of archives is considered a distribution medium equivalent to a tangible storage medium. Accordingly, a tangible storage medium or distribution medium as listed herein, and other equivalents and successor media, in which the software implementations herein may be stored, are included herein.

The present disclosure relates to a system and method associated with a causality based analytics for analyzing time series, which can identify dependencies with time delays. Even more particularly, disclosed is a visual analytics framework that allows users to both generate and test temporal causal hypotheses. A novel algorithm that supports the automated search of potential causes given the observed data is disclosed with several usage scenarios that demonstrate the capabilities of the disclosed causality-based framework.

In certain embodiments or aspects, contemplated is a visual analytics system for investigating causal relations between time-dependent events. The system leverages the theory of logic-based causality and provides visual utilities assisting analysts in 1) generating causal propositions and hypotheses; and 2) testing their truthfulness considering different amounts of time delays. Also devised are novel algorithms for 1) automatically estimating potential causes to improve analytical efficiency; and 2) establishing causal chains by recursive application of an embodiment of the disclosed system and method.

In certain embodiments or aspects, further contemplated is additional other features of the novel visual analytics system and method which include: (1) a new causal network visualization that emphasizes the flow of causal dependencies, (2) a model scoring mechanism with visual hints for interactive model refinement, and (3) flexible approaches for handling heterogeneous data including static or temporal phenomena. Various real-world data examples are described hereinabove.

The disclosed system and method permits a data mining expert to easily visualize the dependency between different time series and the ranking of cause significance towards the target effect, especially with time lags, which cannot be accomplished using known systems.

In other embodiments or aspects, further contemplated is implementation of an a visual analytics system and method that uses a time-lagged conditional distribution visualization, allowing experts or other user visualize directly the influence of one phenomenon on the other and assisted with deducing and identifying a causal relation. The visualization includes a level of interactivity where a visual feedback promptly followed each step of an operation, so the user can visualize the change caused by an action immediately. The visual interface design permits the user to directly visualize the extracted causal information and identify more clearly which cause is becoming more important as the values are adjusted, for example, the respective numeric constraint and the time delay. The different visual components in the disclosed system and method streamlines the data exploration process by allowing users to try different parameters during the inference process, that otherwise, were not immediately decipherable to the expert with respect to time-based or static phenomena associated with particularized datasets.

Although specific example embodiments or aspects have been described, it will be evident that various modifications and changes may be made to these embodiments or aspects without departing from the broader scope of the invention. Accordingly, the specification and drawings are to be regarded in an illustrative rather than a restrictive sense. The accompanying drawings that form a part hereof, show by way of illustration, and not of limitation, specific embodiments or aspects in which the subject matter may be practiced. The embodiments or aspects illustrated are described in sufficient detail to enable those skilled in the art to practice the teachings disclosed herein. Other embodiments or aspects may be utilized and derived therefrom, such that structural and logical substitutions and changes may be made without departing from the scope of this disclosure. This Detailed Description, therefore, is not to be taken in a limiting sense, and the scope of various embodiments or aspects is defined only by the appended claims, along with the full range of equivalents to which such claims are entitled.

Such embodiments or aspects of the inventive subject matter may be referred to herein, individually and/or collectively, by the term “invention” or “embodiment” merely for convenience and without intending to voluntarily limit the scope of this application to any single invention or inventive concept if more than one is in fact disclosed. Thus, although specific embodiments or aspects have been illustrated and described herein, it should be appreciated that any arrangement calculated to achieve the same purpose may be substituted for the specific embodiments or aspects shown. This disclosure is intended to cover any and all adaptations or variations of various embodiments or aspects. Combinations of the above embodiments or aspects, and other embodiments or aspects not specifically described herein, will be apparent to those of skill in the art upon reviewing the above description.

In the foregoing description of the embodiments or aspects, various features are grouped together in a single embodiment for the purpose of streamlining the disclosure. This method of disclosure is not to be interpreted as reflecting that the claimed embodiments or aspects have more features than are expressly recited in each claim. Rather, as the following claims reflect, inventive subject matter lies in less than all features of a single disclosed embodiment or aspect. Thus the following claims are hereby incorporated into the Detailed Description, with each claim standing on its own as a separate example embodiment or aspect. It is contemplated that various embodiments or aspects described herein can be combined or grouped in different combinations that are not expressly noted in the Detailed Description. Moreover, it is further contemplated that claims covering such different combinations can similarly stand on their own as separate example embodiments or aspects, which can be incorporated into the Detailed Description.

Although the present specification describes components and functions implemented in the embodiments with reference to particular standards and protocols, the disclosed embodiment are not limited to such standards and protocols.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived there from, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Each of the non-limiting aspects or examples described herein may stand on its own, or may be combined in various permutations or combinations with one or more of the other examples. The above detailed description includes references to the accompanying drawings, which form a part of the detailed description. The drawings show, by way of illustration, specific embodiments in which the invention may be practiced. These embodiments are also referred to herein as “aspects” or “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third.” etc. are used merely as labels, and are not intended to impose numerical requirements on their objects.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact discs and digital video discs), magnetic cassettes, memory cards or sticks, random access memories (RAMs), read only memories (ROMs), and the like. The above description is intended to be illustrative, and not restrictive. For example, the above-described examples (or one or more aspects thereof) may be used in combination with each other. Other embodiments may be used, such as by one of ordinary skill in the art upon reviewing the above description.

The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments may be combined with each other in various combinations or permutations. The scope of the invention should be determined with reference to the appended claims, along with the full scope of equivalents to which such claims are entitled.

Such embodiments of the inventive subject matter may be referred to herein, individually and/or collectively, by the term “embodiment” merely for convenience and without intending to voluntarily limit the scope of this application to any single embodiment or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

Those skilled in the relevant art will appreciate that aspects of the invention can be practiced with other computer system configurations, including Internet appliances, hand-held devices, cellular or mobile phones, multi-processor systems, microprocessor-based or programmable consumer electronics, network PCs, client-server environments including thin clients, mini-computers, mainframe computers and the like. Aspects of the invention can be embodied in a special purpose computer or data processor that is specifically programmed, configured or constructed to perform one or more of the computer-executable instructions or modules explained in detail below. Indeed, the term “computer” as used herein refers to any data processing platform or device.

Aspects of the invention can also be practiced in distributed computing environments, where tasks or modules are performed by remote processing devices, which are linked through a communications network. In a distributed computing environment, program modules or sub-routines may be located in both local and remote memory storage devices, such as with respect to a wearable and/or mobile computer and/or a fixed-location computer. Aspects of the invention described below may be stored and distributed on computer-readable media, including magnetic and optically readable and removable computer disks, as well as distributed electronically over the Internet or over other networks (including wireless networks). Those skilled in the relevant art will recognize that portions of the invention may reside on a server computer or server platform, while corresponding portions reside on a client computer. For example, such a client server architecture may be employed within a single mobile computing device, among several computers of several users, and between a mobile computer and a fixed-location computer. Data structures and transmission of data particular to aspects of the invention are also encompassed within the scope of the invention.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate example embodiment.

Although preferred embodiments have been described herein with reference to the accompanying drawings, it is to be understood that the disclosure is not limited to those precise embodiments and that various other changes and modifications may be affected herein by one skilled in the art without departing from the scope or spirit of the embodiments, and that it is intended to claim all such changes and modifications that fall within the scope of this disclosure.

What is claimed is:

1. A system associated with generating an interactive visualization of causal models used in analytics of data, the system comprising:
a memory configured to store instructions; and
a visual analytics processing device coupled to the memory, the processing device executing a data visualization application with the instructions stored in memory, wherein the data visualization application is configured to:
receive time series data in the analytics of time-based phenomena associated with a data set;
generate a visual representation to specify an effect associated with a causal relation;
determine a causal hypothesis using at least one of an effect variable and a cause variable associated with the visual representation;
identify causal events in a new visual representation with a time shift being set;
determine a statistical significance using at least one time window within the new visual representation; and
generate an updated visual representation including one or more updated causal models.

2. The system as recited in claim 1, wherein the visual representation comprises a conditional distribution visualization.

3. The system as recited in claim 1, wherein the updated visual representation further comprises a causal flow visualization.

4. The system as recited in claim 1, wherein the system determines the causal hypothesis by analysis of time-lagged phenomena associated with the data set.

5. The system as recited in claim 2, wherein the conditional distribution visualization further comprises a histogram associated with the effect variable.

6. The system as recited in claim 2, wherein the conditional distribution visualization further comprises a histogram associated with the cause variable.

7. The system as recited in claim 6, wherein a value constraint may be set for the cause variable.

8. The system as recited in claim 1, wherein the updated visual representation further comprises a time-lagged conditional distribution visualization.

9. The system as recited in claim 1, wherein the conditional distribution visualization visualizes computed strengths of one or more cause(s) for the effect associated with a causal relation.

10. The system as recited in claim 9, wherein the computed strengths of the one or more cause(s) for the effect is based on a probability analysis associated with the effect.

11. A method associated with generating an interactive visualization of causal models used in analytics of data, the method comprising:
a visual analytics processing device coupled to a memory that stores instructions, the processing device executing a data visualization application with the instructions stored in the memory, wherein the data visualization application is configured to perform the following operations:
receiving time series data in the analytics of time-based phenomena associated with a data set;
generating a visual representation to specify an effect associated with a causal relation;
determining a causal hypothesis using at least one of an effect variable and a cause variable associated with the visual representation;
identifying causal events in a new visual representation with a time shift being set;
determining a statistical significance using at least one time window within the new visual representation; and
generating an updated visual representation including one or more updated causal models.

12. The method as recited in claim 11, wherein the visual representation comprises a conditional distribution visualization.

13. The method as recited in claim 11, wherein the updated visual representation further comprises a causal flow visualization.

14. The method as recited in claim 11, wherein the method further comprises determining the causal hypothesis by analysis of time-lagged phenomena associated with the data set.

15. The method as recited in claim 12, wherein the conditional distribution visualization further comprises a histogram associated with the effect variable.

16. The method as recited in claim 12, wherein the conditional distribution visualization further comprises a histogram associated with the cause variable.

17. The method as recited in claim 16, wherein a value constraint may be set for the cause variable.

18. The method as recited in claim 11, wherein the updated visual representation further comprises a time-lagged conditional distribution visualization.

19. The method as recited in claim 11, wherein the conditional distribution visualization visualizes computed strengths of one or more cause(s) for the effect associated with a causal relation.

20. The method as recited in claim 19, wherein the computed strengths of the one or more cause(s) for the effect is based on a probability analysis associated with the effect.

21. A computer-readable medium storing instructions that, when executed by a visual analytics processing device, performs operations that include:
receiving time series data in the analytics of time-based phenomena associated with a data set;
generating a visual representation to specify an effect associated with a causal relation;
determining a causal hypothesis using at least one of an effect variable and a cause variable associated with the visual representation;
identifying causal events in a new visual representation with a time shift being set;
determining a statistical significance using at least one time window within the new visual representation; and
generating an updated visual representation including one or more updated causal models.

22. The computer readable medium as recited in claim 21, wherein the visual representation comprises a conditional distribution visualization.

23. The computer readable medium as recited in claim 21, wherein the updated visual representation further comprises a causal flow visualization.

24. The computer readable medium as recited in claim 21, wherein the operations further comprise determining the causal hypothesis by analysis of time-lagged phenomena associated with the data set.

25. The computer readable medium as recited in claim 22, wherein the conditional distribution visualization further comprises a histogram associated with the cause variable.

26. The computer readable medium as recited in claim 22, wherein the conditional distribution visualization further comprises a histogram associated with the cause variable.

27. The computer readable medium as recited in claim 22, wherein a value constraint may be set for the cause variable.

28. The computer readable medium as recited in claim 21, wherein the updated visual representation further comprises a time-lagged conditional distribution visualization.

29. The computer readable medium as recited in claim 21, wherein the conditional distribution visualization visualizes computed strengths of one or more cause(s) for the effect associated with a causal relation.

30. The computer readable medium as recited in claim 29, wherein the computed strengths of the one or more cause(s) for the effect is based on a probability analysis associated with the effect.
